(19) United States
(12) Patent Application Publication
(10) Pub. No.: US 2013/0326583 A1
(43) Pub. Date: Dec. 5, 2013

(54) MOBILE COMPUTING DEVICE

(71) Applicants: Karoline Freihold, London (GB); Helge Lippert, London (GB); Linda Ericson, London (GB)

(72) Inventors: Karoline Freihold, London (GB); Helge Lippert, London (GB); Linda Ericson, London (GB)

(73) Assignee: VODAFONE IP LECENSING LIMITED, Newbury, Berkshire (GB)

(21) Appl. No.: 13/808,078

(22) PCT Filed: Jul. 1, 2011
(86) PCT No.: PCT/GB2011/051253

§ 371 Date: Jun. 18, 2013

(30) Foreign Application Priority Data
Jul. 2, 2010 (GB) 1011146.6

(51) Int. Cl. G06F 21/31

(52) U.S. Cl. CPC G06F 21/31
USPC 726/3

(57) ABSTRACT

This is described a method of access control for a mobile computing device having a touch-screen, the method comprising: receiving a signal indicating an input applied to the touch-screen; matching the signal against a library of signal characteristics to identify a user of the mobile computing device from a group of users of the mobile computing device; receiving an additional input to the mobile computing device; using both the signal and the additional input to authenticate the user; and if authenticated, allowing access to the mobile computing device in accordance with configuration data for the authenticated user.

### CROSS-REFERENCE TO RELATED APPLICATIONS

This application is a U.S. Nationalization of PCT Application Number PCT/GB2011/051253, filed Jul. 1, 2011, which claims the benefit of United Kingdom t Application No. 1011146.6 filed Jul. 2, 2010, the entireties of which are incorporated herein by reference.

### FIELD OF INVENTION

The present inventions are in the field of computing devices, and in particular mobile computing devices. In particular, the present invention is concerned with how a user interacts with such computing devices to manage the operation of such devices, the control of remote media players and the content accessible through such devices. The mobile computing device may have communications capabilities and be connected to other devices through communications network.

In particular the inventions relate to methods of organising a user interface of computing devices, a method and system for manipulating and merging user interface icons to achieve new functionality of such a computing device, an improved apparatus and method of providing user security and identity recognition of a computing device, an improved method and apparatus for interacting with the user interface of a computing device, an improved system and method for controlling a remote content display by use of a computing device, a improved method of controlling data steams by use of an electronic programming guides, an improved method of managing and displaying personalised electronic programming guide data, a method and system for managing the personalised use, recovery and display of video data, a method and system of mapping a local environment by use of a mobile computing device, a method and system for configuring user preferences on a mobile computing device by use of location information, a method and system for using location based information of a mobile computing device to control media playback through a separate media player, together with the use of gesture recognition to control media transfer from the mobile computing device to the media player, and a method for managing media playback on a media player by use of motion detection of a mobile computing device.

### BACKGROUND

Developments in computing and communications technologies allow for mobile computing devices with advanced multimedia capabilities. For example, many mobile computing devices provide audio and video playback, Internet access, and gaming functionality. Content may be stored on the device or accessed remotely. Typically, such devices access remote content over wireless local area networks (commonly referred to as “wifi”) and/or telecommunications channels. Modern mobile computing devices also allow for computer programs or “applications” to be run on the device. These applications may be provided by the device manufacturer or a third party. A robust economy has arisen surrounding the supply of such applications.

As the complexity of mobile computing devices, and the applications that run upon them, increases, there arises the problem of providing efficient and intelligent control interfaces. This problem is compounded by the developmental history of such devices.

In the early days of modern computing, large central computing devices or “mainframes” were common. These devices typically had fixed operating software adapted to process business transactions and often filled whole offices or floors. In time, the functionality of mainframe devices was subsumed by desktop personal computers which were designed to run a plurality of applications and be controlled by a single user at a time. Typically, these PCs were connected to other personal computers and sometimes central mainframes, by fixed-line networks, for example those based on the Ethernet standard. Recently, laptop computers have become a popular form of the personal computer.

Mobile communications devices, such as mobile telephones, developed in parallel, but quite separately from, personal computers. The need for battery power and telecommunications hardware within a hand-held platform meant that mobile telephones were often simple electronic devices with limited functionality beyond telephonic operations. Typically, many functions were implemented by bespoke hardware provided by mobile telephone or original equipment manufacturers. Towards the end of the twentieth century developments in electronic hardware saw the birth of more advanced mobile communications devices that were able to implement simple applications, for example, those based on generic managed platforms such as Java Mobile Edition. These advanced mobile communications devices are commonly known as “smartphones”. State of the art smartphones often include a touch-screen interface and a custom mobile operating system that allows third party applications. The most popular operating systems are Symbian™, Android™, Blackberry™ OS, iOS™, Windows Mobile™, LiMo™ and Palm WebOS™.

Recent trends have witnessed a convergence of the fields of personal computing and mobile telephony. This convergence presents new problems for those developing the new generation of devices as the different developmental backgrounds of the two fields make integration difficult.

Firstly, developers of personal computing systems, even those incorporating laptop computers, can assume the presence of powerful computing hardware and standardised operating systems such as Microsoft Windows, MacOS or well-known Linux variations. On the other hand, mobile telephony devices are still constrained by size, battery power and telecommunications requirements. Furthermore, the operating systems of mobile telephony devices are tied to the computing hardware and/or hardware manufacturer, which vary considerably across the field.

Secondly, personal computers, including laptop computers, are assumed to have a full QWERTY keyboard and mouse (or mouse-pad) as primary input devices. On the other hand, it is assumed that mobile telephony devices will not have a full keyboard or mouse; input for a mobile telephony device is constrained by portability requirements and typically there is only space for a numeric keypad or touch-screen interface. These differences mean that the user environments, i.e. the graphical user interfaces and methods of interaction, are often incompatible. In the past, attempts to adapt known techniques from one field and apply it to the other have resulted in limited devices that are difficult for a user to control.

Thirdly, the mobility and connectivity of mobile telephony devices offers opportunities that are not possible with standard personal computers. Desktop personal computers are fixed in one location and so there has not been the need to design applications and user-interfaces for portable operation. Even laptop computers are of limited portability due to their size, relatively high cost, form factor and power demands.

Changes in the way in which users interact with content is also challenging conventional wisdom in the field of both personal computing and mobile telephony. Increases in network bandwidth now allow for the streaming of multimedia content and the growth of server-centric applications (commonly referred to as “cloud computing”). This requires changes to the traditional model of device-centric content. Additionally, the trend for ever larger multimedia files, for example high-definition or three-dimensional video, means that it is not always practical to store such files on the device itself.

### BRIEF DESCRIPTION OF DRAWINGS

FIG. 1A shows a perspective view of the front of an exemplary mobile computing device;

FIG. 1B shows a perspective view of the rear of the exemplary mobile computing device;

FIG. 1C shows a perspective view of the rear of the exemplary mobile computing device during a charging operation;

FIG. 1D shows an exemplary location of one or more expansion slots for one or more non-volatile memory cards;

FIG. 2 shows a schematic internal view of the exemplary mobile computing device;

FIG. 3 shows a schematic internal view featuring additional components that may be supplied with the exemplary mobile computing device;

FIG. 4 shows a system view of the main computing components of the mobile computing device;

FIG. 5A shows a first exemplary resistive touch-screen;

FIG. 5B shows a method of processing input provided by the second resistive touch screen of FIG. 5A;

FIG. 5C shows a perspective view of a second exemplary resistive touch-screen incorporating multi-touch technology;

FIG. 6A shows a perspective view of an exemplary capacitive touch screen;

FIG. 6B shows a top view of the active components of the exemplary capacitive touch screen;

FIG. 6C shows a top view of an alternative embodiment of the exemplary capacitive touch screen;

FIG. 6D shows a method of processing input provided by the capacitive touch screen of FIG. 6A;

FIG. 7 shows a schematic diagram of the program layers used to control the mobile computing device;

FIGS. 8A and 8B show aspects of the mobile computing device in use;

FIGS. 9A to 9H show exemplary techniques for arranging graphical user interface components;

FIG. 10 schematically illustrates an exemplary home network with which the mobile computing device may interact;

FIGS. 11A, 11B and 11C respectively show a front, back and in-use view of a dock for the mobile computing device;

FIGS. 12A and 12B respectively show front and back views of a remote control device for the mobile computing device and/or additional peripherals;

FIGS. 13A, 13B and 13C show how a user may rearrange user interface components according to a first embodiment of the present invention;

FIG. 14 illustrates an exemplary method to perform the rearrangement shown in FIGS. 13A, 13B and 13C;

FIGS. 15A to 15E show how a user may combine user interface components according to a second embodiment of the present invention;

FIGS. 16A and 16B illustrate an exemplary method to perform the combination shown in FIGS. 15A to 15E;

FIG. 17A illustrates how the user interacts with a mobile computing device in a third embodiment of the present invention;

FIG. 17B shows at least some of the touch areas activated when the user interacts with the device as shown in FIG. 17A;

FIG. 17C illustrates an exemplary authentication screen displayed to a user;

FIG. 18 illustrates a method of authorizing a user to use a mobile computing device according to the third embodiment;

FIGS. 19A to 19E illustrate a method of controlling a remote screen using a mobile computing device according to a fourth embodiment of the present invention;

FIGS. 20A and 20B illustrate methods for controlling a remote screen as illustrated in FIGS. 19A to 19E;

FIGS. 21A to 21D illustrates how the user may use a mobile computing device to control content displayed on a remote screen according to a fifth embodiment of the present invention;

FIGS. 22A to 22C illustrate the method steps involved in the interactions illustrated in FIGS. 21A to 21D;

FIG. 23A illustrates the display of electronic program data according to a sixth embodiment of the present invention.

FIG. 23B shows how a user may interact with electronic program guide information in the sixth embodiment;

FIG. 23C shows how a user may use the electronic program guide information to display content on a remote screen;

FIG. 24 illustrates a method of filtering electronic program guide information based on a user profile according to a seventh embodiment of the present invention;

FIGS. 25A and 25B illustrate how a user of a mobile computer device may tag media content according to a seventh embodiment of the present invention;

FIG. 26A illustrates the method steps involved when tagging media as illustrated in FIGS. 25A and 25B;

FIG. 26B illustrates a method of using user tag data according to the seventh embodiment;

FIG. 27A shows an exemplary home environment together with a number of wireless devices;

FIG. 27B shows how a mobile computing device may be located within the exemplary home environment;

FIGS. 27C and 27D show how a user may provide location data according to an eighth embodiment of the present invention;

FIG. 28 illustrates location data for a mobile computing device;

FIG. 29A illustrates the method steps required to provide a map of a home environment according to the eighth embodiment;

FIGS. 29B and 29C illustrate how location data may be used within a home environment;

FIG. 30 shows how a user may play media content on a remote device using location data according to a ninth embodiment of the present invention;

FIGS. 31A and 31B illustrate methods steps to achieve the location-based services of FIG. 30;

FIGS. 32A and 32B show how a mobile computing device with a touch-screen may be used to direct media playback on a remote device according to a tenth embodiment of the present invention;

FIGS. 33A to 33D illustrate how remote media playback may be controlled using a mobile computing device; and

FIG. 34 illustrates a method for performing the remote control shown in FIGS. 33A to 33D.

### DETAILED DESCRIPTION

### Mobile Computing Device

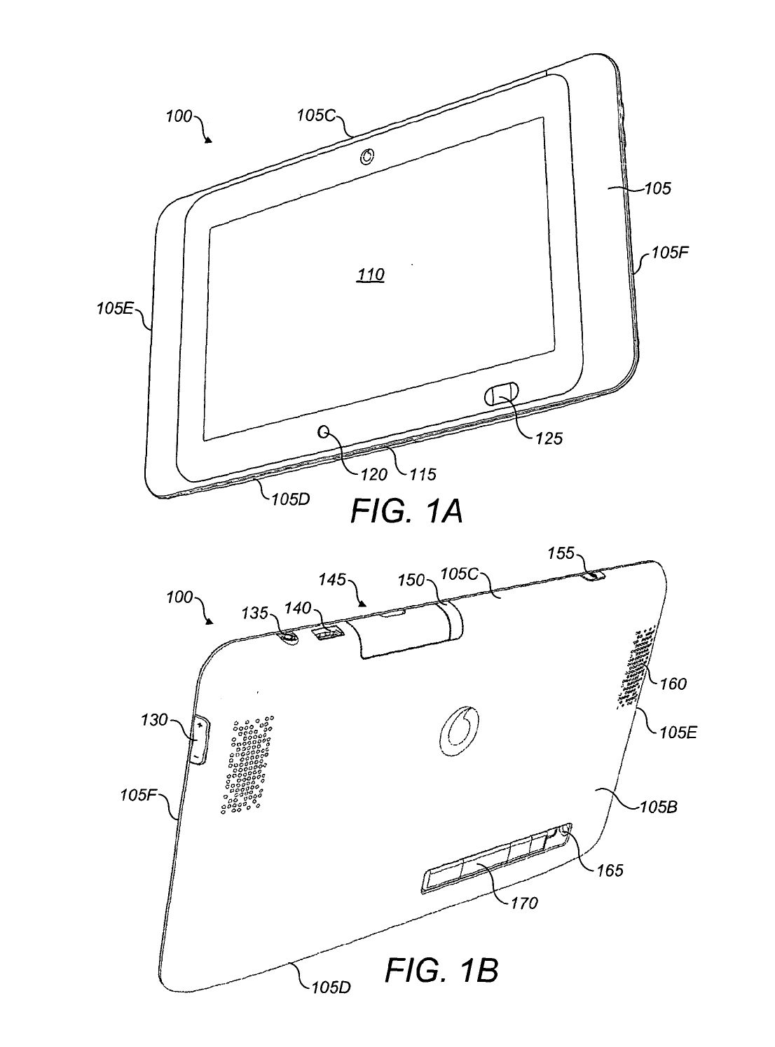

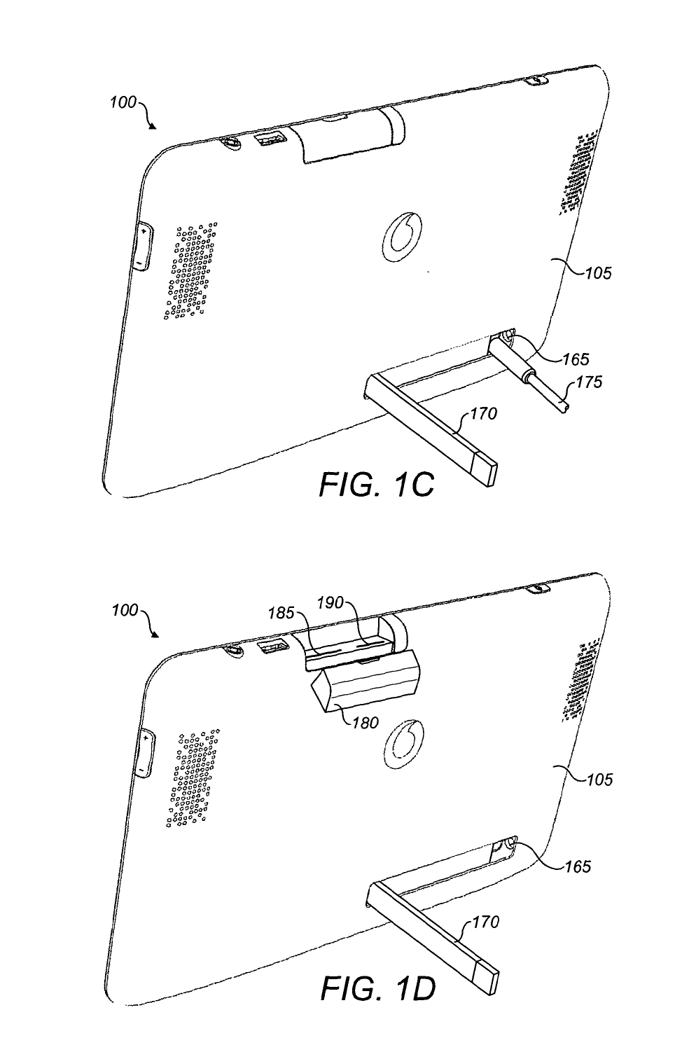

An exemplary mobile computing device (MCD) 100 that may be used to implement the present invention is illustrated in FIGS. 1A to 1D.

The MCD 100 is housed in a thin rectangular case 105 with the touch-screen 110 mounted within the front of the case 105. A front face 105A of the MCD 100 comprises touch-screen 110; it is through this face 105A that the user interacts with the MCD 100. A rear face 105B of the MCD 100 is shown in FIG. 1B. In the present example, the MCD 100 has four edges: a top edge 105C, a bottom edge 105D, a left edge 105E and a right edge 105F. In a preferred embodiment the MCD 100 is approximately [X1] cm in length, [Y1] cm in height and [Z1] cm in thickness, with the screen dimensions being approximately [X2] cm in length and [Y2] cm in height. The case 105 may be of a polymer construction. A polymer case is preferred to enhance communication using internal antennae. The corners of the case 105 may be rounded.

Below the touch-screen 110 are located a plurality of optional apertures for styling. A microphone 120 may be located behind the apertures within the casing 105. A home-button 125 is provided below the bottom-right corner of the touch-screen 1010. A custom communications port 115 is located on the elongate underside of the MCD 100. The custom communications port 115 may comprise a 54-pin connector.

FIG. 1B shows the rear face 105B of the MCD 100. A volume control switch 130 may be mounted on the right edge 105F of the MCD 100. The volume control switch 130 is to preferably centrally pivoted so as to raise volume by depressing an upper part of the switch 130 and to lower volume by depressing a lower part of the switch 130. A number of features are then present on the top edge 105C of the MCD 100. Moving from left to right when facing the rear of the MCD 100, there is an audio jack 135, a Universal Serial Bus (USB) port 140, a card port 145, an Infra-Red (IR) window 150 and a power key 155. These features are not essential to the invention and may be provided or omitted as required. The USB port 140 may be adapted to receive any USB standard device and may, for example, receive USB version 1, 2 or 3 devices of normal or micro configuration. The card port 145 is adapted to receive expansion cards in the manner shown in FIG. 1D. The IR window 150 is adapted to allow the passage of IR radiation for communication over an IR channel. An IR light emitting diode (LED) forming part of an IR transmitter or transceiver is mounted behind the IR window 150 within the casing. The power key 155 is adapted to turn the device on and off. It may comprise a binary switch or a more complex multi-state key. Apertures for two internal speakers 160 are located on the left and right of the rear of the MCD 100. A power socket 165 and an integrated stand 170 are located within an elongate, horizontal indentation in the lower right corner of case 105.

FIG. 1C illustrates the rear of the MCD 100 when the stand 170 is extended. Stand 170 comprises an elongate member pivotally mounted within the indentation at its base. The stand 170 pivots horizontally from a rest position in the plane of the rear of the MCD 100 to a position perpendicular to the plane of the rear of the MCD 100. The MCD 100 may then rest upon a flat surface supported by the underside of the MCD 100 and the end of the stand 170. The end of the stand member may comprise a non-slip rubber or polymer cover. FIG. 1C also illustrates a power-adapter connector 175 inserted into the power socket 165 to charge the MCD 100. The power-adapter connector 175 may also be inserted into the power socket 165 to power the MCD 100.

FIG. 1D illustrates the card port 145 on the rear of the MCD 100. The card port 145 comprises an indentation in the profile of the case 105. Within the indentation are located a Secure Digital (SD) card socket 185 and a Subscriber Identity Module (SIM) card socket 190. Each socket is adapted to receive a respective card. Below the socket apertures are located electrical connect points for making electrical contact with the cards in the appropriate manner. Sockets for other external memory devices, for example other forms of solid-state memory devices, may also be incorporated instead of, or as well as, the illustrated sockets. Alternatively, in some embodiments the card port 145 may be omitted. A cap 180 covers the card port 145 in use. As illustrated the cap 145 may be pivotally and/or removably mounted to allow access to both card sockets.

### Internal Components

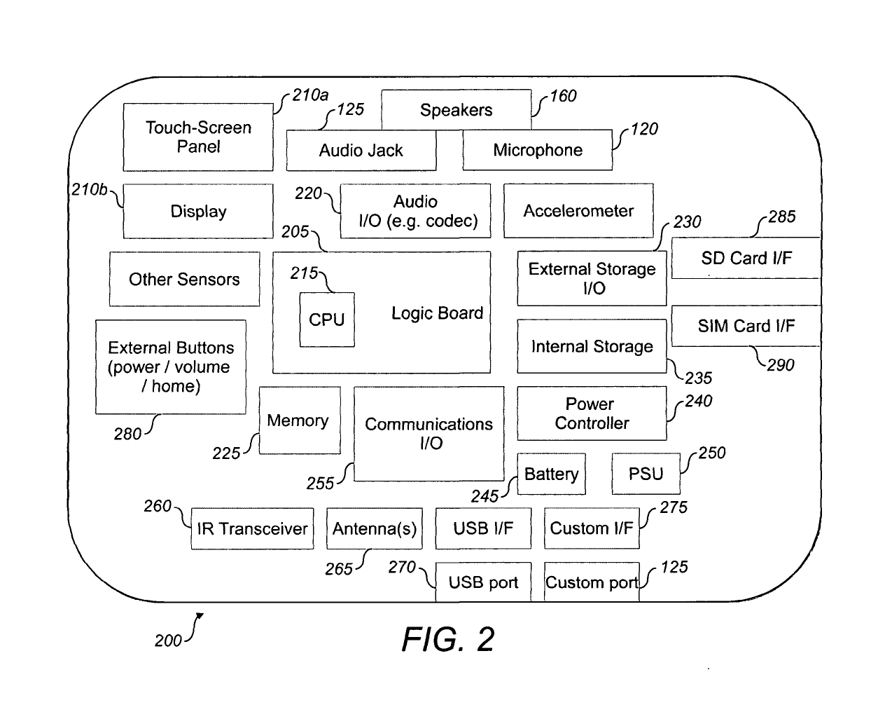

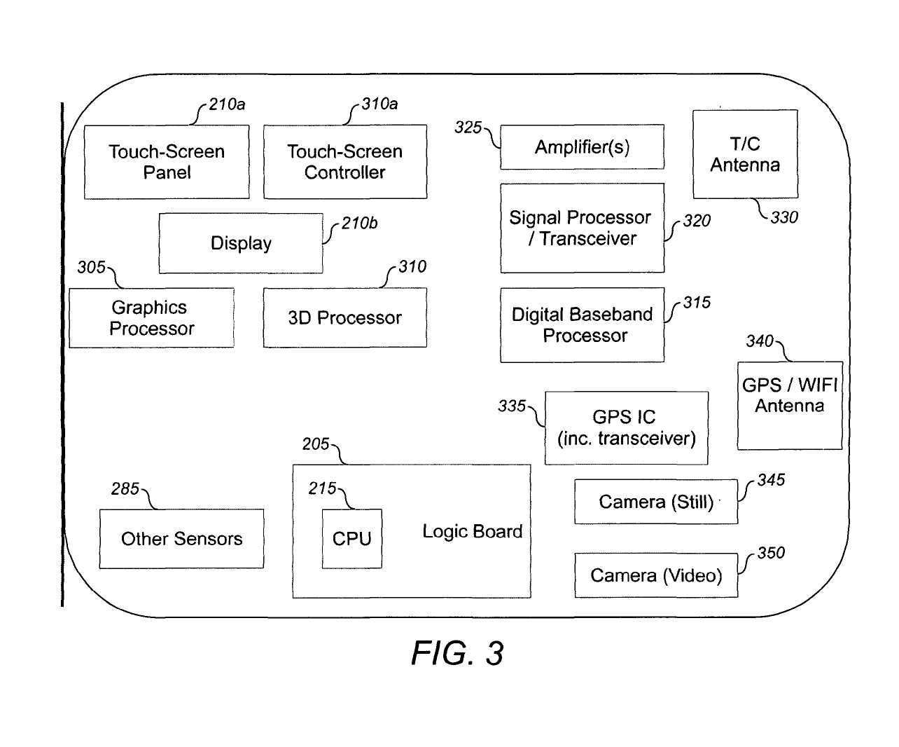

FIG. 2 is a schematic illustration of the internal hardware 200 located within the case 105 of the MCD 100. FIG. 3 is an associated schematic illustration of additional internal components that may be provided. Generally, FIG. 3 illustrates components that could not be practically illustrated in FIG. 2. As the skilled person would appreciate the components illustrated in these Figures are for example only and the actual components used, and their internal configuration, may change with design iterations and different model specifications. FIG. 2 shows a logic board 205 to which a central processing unit (CPU) 215 is attached. The logic board 205 may comprise one or more printed circuit boards appropriately connected. Coupled to the logic board 205 are the constituent components of the touch-screen 110. These may comprise touch screen panel 210A and display 210B. The touch-screen panel 210A and display 210B may form part of an integrated unit or may be provided separately. Possible technologies used to implement touch-screen panel 210A are described in more detail in a later section below. In one embodiment, the display 210B comprises a light emitting diode (LED) backlit liquid crystal display (LCD) of dimensions [X by Y]. The LCD may be a thin-film-transistor (TFT) LCD incorporating available LCD technology, for example incorporating a twisted-nematic (TN) panel or in-plane switching (IPS). In particular variations, the display 210B may incorporate technologies for three-dimensional images; such variations are discussed in more detail at a later point below. In other embodiments organic LED (OLED) displays, including active-matrix (AM) OLEDs, may be used in place of LED backlit LCDs.

FIG. 3 shows further electronic components that may be coupled to the touch-screen 1010. Touch-screen panel 210A may be coupled to a touch-screen controller 310A. Touch-screen controller 310A comprises electronic circuitry adapted to process or pre-process touch-screen input in order to provide the user-interface functionality discussed below together with the CPU 215 and program code in memory. Touch-screen controller may comprise one or more of dedicated circuitry or programmable micro-controllers. Display 210B may be further coupled to one or more of a dedicated graphics processor 305 and a three-dimensional (“3D”) processor 310. The graphics processor 305 may perform certain graphical processing on behalf of the CPU 215, including hardware acceleration for particular graphical effects, three-dimensional rendering, lighting and vector graphics processing. 3D processor 310 is adapted to provide the illusion of a three-dimensional environment when viewing display 210B. 3D processor 310 may implement one or more of the processing methods discussed later below. CPU 215 is coupled to memory 225. Memory 225 may be implemented using known random access memory (RAM) modules, such as (synchronous) dynamic RAM. CPU 215 is also coupled to internal storage 235. Internal storage may be implemented using one or more solid-state drives (SSDs) or magnetic hard-disk drives (HDDs). A preferred SSD technology is NAND-based flash memory.

CPU 215 is also coupled to a number of input/output (I/O) interfaces. In other embodiments any suitable technique for coupling CPU to I/O devices may be used including the use of dedicated processors in communication with the CPU. Audio I/O interface 220 couples the CPU to the microphone 120, audio jack 125, and speakers 160. Audio I/O interface 220, CPU 215 or logic board 205 may implement hardware or software-based audio encoders/decoders (“codecs”) to process a digital signal or data-stream either received from, or to be sent to, devices 120, 125 and 160. External storage I/O interface 230 enables communication between the CPU 215 and any solid-state memory cards residing within card sockets 185 and 190. A specific SD card interface 285 and a specific SIM card interface 290 may be provided to respectively make contact with, and to read/write date to/from, SD and SIM cards.

As well as audio capabilities the MCD 100 may also optionally comprise one or more of a still-image camera 345 and a video camera 350. Video and still-image capabilities may be provided by a single camera device.

Communications I/O interface 255 couples the CPU 215 to wireless, cabled and telecommunications components. Communications I/O interface 255 may be a single interface or may be implemented using a plurality of interfaces. In the latter case, each specific interface is adapted to communicate with a specific communications component. Communications I/O interface 255 is coupled to an IR transceiver 260, one or more communications antennae 265, USB interface 270 and custom interface 275. One or more of these communications components may be omitted according to design considerations. IR transceiver 260 typically comprises an LED transmitter and receiver mounted behind IR window 150. USB interface 270 and custom interface 275 may be respectively coupled to, or comprise part of, USB port 140 and custom communications port 125. The communication antennae may be adapted for wireless, telephony and/or proximity wireless communication; for example, communication using WIFI or WIMAX™ standards, telephony standards as discussed below and/or Bluetooth™ or Zigbee™. The logic board 205 is also coupled to external switches 280, which may comprise volume control switch 130 and power key 155. Additional internal or external sensors 285 may also be provided.

FIG. 3 shows certain communications components in more detail. In order to provide mobile telephony the CPU 215 and logic board 205 are coupled to a digital baseband processor 315, which is in turn coupled to a signal processor 320 such as a transceiver. The signal processor 320 is coupled to one or more signal amplifiers 325, which in turn are coupled to one or more telecommunications antennae 330. These components may be configured to enable communications over a cellular network, such as those based on the Groupe Spèciale Mobile (GSM) standard, including voice and data capabilities. Data communications may be based on, for example, one or more of the following: General Packet Radio Service (GPRS), Enhanced Data Rates for GSM Evolution (EDGE) or the xG family of standards (3G, 4G etc.).

FIG. 3 also shows an optional Global Positioning System (GPS) enhancement comprising a GPS integrated circuit (IC) 335 and a GPS antenna 340. The GPS IC 335 may comprise a receiver for receiving a GPS signal and dedicated electronics for processing the signal and providing location information to logic board 205. Other positioning standards can also be used.

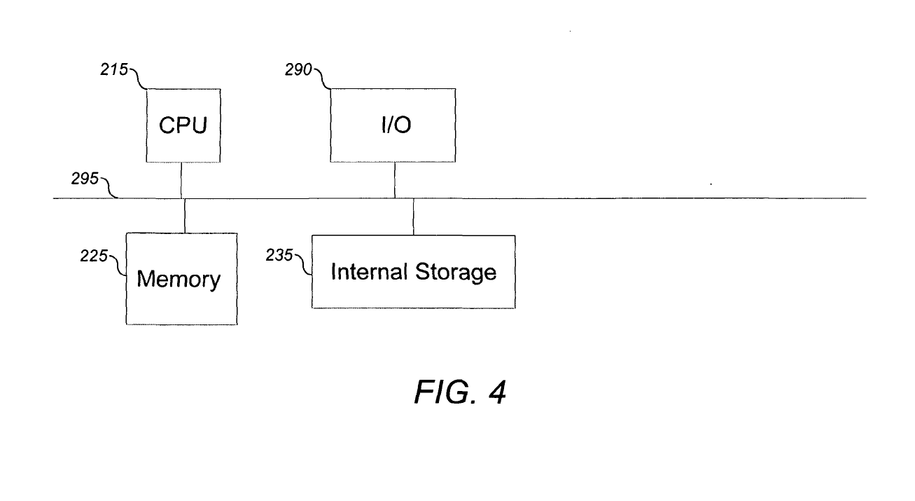

FIG. 4 is a schematic illustration of the computing components of the MCD 100. CPU 215 comprises one or more processors connected to a system bus 295. Also connected to the system bus 295 is memory 225 and internal storage 235. One or more I/O devices or interfaces 290, such as the I/O interfaces described above, are also connected to the system bus 295. In use, computer program code is loaded into memory 225 to be processed by the one or more processors of the CPU 215.

### Touch-Screen

The MCD 100 uses a touch-screen 1010 as a primary input device. The touch-screen 1010 may be implemented using any appropriate technology to convert physical user actions into parameterised digital input that can be subsequently processed by CPU 215. Two preferred touch-screen technologies, resistive and capacitive, are described below. However, it is also possible to use other technologies including, but not limited to, optical recognition based on light beam interruption or gesture detection, surface acoustic wave technology, dispersive signal technology and acoustic pulse recognition.

### Resistive

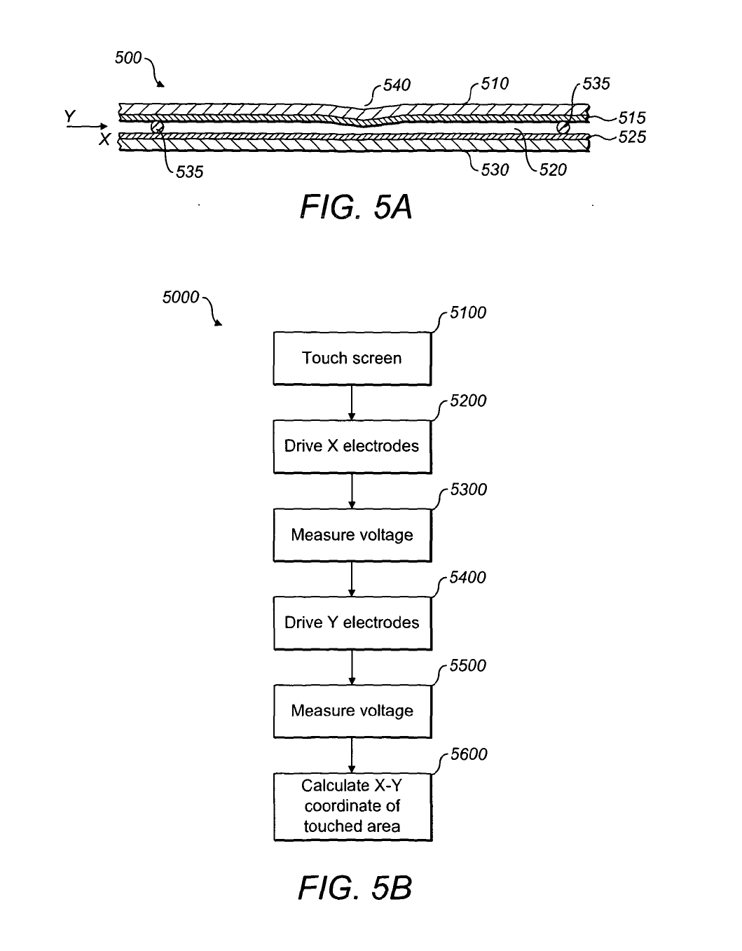

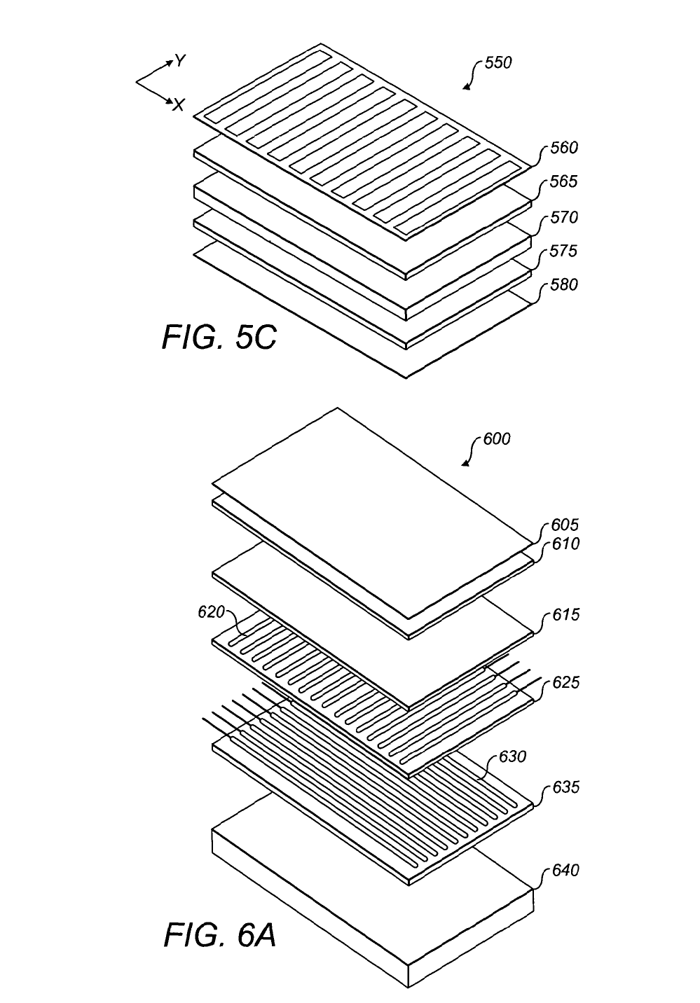

FIG. 5A is a simplified diagram of a first resistive touch screen 500. The first resistive touch screen 500 comprises a flexible, polymer cover-layer 510 mounted above a glass or acrylic substrate 530. Both layers are transparent. Display 210B either forms, or is mounted below, substrate 530. The upper surface of the cover-layer 510 may be optionally have a scratch-resistance, hard durable coating. The lower surface of the cover-layer 510 and the upper surface of the substrate 530 are coated with a transparent conductive coating to form an upper conductive layer 515 and a lower conductive layer 525. The conductive coating may be indium tin oxide (ITO). The two conductive layers 515 and 525 are spatially separated by an insulating layer. In FIG. 5A the insulating layer is provided by an air-gap 520. Transparent insulating spacers 535, typically in the form of polymer spheres or dots, maintain the separation of the air gap 520. In other embodiments, the insulating layer may be provided by a gel or polymer layer.

The upper conductive layer 515 is coupled to two elongate x-electrodes (not shown) laterally-spaced in the x-direction. The x-electrodes are typically coupled to two opposing sides of the upper conductive layer 515, i.e. to the left and right of FIG. 5A. The lower conductive layer 525 is coupled to two elongate y-electrodes (not shown) laterally-spaced in the y-direction. The y-electrodes are likewise typically coupled to two opposing sides of the lower conductive layer 525, i.e. to the fore and rear of FIG. 5A. This arrangement is known as a four-wire resistive touch screen. The x-electrodes and y-electrodes may alternatively be respectively coupled to the lower conductive layer 525 and the upper conductive layer 515 with no loss of functionality. A four-wire resistive touch screen is used as a simple example to explain the principles behind the operation of a resistive touch-screen. Other wire multiples, for example five or six wire variations, may be used in alternative embodiments to provide greater accuracy.

FIG. 5B shows a simplified method 5000 of recording a touch location using the first resistive touch screen. Those skilled in the art will understand that processing steps may be added or removed as dictated by developments in resistive sensing technology; for example, the recorded voltage may be filtered before or after analogue-to-digital conversion. At step 5100 a pressure is applied to the first resistive touch-screen 500. This is illustrated by finger 540 in FIG. 5A. Alternatively, a stylus may also be used to provide an input. Under pressure from the finger 540, the cover-layer 510 deforms to allow the upper conductive layer 515 and the lower conductive layer 525 to make contact at a particular location in x-y space. At step 5200 a voltage is applied across the x-electrodes in the upper conductive layer 515. At step 5300 the voltage across the y-electrodes is measured. This voltage is dependent on the position at which the upper conductive layer 515 meets the lower conductive layer 525 in the x-direction. At step 5400 a voltage is applied across the y-electrodes in the lower conductive layer 515. At step 5500 the voltage across the x-electrodes is measured. This voltage is dependent on the position at which the upper conductive layer 515 meets the lower conductive layer 525 in the y-direction. Using the first measured voltage an x co-ordinate can be calculated. Using the second measured voltage a y co-ordinate can be calculated. Hence, the x-y co-ordinate of the touched area can be determined at step 5600. The x-y co-ordinate can then be input to a user-interface program and be used much like a co-ordinate obtained from a computer mouse.

FIG. 5C shows a second resistive touch-screen 550. The second resistive touch-screen 550 is a variation of the above-described resistive touch-screen which allows the detection of multiple touched areas, commonly referred to as “multi-touch”. The second resistive touch-screen 550 comprises an array of upper electrodes 560, a first force sensitive resistor layer 565, an insulating layer 570, a second force sensitive layer 575 and an array of lower electrodes 580. Each layer is transparent. The second resistive touch screen 550 is typically mounted on a glass or polymer substrate or directly on display 210B. The insulating layer 570 may be an air gap or a dielectric material. The resistance of each force resistive layer decreases when compressed. Hence, when pressure is applied to the second resistive touch-screen 550 the first 575 and second 580 force sensitive layers are compressed allowing a current to flow from an upper electrode 560 to a lower electrode 580, wherein the voltage measured by the lower electrode 580 is proportional to the pressure applied.

In operation, the upper and lower electrodes are alternatively switched to build up a matrix of voltage values. For example, a voltage is applied to a first upper electrode 560. A voltage measurement is read-out from each lower electrode 580 in turn. This generates a plurality of y-axis voltage measurements for a first x-axis column. These measurements may be filtered, amplified and/or digitised as required. The process is then repeated for a second neighbouring upper electrode 560. This generates a plurality of y-axis voltage measurements for a second x-axis column. Over time, voltage measurements all x-axis columns are collected to populate a matrix of voltage values. This matrix of voltage values can then be converted into a matrix of pressure values. This matrix of pressure values in effect provides a three-dimensional map indicating where pressure is applied to the touch-screen. Due to the electrode arrays and switching mechanisms multiple touch locations can be recorded. The processed output of the second resistive touch-screen 550 is similar to that of the capacitive touch-screen embodiments described below and thus can be used in a similar manner. The resolution of the resultant touch map depends on the density of the respective electrode arrays. In a preferred embodiment of the MCD 100 a multi-touch resistive touch-screen is used.

### Capacitive

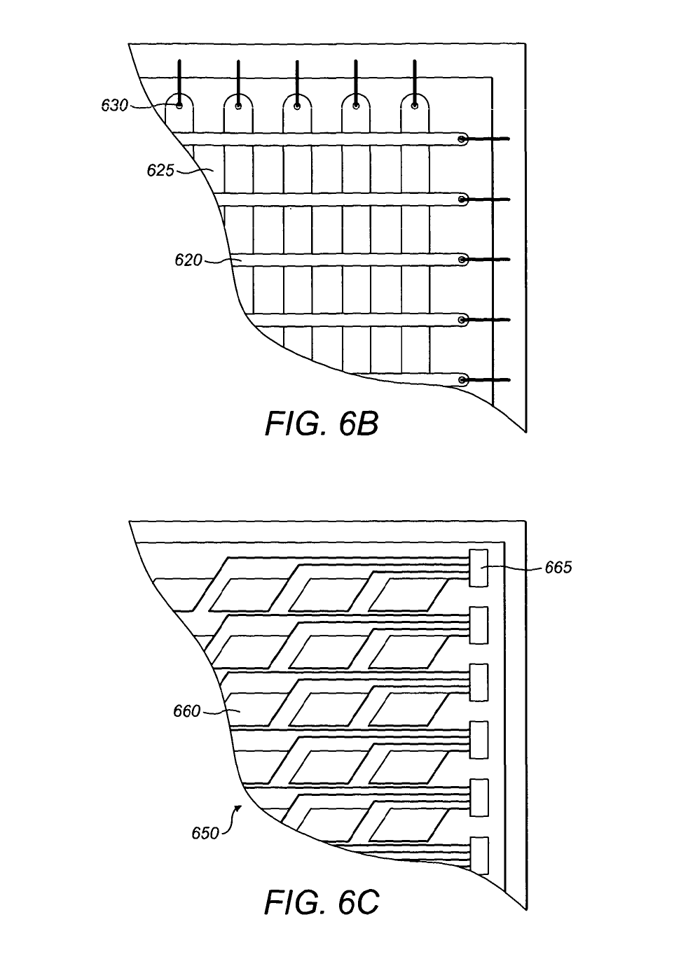

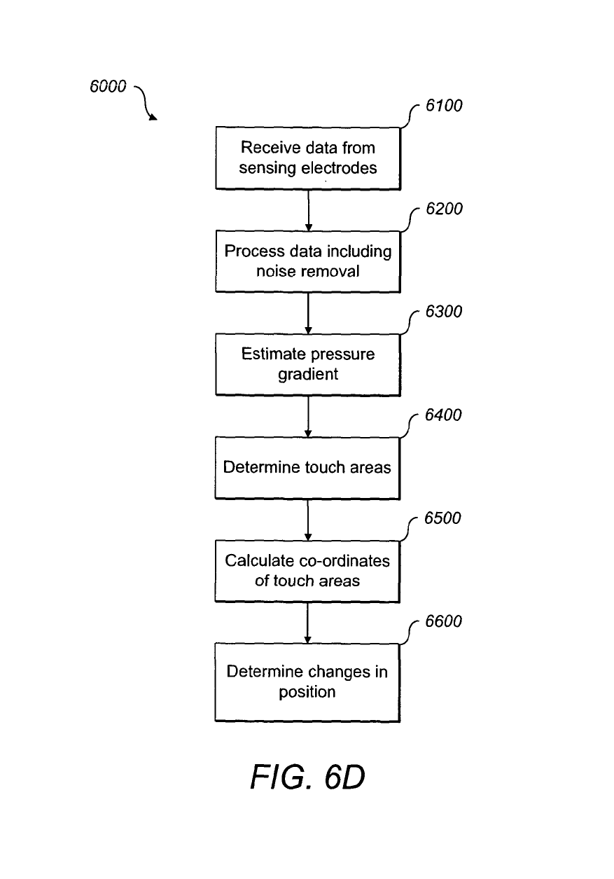

FIG. 6A shows a simplified schematic of a first capacitive touch-screen 600. The first capacitive touch-screen 600 operates on the principle of mutual capacitance, provides processed output similar to the second resistive touch screen 550 and allows for multi-touch input to be detected. The first capacitive touch-screen 600 comprises a protective anti-reflective coating 605, a protective cover 610, a bonding layer 615, driving electrodes 620, an insulating layer 625, sensing electrodes 630 and a glass substrate 635. The first capacitive touch-screen 600 is mounted on display 210B. Coating 605, cover 610 and bonding layer 615 may be replaced with a single protective layer if required. Coating 605 is optional. As before, the electrodes may be implemented using an ITO layer patterned onto a glass or polymer substrate.

During use, changes in capacitance that occur at each of the electrodes are measured. These changes allow an x-y co-ordinate of the touched area to be measured. A change in capacitance typically occurs at an electrode when a user places an object such as a finger in close proximity to the electrode. The object needs to be conductive such that charge is conducted away from the proximal area of the electrode affecting capacitance.

As with the second resistive touch screen 550, the driving 620 and sensing 630 electrodes form a group of spatially separated lines formed on two different layers that are separated by an insulating layer 625 as illustrated in FIG. 6B. The sensing electrodes 630 intersect the driving electrodes 620 thereby forming cells in which capacitive coupling can be measured. Even though perpendicular electrode arrays have been described in relation to FIGS. 5C and 6A, other arrangements may be used depending on the required co-ordinate system. The driving electrodes 620 are connected to a voltage source and the sensing electrodes 630 are connected to a capacitive sensing circuit (not shown). In operation, the driving electrodes 620 are alternatively switched to build up a matrix of capacitance values. A current is driven through each driving electrode 620 in turn, and because of capacitive coupling, a change in capacitance can be measured by the capacitive sensing circuit in each of the sensing electrodes 630. Hence, the change in capacitance at the points at which a selected driving electrode 620 crosses each of the sensing electrodes 630 can be used to generate a matrix column of capacitance measurements. Once a current has been driven through all of the driving electrodes 630 in turn, the result is a complete matrix of capacitance measurements. This matrix is effectively a map of capacitance measurements in the plane of the touch-screen to (i.e. the x-y plane). These capacitance measurements are proportional to changes in capacitance caused by a user's finger or specially-adapted stylus and thus record areas of touch.

FIG. 6C shows a simplified schematic illustration of a second capacitive touch-screen 650. The second capacitive touch-screen 650 operates on the principle of self-capacitance and provides processed output similar to the first capacitive touch-screen 600, allowing for multi-touch input to be detected. The second capacitance touch-screen 650 shares many features with the first capacitive touch screen 600; however, it differs in the sensing circuitry that is used. The second capacitance touch-screen 650 comprises a two-dimensional electrode array, wherein individual electrodes 660 make up cells of the array. Each electrode 660 is coupled to a capacitance sensing circuit 665. The capacitance sensing circuit 665 typically receives input from a row of electrodes 660. The individual electrodes 660 of the second capacitive touch-screen 650 sense changes in capacitance in the region above each electrode. Each electrode 660 thus provides a measurement that forms an element of a matrix of capacitance measurements, wherein the measurement can be likened to a pixel in a resulting capacitance map of the touch-screen area, the map indicating areas in which the screen has been touched. Thus, both the first 600 and second 650 capacitive touch-screens produce an equivalent output, i.e. a map of capacitance data.

FIG. 6D shows a method of processing capacitance data that may be applied to the output of the first 600 or second 650 capacitive touch screens. Due to the differences in physical construction each of the processing steps may be optionally configured for each screens construction, for example, filter characteristics may be dependent on the form of the touch-screen electrodes. At step 6100 data is received from the sensing electrodes. These may be sensing electrodes 630 or individual electrodes 660. At step 6200 the data is processed. This may involve filtering and/or noise removal. At step 6300 the processed data is analysed to determine a pressure gradient for each touched area. This involves looking at the distribution of capacitance measurements and the variations in magnitude to estimate the pressure distribution perpendicular to the plane of the touch-screen (the z-direction). The pressure distribution in the z-direction may be represented by a series of contour lines in the x-y direction, different sets of contour lines representing different quantised pressure values. At step 6400 the processed data and the pressure gradients are used to determine the touched area. A touched area is typically a bounded area with x-y space, for example the origin of such a space may be the lower left corner of the touch-screen. Using the touched area a number of parameters are calculated at step 6500. These parameters may comprise the central co-ordinates of the touched area in x-y space, plus additional values to characterise the area such as height and width and/or pressure and skew metrics. By monitoring changes in the parameterised touch areas over time changes in finger position may be determined at step 6600.

Numerous methods described below make use of touch-screen functionality. This functionality may make use of the methods described above. Touch-screen gestures may be active, i.e. vary with time such as a tap, or passive, e.g. resting a finger on the display.

### Three-Dimensional Display

Display 210B may be adapted to display stereoscopic or three-dimensional (3D) images. This may be achieved using a dedicated 3D processor 310. The 3D processor 310 may be adapted to produce 3D images in any manner known in the art, including active and passive methods. The active methods may comprise, for example, LCD shutter glasses wirelessly linked and synchronised to the 3D processor (e.g. via Bluetooth™) and the passive methods may comprise using linearly or circularly polarised glasses, wherein the display 210B may comprise an alternating polarising filter, or anaglyphic techniques comprising different colour filters for each eye and suitably adapted colour-filtered images.

The user-interface methods discussed herein are also compatible with holographic projection technologies, wherein the display may be projected onto a surface using coloured lasers. User actions and gestures may be estimated using IR or other optical technologies.

### Device Control

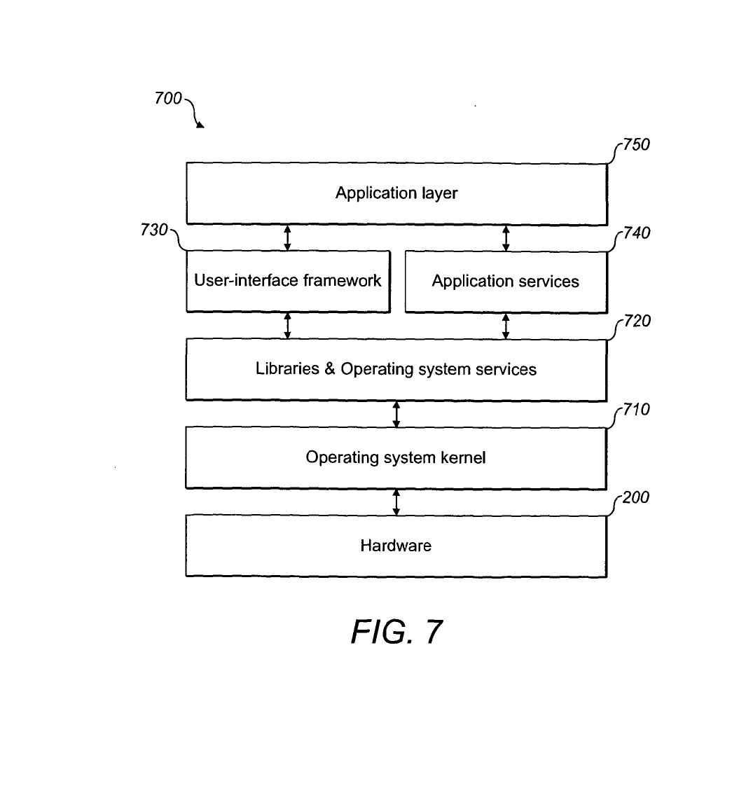

An exemplary control architecture 700 for the MCD 100 is illustrated in FIG. 7. Preferably the control architecture is implemented as a software stack that operates upon the internal hardware 200 illustrated in FIGS. 2 and 3. Hence, the components of the architecture may comprise computer program code that, in use, is loaded into memory 225 to be implemented by CPU 215. When not in use the program code may be stored in internal storage 235. The control architecture comprises an operating system (OS) kernel 710. The OS kernel 710 comprises the core software required to manage hardware 200. These services allow for management of the CPU 215, memory 225, internal storage 235 and I/O devices 290 and include software drivers. The OS kernel 710 may be either proprietary or Linux (open source) based. FIG. 7 also shows number of OS services and libraries 720. OS services and libraries 720 may be initiated by program calls from programs above them in the stack and may themselves call upon the OS kernel 710. The OS services may comprise software services for carrying out a number of regularly-used functions. They may be implemented by, or may load in use, libraries of computer program code. For example, one or more libraries may provide common graphic-display, database, communications, media-rendering or input-processing functions. When not in use, the libraries may be stored in internal storage 235.

To implement the user-interface (UI) that enables a user to interact with the MCD 100 a UI-framework 730 and application services 740 may be provided. UI framework 730 provides common user interface functions. Application services 740 are services other than those implemented at the kernel or OS services level. They are typically programmed to manage certain common functions on behalf of applications 750, such as contact management, printing, internet access, location management, and UI window management. The exact separation of services between the illustrated layers will depend on the operating system used. The UI framework 730 may comprise program code that is called by applications 750 using predefined application programming interfaces (APIs). The program code of the UI framework 730 may then, in use, call OS services and library functions 720. The UI framework 730 may implement some or all of the user-environment functions described below.

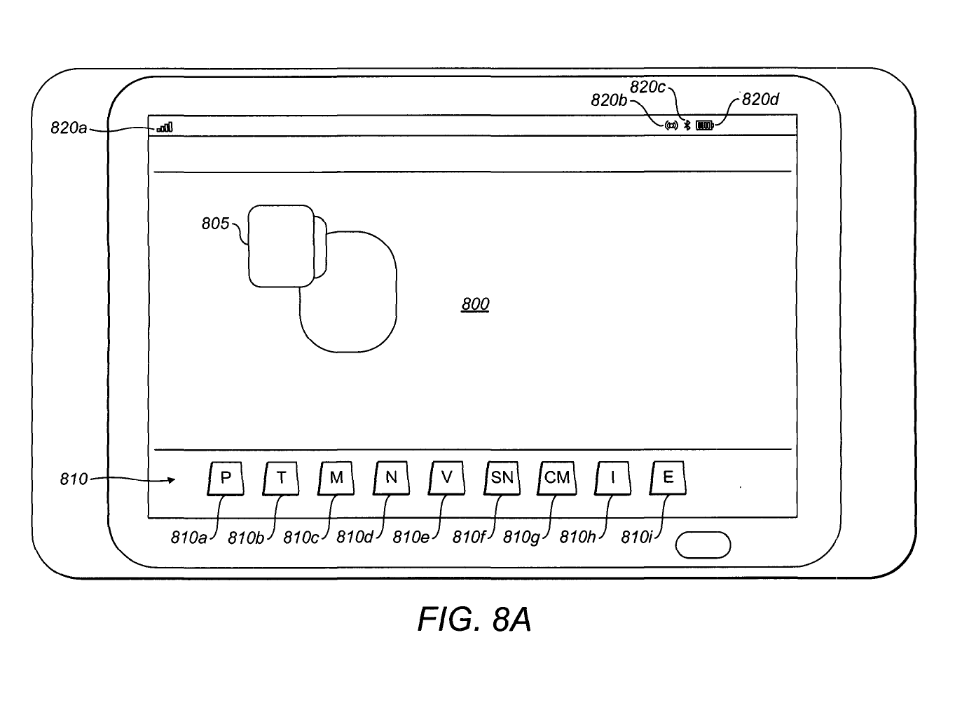

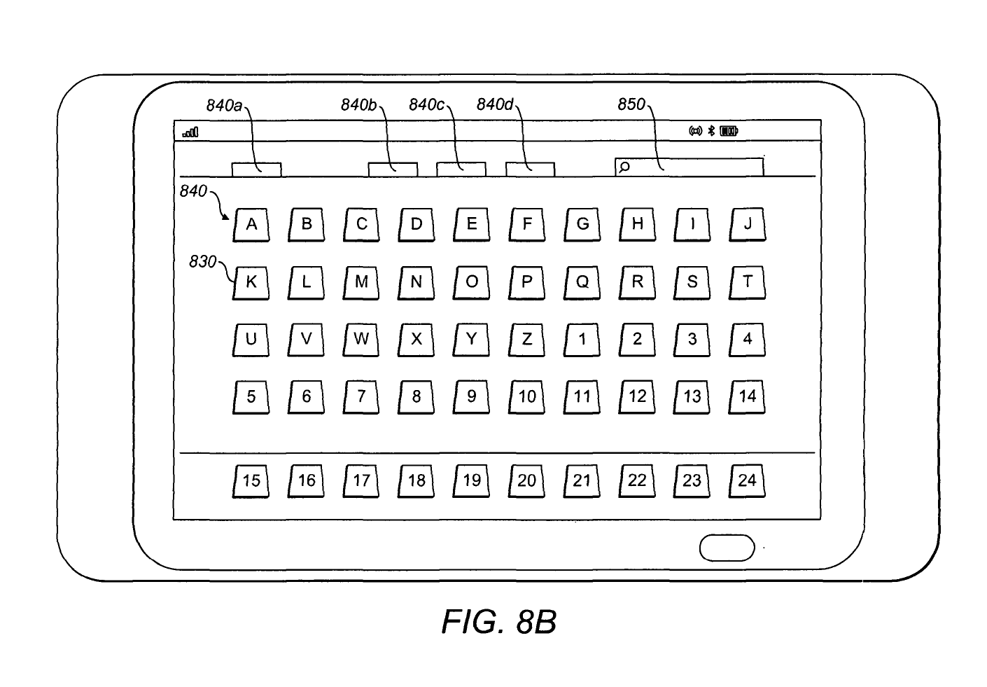

At the top of the software stack sit one or more applications 750. Depending on the operating system used these applications may be implemented using, amongst others, C++, .NET or Java ME language environments. Example applications are shown in FIG. 8A. Applications may be installed on the device from a central repository.

### User Interface

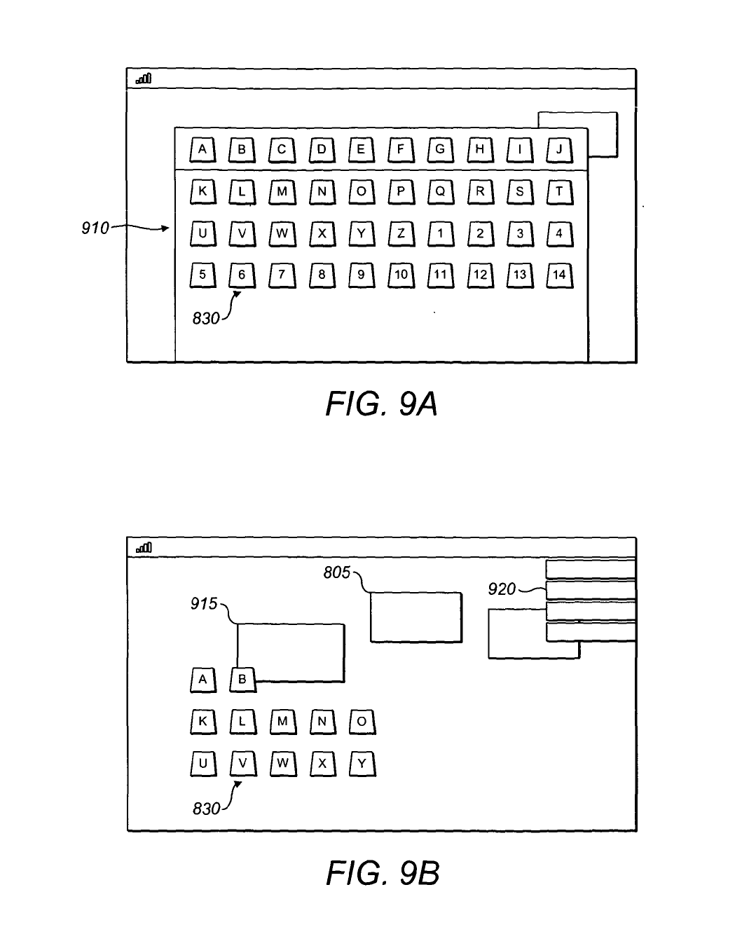

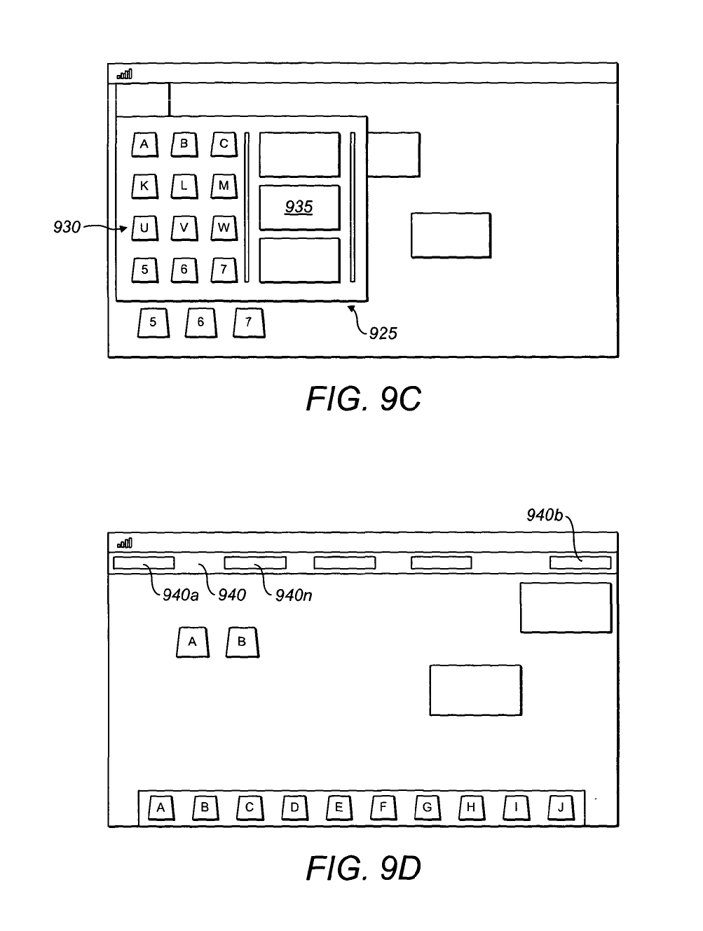

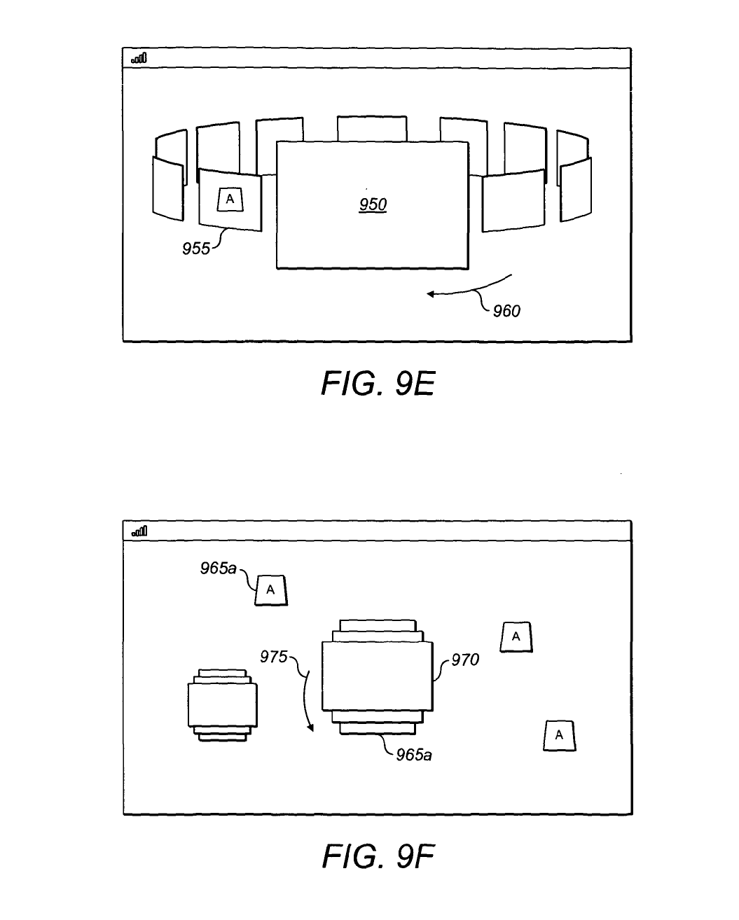

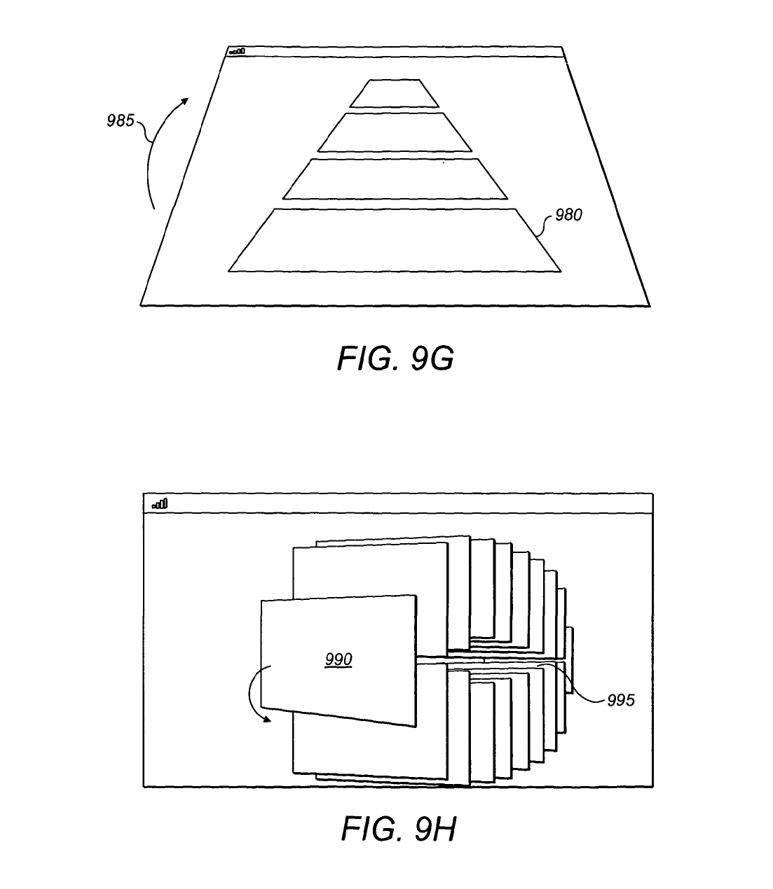

FIG. 8A shows an exemplary user interface (UI) implemented on the touch-screen of MCD 100. The interface is typically graphical, i.e. a GUI. The GUI is split into three main areas: background area 800, launch dock 810 and system bar 820. The GUI typically comprises graphical and textual elements, referred to herein as components. In the present example, background area 800 contains three specific GUI components 805, referred to hereinafter as “widgets”. A widget comprises a changeable information arrangement generated by an application. The widgets 805 are analogous to the “windows” found in most common desktop operating systems, differing in that boundaries may not be rectangular and that they are adapted to make efficient use of the limited space available. For example, the widgets may not comprise tool or menu-bars and may have transparent features, allowing overlap. Widget examples include a media player widget, a weather-forecast widget and a stock-portfolio widget. Web-based widgets may also be provided; in this case the widget represents a particular Internet location or a uniform resource identifier (URI). For example, an application icon may comprise a short-cut to a particular news website, wherein when the icon is activated a HyperText Markup Language (HTML) page representing the website is displayed within the widget boundaries The launch dock 810 provides one way of viewing application icons. Application icons are another form of UI component, along with widgets. Other ways of viewing application icons are described with relation to FIG. 9A to 9H. The launch dock 810 comprises a number of in-focus application icons. A user can initiate an application by clicking on one of the in-focus icons. In the example of FIG. 8A the following applications have in-focus icons in the launch dock 810: phone 810-A, television (TV) viewer 810-B, music player 810-C, picture viewer 810-D, video viewer 810-E, social networking platform 810-F, contact manager 810-G, internet browser 810-H and email client 810-I. These applications represent some of the types of applications that can be implemented on the MCD 100. The launch dock 810 may be dynamic, i.e. may change based on user-input, use and/or use parameters. In the present example, a user-configurable set of primary icons are displayed as in-focus icons. By performing a particular gesture on the touch-screen, for example by swiping the launch dock 810, other icons may come into view. These other icons may include one or more out-of-focus icons shown at the horizontal sides of the launch dock 810, wherein out-of-focus refers to icons that have been blurred or otherwise altered to appear out-of-focus on the touch-screen 11.

System bar 820 shows the status of particular system functions. For example, the system bar 820 of FIG. 8A shows: the strength and type of a telephony connection 820-A; if a connection to a WLAN has been made and the strength of that connection (“wireless indicator”) 820-B; whether a proximity wireless capability (e.g. Bluetooth™) is activated 820-C; and the power status of the MCD 820-D, for example the strength of the battery and/or whether the MCD is connected to a mains power supply. The system bar 820 can also display date, time and/or location information 820-E, for example “6.00 pm-Thursday 23 Mar. 2015-Munich”.

FIG. 8A shows a mode of operation where the background area 800 contains three widgets. The background area 800 can also display application icons as shown in FIG. 8B. FIG. 8B shows a mode of operation in which application icons 830 are displayed in a grid formation with four rows and ten columns. Other grid sizes and icon display formats are possible. A number of navigation tabs 840 are displayed at the top of the background area 800. The navigation tabs 840 allow the user to switch between different “pages” of icons and/or widgets. Four tabs are visible in FIG. 8B: a first tab 840-A that dynamically searches for and displays all application icons relating to all applications installed or present on the MCD 100; a second tab 840-B that dynamically searches for and displays all active widgets; a third tab 840-C that dynamically searches for and displays all application icons and/or active widgets that are designated as a user-defined favorite; and a fourth tab 840-D which allows the user to scroll to additional tabs not shown in the current display. A search box 850 is also shown in FIG. 8B. When the user performs an appropriate gesture, for example taps once on the search box 850, a keyboard widget (not shown) is displayed allowing the user to enter in the name of whole or part of an application. On text entry and/or performance of an additional gesture, application icons and/or active widgets that match the entered search terms are displayed in background area 800. A default or user-defined arrangement of application icons 830 and/or widgets 805 may be set as a “home screen”. This home-screen may be displayed on display 210B when the user presses home button 125.

### User Interface Methods

FIGS. 9A to 9H illustrate functionality of the GUI for the MCD 100. Zero or more of the methods described below may be incorporated into the GUI and/or the implemented methods may be selectable by the user. The methods may be implemented by the UI framework 730.

FIG. 9A shows how, in a particular embodiment, the launch dock 810 may be extendable. On detection of a particular gesture performed upon the touch-screen 110 the launch dock 810 expands upwards to show an extended area 910. The extended area 910 shows a number of application icons 830 that were not originally visible in the launch dock 810. The gesture may comprise an upward swipe by one finger from the bottom of the touch-screen 110 or the user holding a finger on the launch dock 810 area of the touch-screen 110 and then moving said finger upwards whilst maintaining contact with the touch-screen 110. This effect may be similarly applied to the system bar 820, with the difference being that the area of the system bar 820 expands downwards. In this latter case, extending the system bar 820 may display operating metrics such as available memory, battery time remaining, and/or wireless connection parameters.

FIG. 9B shows how, in a particular embodiment, a preview of an application may be displayed before activating the application. In general an application is initiated by performing a gesture on the application icon 830, for example, a single or double tap on the area of the touch-screen 110 displaying the icon. In the particular embodiment of FIG. 9B, an application preview gesture may be defined. For example, the application preview gesture may be defined as a tap and hold gesture on the icon, wherein a finger is held on the touch-screen 110 above an application icon 830 for a predefined amount of time such as two or three seconds. When a user performs an application preview gesture on an application icon 830 a window or preview widget 915 appears next the icon. The preview widget 915 may display a predefined preview image of the application or a dynamic control. For example, if the application icon 830 relates to a television or video-on-demand channel then the preview widget 915 may display a preview of the associated video data stream, possibly in a compressed or down-sampled form. Along with the preview widget 915 a number of buttons 920 may also be displayed. These buttons may allow the initiation of functions relating to application being previewed: for example, “run application”; “display active widget”; “send/share application content” etc.

FIG. 9C shows how, in a particular embodiment, one or more widgets and one or more application icons may be organised in a list structure. Upon detecting a particular gesture or series of gestures applied to the touch screen 110 a dual-column list 925 is displayed to the user. The list 925 comprises a first column which itself contains one or more columns and one or more rows of application icons 930. A scroll-bar is provided to the right of the column to allow the user to scroll to application icons that are not immediately visible. The list 925 also comprises a second column containing zero or more widgets 935. These may the widgets that are currently active on the MCD 100. A scroll-bar is also provided to the right of the column to allow the user to scroll to widgets that are not immediately visible.

FIG. 9D shows how, in a particular embodiment, one or more reduced-size widget representations or “mini-widgets” 940-N may be displayed in a “drawer” area 940 overlaid over background area 800. The “drawer” area typically comprises a GUI component and the mini-widgets may comprise buttons or other graphical controls overlaid over the component. The “drawer” area 940 may become visible upon the touch-screen following detection of a particular gesture or series of gestures. “Mini-widget” representations may be generated for each active widget or alternatively may be generated when a user drags an active full-size widget to the “drawer” area 940. The “drawer” area 940 may also contain a “back” button 940-A allowing the user to hide the “drawer” area and a “menu” button 940-B allowing access to a menu structure.

FIG. 9E shows how, in a particular embodiment, widgets and/or application icons may be displayed in a “fortune wheel” or “carousel” arrangement 945. In this arrangement GUI components are arranged upon the surface of a virtual three-dimensional cylinder, the GUI component closest to the user 955 being of a larger size than the other GUI components 950. The virtual three-dimensional cylinder may be rotated in either a clockwise 960 or anticlockwise direction by performing a swiping gesture upon the touch-screen 110. As the cylinder rotates and a new GUI component moves to the foreground it is increased in size to replace the previous foreground component.

FIG. 9F shows how, in a particular embodiment, widgets and/or application icons may be displayed in a “rolodex” arrangement 965. This arrangement comprises one or more groups of GUI components, wherein each group may include a mixture of application icons and widgets. In each group a plurality of GUI components are overlaid on top of each other to provide the appearance of looking down upon a stack or pile of components. Typically the overlay is performed so that the stack is not perfectly aligned; the edges of other GUI components may be visible below the GUI component at the top of the stack (i.e. in the foreground). The foreground GUI component 970 may be shuffled to a lower position in the stack by performing a particular gesture or series of gestures on the stack area. For example, a downwards swipe 975 of the touch-screen 110 may replace the foreground GUI component 970 with the GUI component below the foreground GUI component in the stack. In another example, taping on the stack N times may move through N items in the stack such that the GUI component located N components below is now visible in the foreground. Alternatively, the shuffling of the stacks may be performed in response to a signal from an accelerometer or the like that the user is shaking the MCD 100.

FIG. 9G shows how, in a particular embodiment, widgets and/or application icons may be displayed in a “runway” arrangement 965. This arrangement comprises one or more GUI components 980 arranged upon a virtual three-dimensional plane oriented at an angle to the plane of the touch-screen. This gives the appearance of the GUI components decreasing in size towards the top of the touch-screen in line with a perspective view. The “run-way” arrangement may be initiated in response to a signal, from an accelerometer or the like, indicating that the user has tilted the MCD 100 from an approximately vertical orientation to an approximately horizontal orientation. The user may scroll through the GUI components by performing a particular gesture or series of gestures upon the touch-screen 110. For example, a swipe 985 of the touch-screen 110 from the bottom of the screen to the top of the screen, i.e. in the direction of the perspective vanishing point, may move the foreground GUI component 980 to the back of the virtual three-dimensional plane to be replaced by the GUI component behind.

FIG. 9H shows how, in a particular embodiment, widgets and/or application icons may be brought to the foreground of a three-dimensional representation after detection of an to application event. FIG. 9H shows a widget 990 which has been brought to the foreground of a three-dimensional stack 995 of active widgets. The arrows in the Figure illustrate that the widget is moved to the foreground on recent on an event associated with the widget and that the widget then retains the focus of the GUI. For example, an internet application may initiate an event when a website updates or a messaging application may initiate an event when a new message is received.

### Home Environment

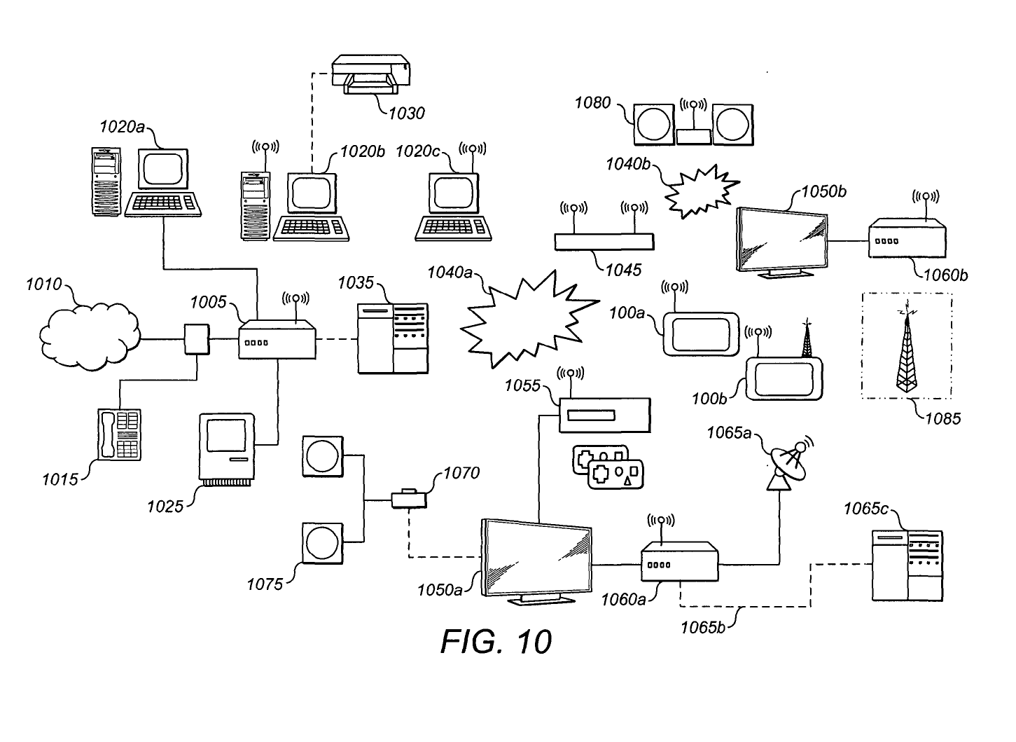

FIG. 10 shows an exemplary home network for use with the MCD 100. The particular devices and topology of the network are for example only and will in practice vary with implementation. The home network 1000 may be arranged over one or more rooms and/or floors of a home environment. Home network 1000 comprises router 1005. Router 1005 uses any known protocol and physical link mechanism to connect the home network 1000 to other networks. Preferably, the router 1005 comprises a standard digital subscriber line (DSL) modem (typically asynchronous). In other embodiments the DSL modem functionality may be replaced with equivalent (fibre optic) cable and/or satellite communication technology. In this example the router 1005 incorporates wireless networking functionality. In other embodiments the modem and wireless functionality may be provided by separate devices. The wireless capability of the router 1005 is typically IEEE 802.11 compliant although it may operate according to any wireless protocol known to the skilled person. Router 1005 provides the access point in the home to one or more wide area networks (WANs) such as the Internet 1010. The router 1005 may have any number of wired connections, using, for example, Ethernet protocols. FIG. 10 shows a Personal Computer (PC), which may run any known operating system, and a network-attached storage (NAS) device 1025 coupled to router 1005 via wired connections. The NAS device 1025 may store media content such as photos music and video that may be streamed over the home network 1000.

FIG. 10 additionally shows a plurality of wireless devices that communicate with the router 1005 to access other devices on the home network 1000 or the Internet 1010. The wireless devices may also be adapted to communicate with each other using ad-hoc modes of communication, i.e. communicate directly with each other without first communicating with router 1005. In this example, the home network 1000 comprises two spatially distinct wireless local area networks (LANs): first wireless LAN 1040A and second wireless LAN 1040B. These may represent different floors or areas of a home environment. In practice one or more wireless LANs may be provided. On the first wireless LAN 1040A, the plurality of wireless devices comprises router 1005, wirelessly-connected PC 1020B, wirelessly-connected laptop 1020C, wireless bridge 1045, one or more MCDs 100, a games console 1055, and a first set-top box 1060A. The devices are shown for example only and may vary in number and type. As well as connecting to the home network using wireless protocols, one or more of the MCDs 100 may comprise telephony systems to allow communication over, for example, the universal mobile telecommunications system (UMTS). Wireless access point 1045 allows the second wireless LAN 1040B to be connected to the first wireless LAN 1040A and by extension router 1005. If the second wireless LAN 1040B uses different protocols, wireless access point 1045 may comprise a wireless bridge. If the same protocols are used on both wireless LANs then the wireless access point 1045 may simply comprise a repeater. Wireless access point 1045 allows additional devices to connect to the home network even if such devices are out of range of router 1005. For example, connected to the second wireless LAN 1040B are a second set-top box 1060B and a wireless media processor 1080. Wireless media processor 1080 may comprise a device with integrated speakers adapted to receive and play media content (with or without a coupled display) or it may comprise a stand-alone device coupled to speakers and/or a screen by conventional wired cables.

The first and second televisions 1050A and 1050B are respectively connected to the first and second set-top boxes 1060A and 1060B. The set-top boxes 1060 may comprise any electronic device adapted to receive and render media content, i.e. any media processor. In the present example, the first set-top box 1060A is connected to one or more of a satellite dish 1065A and a cable connection 1065B. Cable connection 1065B may be any known co-axial or fibre optic cable which attaches the set-top box to a cable exchange 1065C which in turn is connected to a wider content delivery network (not shown). The second set-top box 1060B may comprise a media processor adapted to receive video and/or audio feeds over TCP/IP protocols (so-called “IPTV”) or may comprise a digital television receiver, for example, according to digital video broadcasting (DVB) standards. The media processing functionality of the set-top box may also be alternately incorporated into either television. Televisions may comprise any known television technology such as LCD, cathode ray tube (CRT) or plasma devices and also include computer monitors. In the following description a display such as one of televisions 1060 with media processing functionality, either in the form of a coupled or integrated set-top box is referred to as a “remote screen”. Games console 1055 is connected to the first television 1050A. Dock 1070 may also be optionally coupled to the first television 1050A, for example, using a high definition multimedia interface (HDMI). Dock 1070 may also be optionally connected to external speakers 1075. Other devices may also be connected to the home network 1000. FIG. 10 shows a printer 1030 optionally connected to wirelessly-connected PC 1020B. In alternative embodiments, printer 1030 may be connected to the first or second wireless LAN 1040 using a wireless print server, which may be built into the printer or provided separately. Other wireless devices may communicate with or over wireless LANs 1040 including hand-held gaming devices, mobile telephones (including smart phones), digital photo frames, and home automation systems. FIG. 10 shows a home automation server 1035 connected to router 1005. Home automation server 1035 may provide a gateway to access home automation systems. For example, such systems may comprise burglar alarm systems, lighting systems, heating systems, kitchen appliances, and the like. Such systems may be based on the X-10 standard or equivalents. Also connected to the DSL line which allows router 1005 to access the Internet 1010 is a voice-over IP (VOIP) interface which allows a user to connect voice-enabled phones to converse by sending voice signals over IP networks.

### Dock

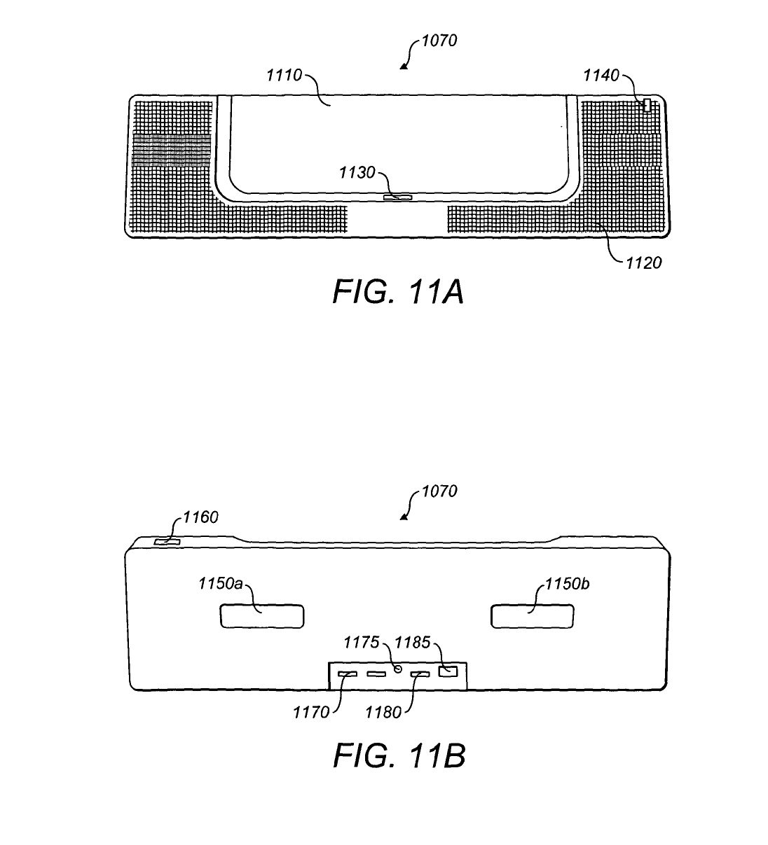

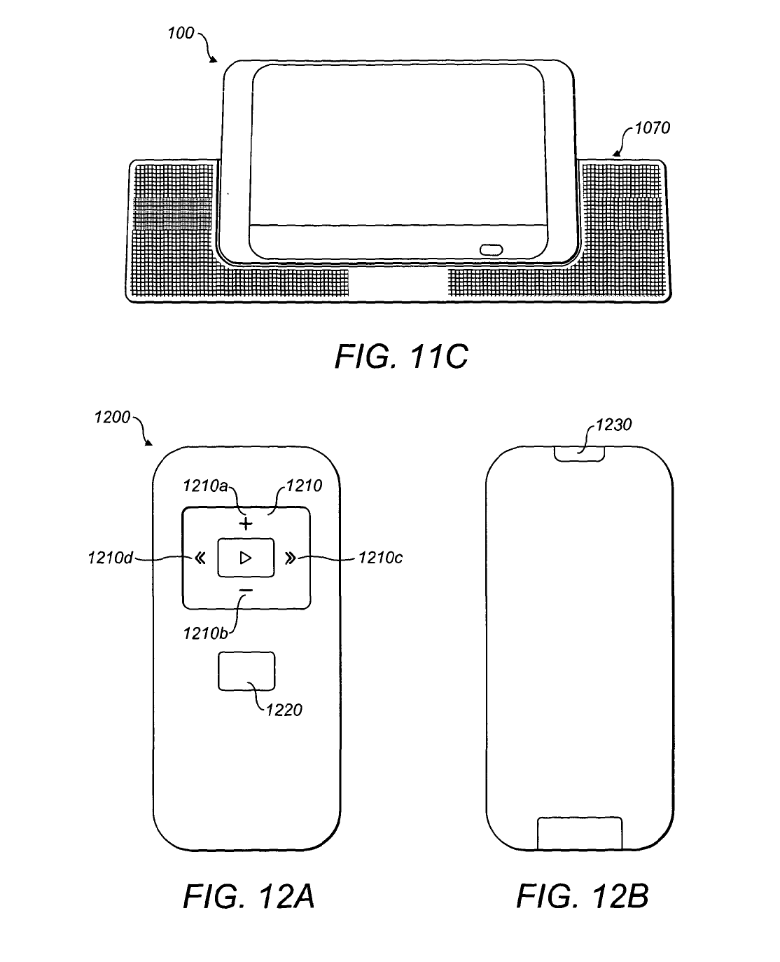

FIGS. 11A, 11B and 11C show dock 1070. FIG. 11A shows the front of the dock. The dock 1070 comprises a moulded indent 1110 in which the MCD 100 may reside. The dock 1070 comprises integrated speakers 1120. In use, when mounted in the dock, MCD 100 makes contact with a set of custom connector pins 1130 which mate with custom communications port 115. The dock 1070 may also be adapted for infrared communications and FIG. 11A shows an IR window 1140 behind which is mounted an IR transceiver. FIG. 11B shows the back of the dock. The back of the dock contains two sub-woofer outlets 1150 and a number of connection ports. On the top of the dock is mounted a dock volume key 1160 of similar construction to the volume key on the MCD 130. In this specific example, the ports on the rear of the dock 1070 comprise a number of USB ports 1170, in this case, two; a dock power in socket 1175 adapted to receive a power connector, a digital data connector, in this case, an HDMI connector 1180; and a networking port, in this case, an Ethernet port 1185. FIG. 11C shows the MCD 100 mounted in use in the dock 1070.

FIG. 12A shows a remote control 1200 that may be used with any one of the MCDs 100 or the dock 1070. The remote control 1200 comprises a control keypad 1210. In the present example, the control keypad contains an up volume key 1210A, a down volume key 1210B, a fast-forward key 1210C and a rewind key 1210D. A menu key is also provided 1220. Other key combinations may be provided depending on their design. FIG. 12B shows a rear view of the remote control indicating the IR window 1230 behind which is mounted an IR transceiver such that the remote control 1200 may communicate with either one of the MCDs 100 or dock 1070.

### First Embodiment

### Component Arrangement

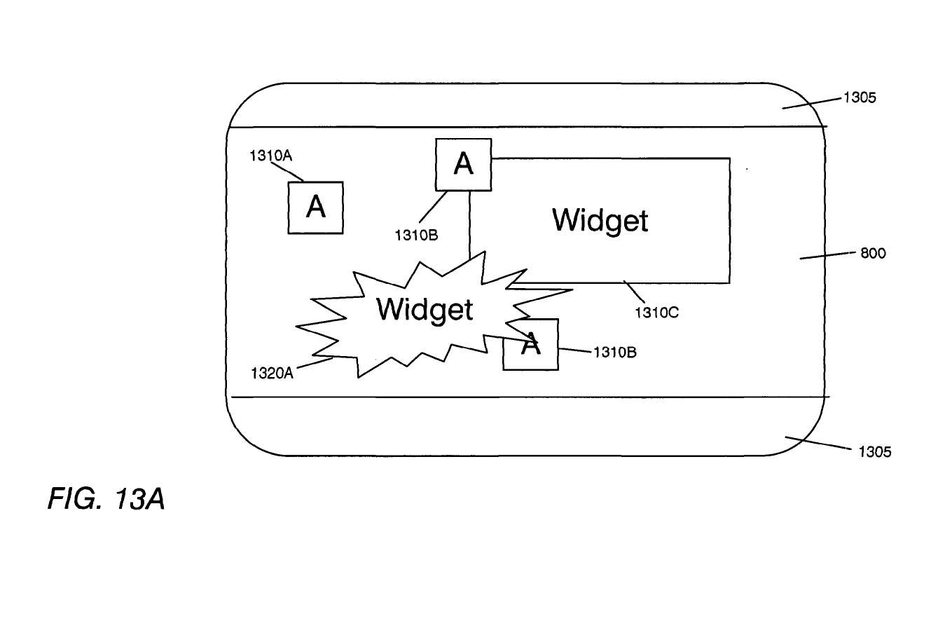

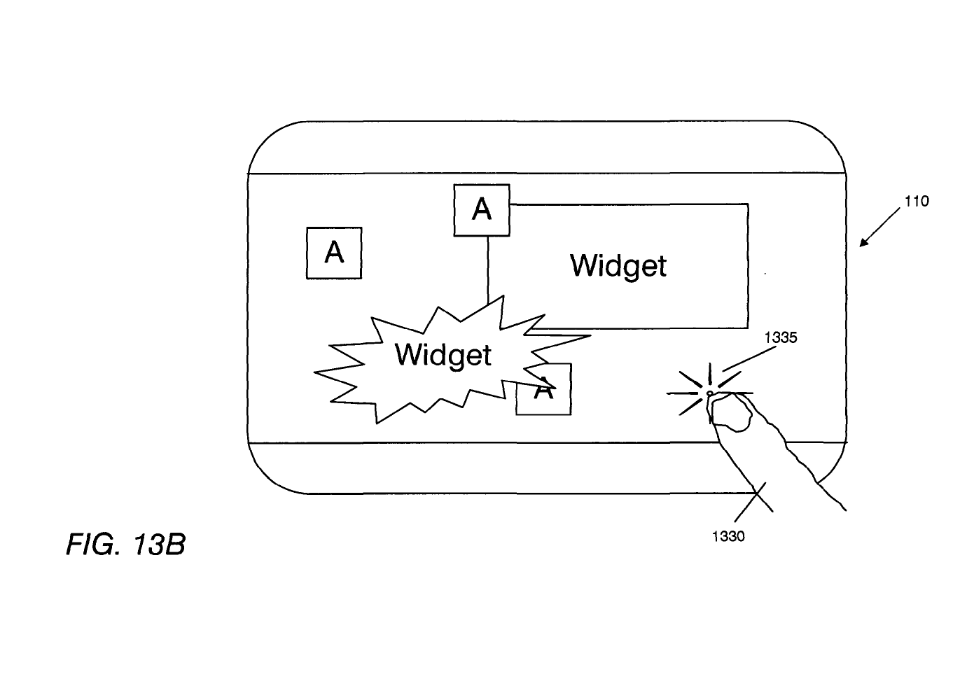

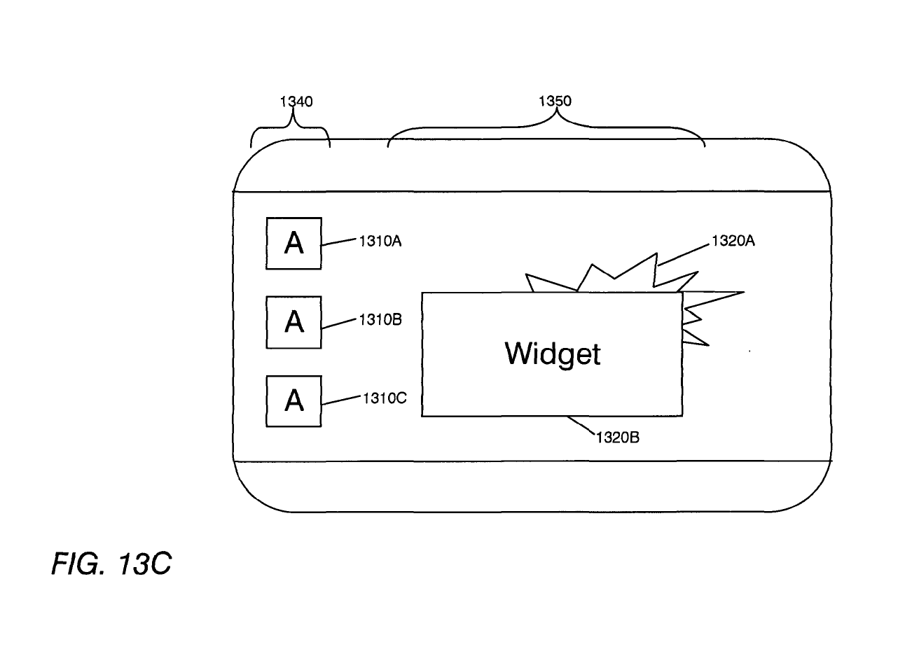

A first embodiment of the present invention provides a method for organising user interface (UI) components on the UI of the MCD 100. FIG. 13A is a simplified illustration of background area 800, as for example illustrated in FIG. 8A. GUI areas 1305 represent areas in which GUI components cannot be placed, for example, launch dock 810 and system bar 820 as shown in FIG. 8A. As described previously, the operating system 710 of the MCD 100 allows multiple application icons and multiple widgets to be displayed simultaneously. The widgets may be running simultaneously, for example, may be implemented as application threads which share processing time on CPU 215. The ability to to have multiple widgets displayed and/or running simultaneously may be of an advantage to the user. However, it can also quickly lead to visual “chaos”, i.e. a haphazard or random arrangement of GUI components in the background area 800. Generally, this is caused by the user opening and/or moving widgets over time. There is thus the problem of how to handle multiple displayed and/or running application processes on a device that has limited screen area. The present embodiment provides a solution to this problem.

The present embodiment provides a solution that may be implemented as part of the user-interface framework 730 in order to facilitate interaction with a number of concurrent processes. The present embodiment proposes two or more user interface modes: a first mode in which application icons and/or widgets may be arranged in UI as dictated by the user; and a second mode in which application icons and/or widgets may be arranged according to predefined graphical structure.

FIG. 13A displays this first mode. On background area 800, application icons 1310 and widgets 1320 have been arranged over time as a user interacts with the MCD 100. For example, during use, the user may have dragged application icons 1310 to their specific positions and may have initiated widgets 1320 over time by clicking on a particular application icon 1310. In FIG. 13A, widgets and application icons, may be overlaid on top of each other; hence widget 1320A is overlaid over application icon 1310C and widget 1320B. The positions of the widget and/or application icon in the overlaid arrangement may depend upon the time when the user last interacted with the application icon and/or widget. For example, widget 1320A is located on top of widget 1320B; this may represent the fact that the user last interacted with (or activated) widget 1320B. Alternatively, widget 1320A may be overlaid on top of other widgets when an event occurs in the application providing the widget. Likewise application icon 1310B may be overlaid over widget 1320B as the user may have dragged the application icon 1310B over widget 1320B at a point in time after activation of widget.

FIG. 13A is a necessary simplification of a real-world device. Typically, many more widgets may be initiated and many more application icons may be useable on the screen area. This can quickly lead to a “messy” or “chaotic” display. For example, a user may “lose” an application or widget as other application icons or widgets are overlaid on top of it. Hence, the first embodiment of the present invention provides a control function, for example as part of the user-interface framework 730, for changing to a UI mode comprising an ordered or structured arrangement of GUI components. This control function is activated on receipt of a particular sensory input, for example a particular gesture or series of gestures applied to the touch-screen 110.

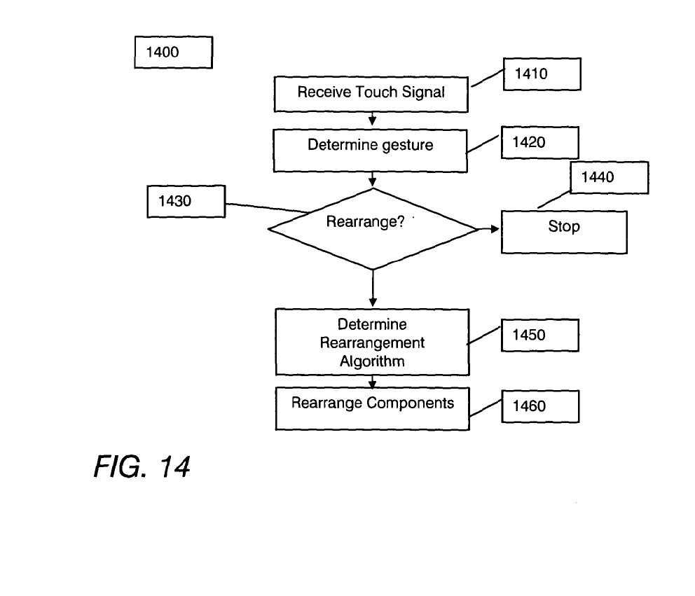

FIG. 13B shows a way in which mode transition is achieved. While operating in a first UI mode, for example a “free-form” mode, with a number of application and widgets haphazardly arranged (i.e. a chaotic display), the user performs a gesture on touch screen 110. “Gesture”, as used herein, may comprise a single activation of touch-screen 110 or a particular pattern of activation over a set time period. The gesture may be detected following processing of touch-screen input in the manner of FIGS. 5C and/or 6D or any other known method in the art. A gesture may be identified by comparing processed touch-screen data with stored patterns of activation. The detection of the gesture may take place, for example, at the level of the touch-screen panel hardware (e.g. using inbuilt circuitry), a dedicated controller connected to the touch-screen panel or may be performed by CPU 215 on receipt of signals from touch screen panel. In FIG. 13B, the gesture 1335 is a double-tap performed with a single finger 1330. However, depending on the assignment of gestures to functions, the gesture may be more complex and involve swiping motions and/or multiple activation areas. When a user double-taps their finger 1330 on touch-screen 110, this is detected by the device and the method shown in FIG. 14 begins.

At step 1410, a touch-screen signal is received. At step 1420 a determination is made as to what gesture was performed as discussed above. At step 1430 a comparison is made to determine whether the detected gesture is a gesture that has been assigned to the UI component re-arrangement. In an optional variation, rearrangement gestures may be detected based on their location in a particular area of touch-screen 110, for example within a displayed boxed area on the edge of the screen. If it is not then at step 1440 the gesture is ignored. If it is, then at step 1450 a particular UI component re-arrangement control function is selected. This may be achieved by looking up user configuration information or operating software data of the device. For example, an optionally-configurable look-up table may store an assignment of gestures to functions. The look-up table, or any gesture identification function, may be context specific; e.g. in order to complete the link certain contextual criteria need to be fulfilled such as operation in a particular OS mode. In other examples, a gesture may initiate the display of a menu containing two or more re-arrangement functions for selection. At step 1460 the selected function is used to re-arrange the GUI components upon the screen. This may involve accessing video data or sending commands to services to manipulate the displayed graphical components; for example, may comprise revising the location co-ordinates of UI components. FIG. 13C shows one example of re-arranged components. As can be seen, application icons 1310 have been arranged in a single column 1340. Widgets 1320B and 1320A have been arranged in another column 1350 laterally spaced from the application icon column 1340. FIG. 13C is provided for example, in other arrangements application icons 1310 and/or widgets 1320 may be provided in one or more grids of UI components or may be re-arranged to reflect one of the structured arrangements of FIGS. 9A to 9H. Any predetermined configuration of application icons and/or widgets may be used as the second arrangement.

A number of variations of the first embodiment will now be described. Their features may be combined in any configuration.

A first variation of the first embodiment involves the operation of a UI component re-arrangement control function. In particular, a control function may be adapted to arrange UI components in a structured manner according to one or more variables associated with each component. The variables may dictate the order in which components are displayed in the structured arrangement. The variables may comprise metadata relating to the application that the icon or widget represents. This metadata may comprise one or more of: application usage data, such as the number of times an application has been activated or the number of times a particular web site has been visited; priorities or groupings, for example, a user may assign a priority value to an application or applications may be grouped (manually or automatically) in one or more groups; time of last activation and/or event etc. Typically, this metadata is stored and updated by application services 740. If a basic grid structure with one or more columns and one or more rows is used for the second UI mode, the ordering of the rows and/or columns may be based on the metadata. For example, the most frequently utilised widgets could be displayed in the top right grid cell with the ordering of the widgets in columns then rows being dependent on usage time. Alternatively, the rolodex stacking of FIG. 9F may be used wherein the icons are ordered in the stack according to a first variable, wherein each stack may be optionally sorted according to a second variable, such as application category; e.g. one stack may contain media playback applications while another stack may contain Internet sites.

A second variation of the first embodiment also involves the operation of a UI component re-arrangement control function. In this variation UI components in the second arrangement are organised with one or more selected UI components as a focus. For example, in the component arrangements of FIGS. 9E, 9F and 9G selected UI components 950, 970 and 980 are displayed at a larger size that surrounding components; these selected UI components may be said to have primary focus in the arrangements. If the UI components are arranged in a grid, then the primary focus may be defined as the centre or one of the corners of the grid. In this variation the gesture that activates the re-arrangement control function may be linked to one or more UI components on the touch-screen 110. This may be achieved by comparing the co-ordinates of the gesture activation area with the placement co-ordinates of the displayed UI components; UI components within a particular range of the gesture are deemed to be selected. Multiple UI components may be selected by a swipe gesture that defines an internal area; the selected UI components being those resident within the internal area. In the present variation, these selected components form the primary focus of the second structured arrangement. For example, if the user were to perform gesture 1335 in an area associated with widget 1320B in FIG. 13A then icons 1310A, 1310B, 1310C and 1320A may be arranged around and behind widget 1320B, e.g. widget 1320B may become the primary focus widget 950, 970, 980 of FIGS. 9E to 9F. In a grid arrangement, widget 1320B may be placed in a central cell of the grid or in the top left corner of the grid. The location of ancillary UI components around one or more components that have primary focus may be ordered by one or more variables, e.g. the metadata as described above. For example, UI components may be arranged in a structured arrangement consisting of a number of concentric rings of UI components with the UI components that have primary focus being located in the centre of these rings; other UI components may then be located a distance, optionally quantised, from the centre of the concentric rings, the distance proportional to, for example, the time elapsed since last use or a user preference.

A third variation of the first embodiment allows a user to return from the second mode of operation to the first mode of operation; i.e. from an ordered or structured mode to a haphazard or (pseudo)-randomly arranged mode. As part of rearranging step 1460 the control function may store the UI component configuration of the first mode. This may involve saving display or UI data, for example, that generated by OS services 720 and/or UI-framework 730. This data may comprise the current application state and co-ordinates of active UI components. This data may also be associated with a time stamp indicating the time at which rearrangement (e.g. the steps of FIG. 14) occurred.

After the UI components have been arranged in a structured form according to the second mode the user may decide they wish to view the first mode again. This may be the case if the user only required a structured arrangement of UI components for a brief period, for example, to locate a particular widget or application icon for activation. To return to the first mode the user may then perform a further gesture, or series of gestures, using the touch-screen. This gesture may be detected as described previously and its associated control function may be retrieved. For example, if a double-tap is associated with a transition from the first mode to the second mode, a single or triple tap could be associated with a transition from the second mode to the first mode. The control function retrieves the previously stored display data and uses this to recreate the arrangement of UI components at the time of the transition from the first mode to the second mode, for example may send commands to UI framework 730 to redraw the display such that the mode of display is changed from that shown in FIG. 13C back to the chaotic mode of FIG. 13A.

The first embodiment, or any of the variations of the first embodiment, may be limited to UI components within a particular application. For example, the UI components may comprise contact icons within an address book or social networking application, wherein different structured modes represent different ways in which to organise the contact icons in a structured form.

A fourth variation of the first embodiment allows two or more structured or ordered modes of operation and two or more haphazard or chaotic modes of operation. This variation builds upon the third variation. As seen in FIGS. 9A to 9H and the description above there may be multiple ways in which to order UI components; each of these multiple ways may be associated with a particular mode of operation. A transition to a particular mode of operation may have a particular control function, or pass a particular mode identifier to a generic control function. The particular structured mode of operation may be selected from a list presented to the user upon performing a particular gesture or series of gestures. Alternatively, a number of individual gestures or gesture series may be respectively linked to a respective number of control functions or respective mode identifiers. For example, a single-tap followed user-defined gesture may be registered against a particular mode. The assigned gesture or gesture series may comprise an alpha-numeric character drawn with the finger or a gesture indicative of the display structure, such as a circular gesture for the fortune wheel arrangement of FIG. 9E.

Likewise, multiple stages of haphazard or free-form arrangements may be defined. These may represent the arrangement of UI components at particular points in time. For example, a user may perform a first gesture on a chaotically-organised screen to store the arrangement in memory as described above. They may also store and/or link a specific gesture with the arrangement. As the user interacts with the UI components, he may further store further arrangements and associated gestures. To change the present arrangement to a previously-defined arrangement, the user performs the assigned gesture. This may comprise performing to the method of FIG. 14, wherein the assigned gesture is linked to a control function, and the control function is associated with a particular arrangement in time or is passed data identifying said arrangement. The gesture or series of gestures may be intuitively linked to the stored arrangements, for example, the number of taps a user performs upon the touch-screen 110 may be linked to a particular haphazard arrangement or a length of time since the haphazard arrangement was viewed. For example, a double-tap may modify the display to show a chaotic arrangement of 2 minutes ago and/or a triple-tap may revert back to the third-defined chaotic arrangement. “Semi-chaotic” arrangements are also possible, wherein one or more UI components are organised in a structured manner, e.g. centralised on screen, while other UI components retain their haphazard arrangement.

A fourth variation of the first embodiment replaces the touch-screen signal received at step 1410 in FIG. 14 with another sensor signal. In this case a gesture is still determined but the gesture is based upon one or more sensory signals from one or more respective sensory devices other than the touch-screen 110. For example, the sensory signal may be received from motion sensors such as an accelerometer and/or a gyroscope. In this case the gesture may be a physical motion gesture that is characterised by a particular pattern of sensory signals; for example, instead of a tap on a touch-screen UI component rearrangement may be initialised based on a “shake” gesture, wherein the user rapidly moves the MCD 100 within the plane of the device, or a “flip” gesture, wherein the user rotates the MCD 100 such that the screen rotates from a plane facing the user. Visual gestures may also be detected using still 345 or video 350 cameras and auditory gestures, e.g. particular audio patterns, may be detected using microphone 120. Furthermore, a mix of touch-screen and non-touch-screen gestures may be used. For example, in the third and fourth variations, particular UI modes may relate to particular physical, visual, auditory and/or touch-screen gestures.

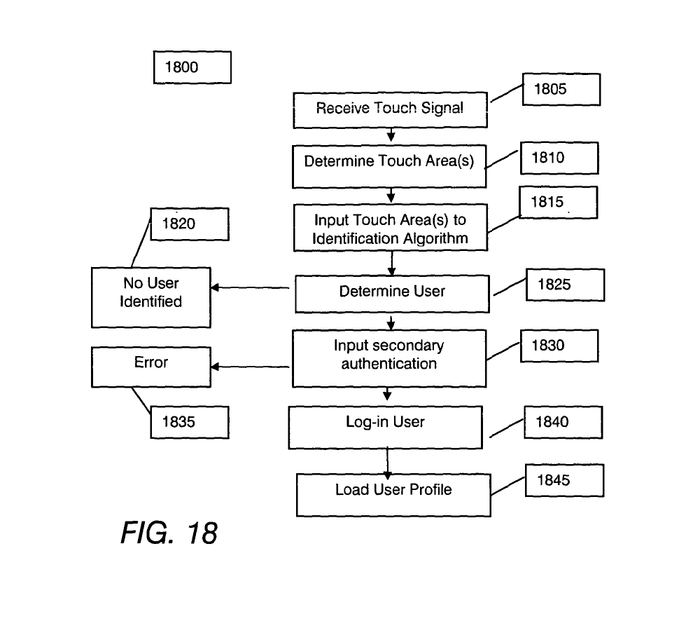

In the first embodiment, as with the other embodiments described below, features may be associated with a particular user by way of a user account. For example, the association between gestures and control function operation, or the particular control function(s) to use, may be user-specific based on user profile data. User profile data may be loaded using the method of FIG. 18. Alternatively a user may be identified based on information stored in a SIM card such as the International Mobile Equipment Identity (IMEI) number.

### Second Embodiment

### UI Component Pairing

A second embodiment of the present invention will now be described. The second embodiment provides a method for pairing UI components in order to produce new functionality. The method facilitates user interaction with the MCD 100 and compensates for the limited screen area of the device. The second embodiment therefore provides a novel way in which a user can intuitively activate applications and/or extend the functionality of existing applications.

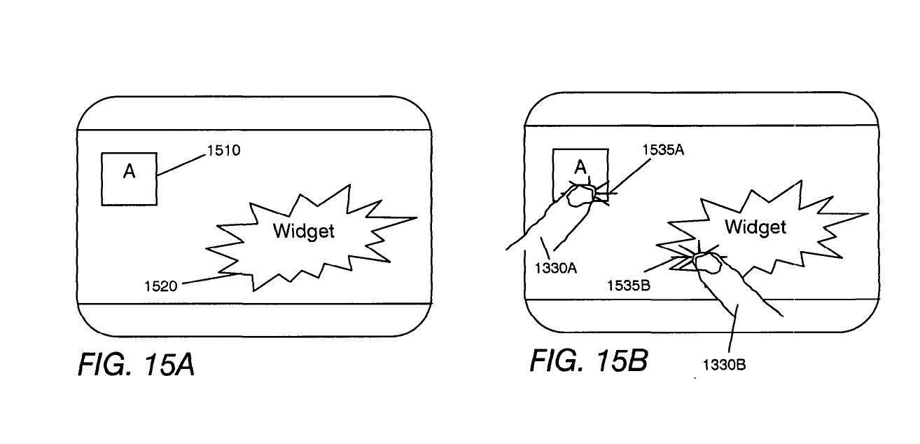

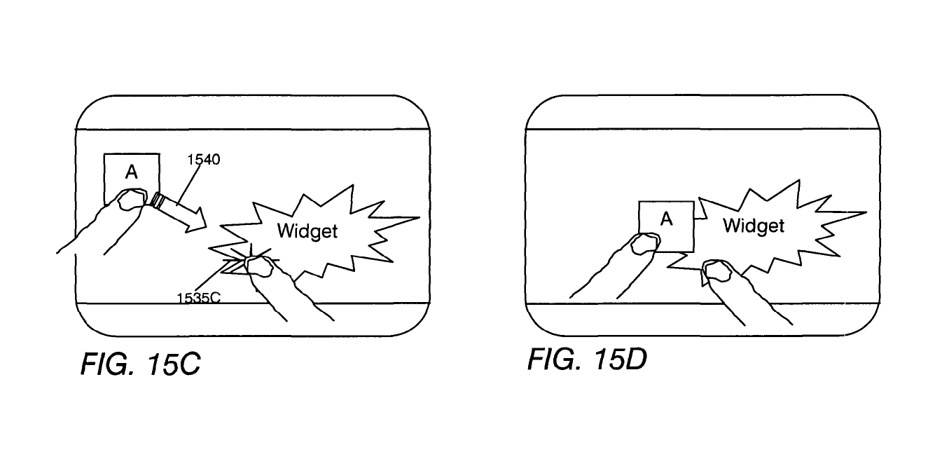

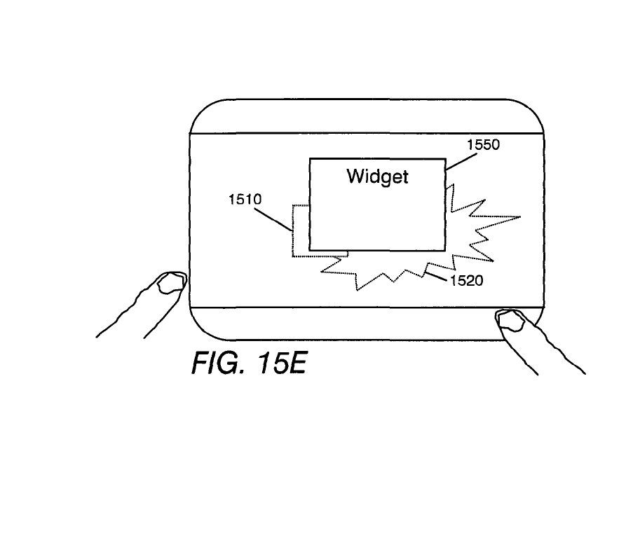

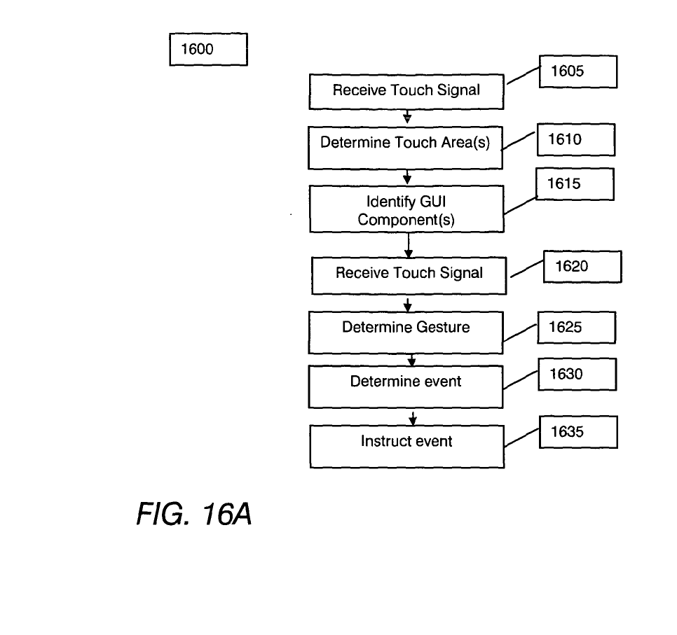

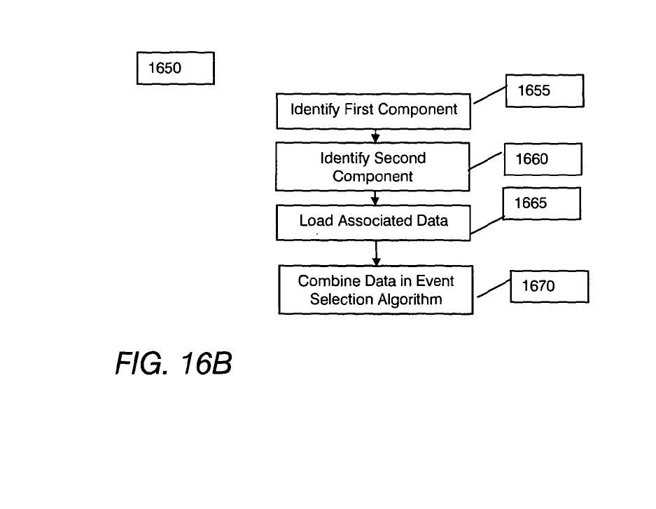

FIGS. 15A to 15D illustrate the events performed during the method of FIG. 16A. FIG. 15A shows two UI components. An application icon 1510 and a widget 1520 are shown. However, any combination of widgets and application icons may be used, for example, two widgets, two application items or a combination of widgets and application icons. At step 1605 in the method 1600 of FIG. 16A one or more touch signals are received. In the present example, the user taps, i.e. activates 1535, the touch-screen and maintains contact with the areas of touch-screen representing both the application icon 1510 and the widget 1520. However, the second embodiment is not limited to this specific gesture for selection and other gestures, such as a single tap and release or a circling of the application icon 1510 or widget 1520 may be used. At step 1610 the areas of the touch-screen activated by the user are determined. This may involve determining touch area characteristics, such as area size and (x, y) coordinates as described in relation to FIGS. 5B and 6D. At step 1650, the UI components relating to the touched areas are determined. This may involve matching the touch area characteristics, e.g. the (x, y) coordinates of the touched areas, with display information used to draw and/or locate graphical UI components upon the screen of the MCD 100. For example, in FIG. 15B, it is determined that a touch area 1535A corresponds to a screen area in which a first UI component, application icon 1510, is displayed, and likewise that touch area 1535B corresponds to a screen area in which a second UI component, widget 1520, is displayed. Turning now to FIG. 15C, at step 1620 a further touch signal is received indicating a further activation of touch-screen 110. In the present example, the activation corresponds to the users swiping their first finger 1530A in a direction indicated by arrow 1540. This direction is from application icon 1510 towards widget 1520, i.e. from a first selected UI component to a second selected UI component. As the user's first finger 1530A maintains contact with the touch-screen and drags finger 1530A across the screen in direction 1540, the intermediate screen area between application icon 1510 and widget 1520 may be optionally animated to indicate the movement of application icon 1510 towards widget 1520. The user may maintain the position of the user's second finger 1530B at contact point 1535C. After dragging application icon 1510 in direction 1540, such that application icon 1510 overlaps widget 1520, a completed gesture is detected at step 1625. This gesture comprises dragging a first UI component such that it makes contact with a second UI component. In certain embodiments the identification of the second UI component may be solely determined by analysing the end co-ordinates of this gesture, i.e. without determining a second touch area as described above.

At step 1630 an event to be performed is determined. This is described in more detail in relation to FIG. 16B and the variations of the second embodiment. In the present example, after detection of the gesture, a look-up table indexed by information relating to both application icon 1510 and widget 1520 is evaluated to determine the event to be performed. The look-up table may be specific to a particular user, e.g. forming part of user profile data, may be generic for all users, or may be constructed in part from both approaches. In this case, the event is the activation of a new widget. This event is then instructed at step 1635. As shown in FIG. 15E this causes the activation of a new widget 1550, which has functionality based on the combination of application icon 1510 and widget 1520.

Some examples of the new functionality enabled by combining two UI components will now be described. In a first example, the first UI component represents a particular music file and the second UI component represents an alarm function. When the user identifies the two UI components and performs the combining gesture as described above, the identified event comprises updating settings for the alarm function such that the selected music file is the alarm sound. In a second example, the first UI component may comprise an image, image icon or image thumbnail and widget 1520 may represent a social networking application, based either on the MCD 100 or hosted online. The determined event for the combination of these two components may comprise instructing a function, e.g. through an Application Program Interface (API) of the social networking application, that “posts”, i.e. uploads, the image to the particular social networking application, wherein user data for the social networking application may be derived from user profile data as described herein. In a third example, the first UI component may be an active game widget and the second UI component may be a social messaging widget. The event performed when the two components are made to overlap may comprise publishing recent high-scores using the social messaging widget. In a fourth example, the first UI component may be a web-browser widget showing a web-page for a music event and the second UI component may be a calendar application icon. The event performed when the two components are made to overlap may comprise creating a new calendar appointment for the music event.

In a second variation of the second embodiment, each application installed on the device has associated metadata. This may comprise one or more register entries in OS kernel 710, an accompanying system file generated on installation and possibly updated during use, or may be stored in a database managed by application services 740. The metadata may have static data element that persist when the MCD 100 is turned off and dynamic data elements that are dependent on an active user session. Both types of elements may be updated during use. The metadata may be linked with display data used by UI framework 730. For example, each application may comprise an identifier that uniquely identifies the application. Displayed UI components, such as application icons and/or widgets may store an application identifier identifying the application to which it relates. Each rendered UI component may also have an identifier uniquely identifying the component. A tuple comprising (component identifier, application identifier) may thus be stored by UI framework 730 or equivalent services. The type of UI component, e.g. widget or icon, may be identified by a data variable.

When the user performs the method of FIG. 16A, the method of FIG. 16B is used to determine the event at step 1630. At step 1655, the first UI component is identified. At step 1660 the second UI component is also identified. This may be achieved using the methods described above with relation to the first embodiment and may comprise determining the appropriate UI component identifiers. At step 1665, application identifiers associated with each identified GUI component are retrieved. This may be achieved by inspecting tuples as described above, either directly or via API function calls. Step 1665 may be performed by the UI framework 730, application services 740 or by an interaction of the two modules. After retrieving the two application identifiers relating to the first and second UI components, this data may be input into an event selection algorithm at step 1670. The event selection algorithm may comprise part of application services 740, UI framework 730 or OS services and libraries 720. Alternatively, the event selection algorithm may be located on a remote server and initiated through a remote function call. In the latter case, the application identifiers will be sent in a network message to the remote server. In a simple embodiment, the event selection algorithm may make use of a look-up table. The look-up table may have three columns, a first column containing a first set of application identifiers, a second column containing a second set of application identifiers and a third column indicating functions to perform, for example in the form of function calls. In this simple embodiment, the first and second application identifiers are used to identify a particular row in the look-up table and thus retrieve the corresponding function or function call from the identified row. The algorithm may be performed locally on the MCD 100 or remotely, for example by the aforementioned remote server, wherein in the latter case a reference to the identified function may be sent to the MCD 100. The function may represent an application or function of an application that is present on the MCD 100. If so the function may be initiated. In certain cases, the function may reference an application that is not present on the MCD 100. In the latter case, while identifying the function, the user may be provided with the option of downloading and/or installing the application on the MCD 100 to perform the function. If there is no entry for the identified combination of application identifiers, then feedback may be provided to the user indicating that the combination is not possible. This can be indicated by an auditory or visual alert.

In more advanced embodiments, the event selection algorithm may utilise probabilistic methods in place of the look-up table. For example, the application identifiers may allow more detailed application metadata to be retrieved. This metadata may comprise application category, current operating data, application description, a user-profile associated with the description, metadata tags identifying people, places or items etc. Metadata such as current operating data may be provided based data stored on the MCD 100 as described above and can comprise current file or URI opened by the application, usage data, and/or currently viewed data. Application category may be provided directly based on data stored on MCD 100 or remotely using categorical information accessible on a remote server, e.g. based on a communicated application identifier. Metadata may be retrieved by the event selection algorithm or passed to the algorithm from other services. Using the metadata the event selection algorithm may then provide a new function based on probabilistic calculations.

The order in which the first and second GUI components are selected may also affect the resulting function. For example, dragging an icon for a football (soccer) game onto an icon for a news website may filter the website for football news, whereas dragging an icon for a news website onto a football (soccer) game may interpret the game when breaking news messages are detected. The order may be set as part of the event selection algorithm; for example, a lookup table may store different entries for the game in the first column and the news website in the second column and the news website in the first column and the game in the second column.

For example, based on the categories of two paired UI components, a reference to a widget in a similar category may be provided. Alternatively, a list of suggestions for appropriate widgets may be provided. In both cases, appropriate recommendation engines may be used. In another example, first UI component may be widget displaying a news website and second UI component may comprise an icon for a sports television channel. By dragging the icon onto the widget, metadata relating to the sports television channel may be retrieved, e.g. categorical data identifying a relation to football, and the news website or new service may be filtered to provide information based on the retrieved metadata, e.g. filtered to return articles relating to football. In another example, the first UI component may comprise an image, image icon, or image thumbnail of a relative and second UI component may comprise a particular internet shopping widget. When the UI components are paired then the person shown in the picture may be identified by retrieving tags associated with the image. The identified person may then be identified in a contact directory such that characteristics of the person (e.g. age, sex, likes and dislikes) may be retrieved. This latter data may be extracted and used by recommendation engines to provide recommendations of, and display links to, suitable gifts for the identified relative

### Third Embodiment

### Authentication Method

Many operating systems for PCs allow multiple users to be authenticated by the operating system. Each authenticated user may be provided with a bespoke user interface, tailored to the user's preferences, e.g. may use a particular distinguished set of UI components sometimes referred to as a “skin”. In contrast, mobile telephony devices have, in the past, been assumed to belong to one particular user. Hence, whereas mobile telephony devices sometimes implement mechanisms to authenticate a single user, it is not possible for multiple users to use the telephony device.

The present embodiment of the present invention uses the MCD 100 as an authentication device to authenticate a user, e.g. log a user into the MCD 100, authenticate the user on home network 1000 and/or authenticate the user for use of a remote device such as PCs 1020. In the case of logging a user into the MCD 100, the MCD 100 is designed to be used by multiple users, for example, a number of family members within a household. Each user within the household will have different requirements and thus requires a tailored user interface. It may also be required to provide access controls, for example, to prevent children from accessing adult content. This content may be stored as media files on the device, media files on a home network (e.g. stored on NAS 1025) or content that provided over the Internet.

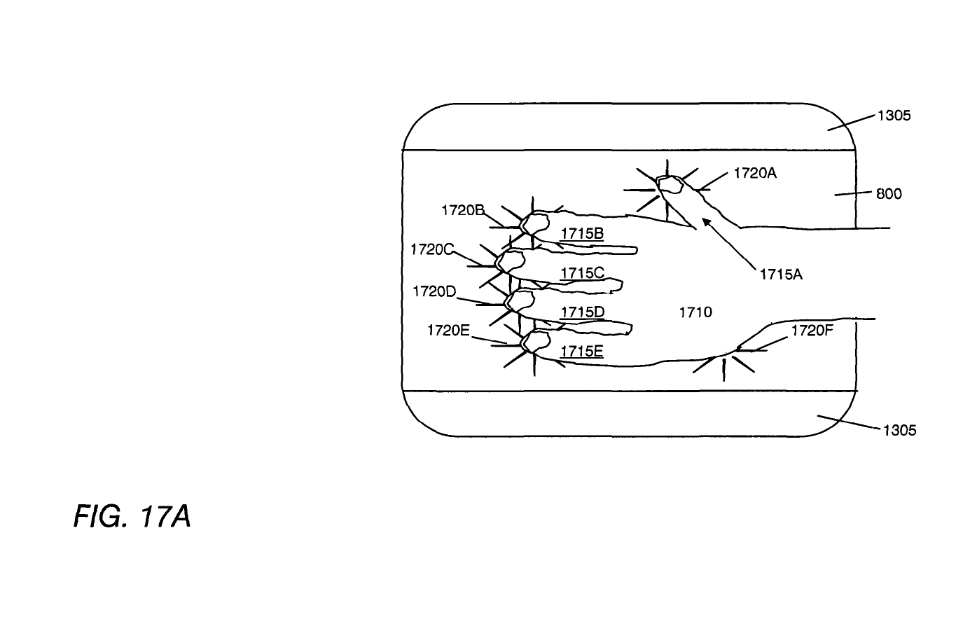

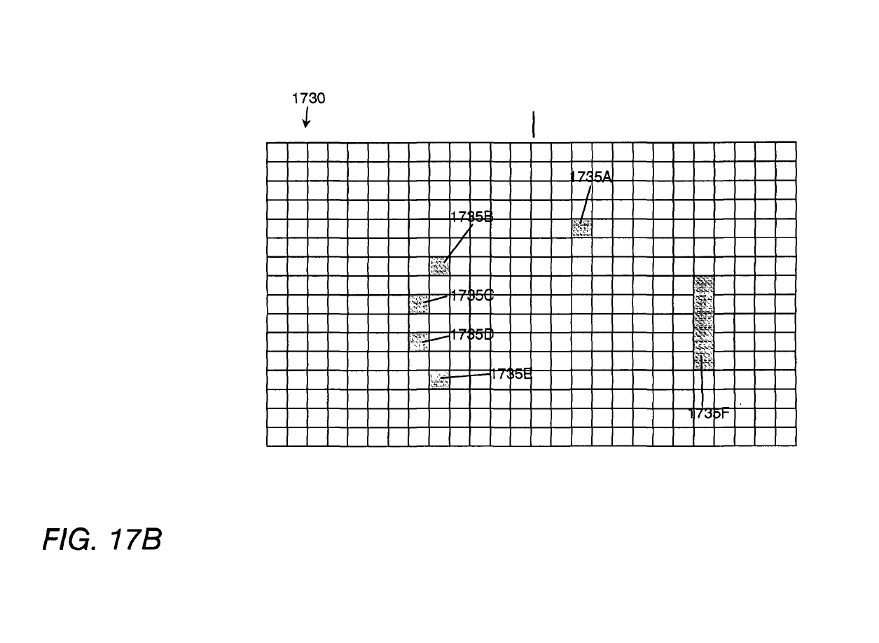

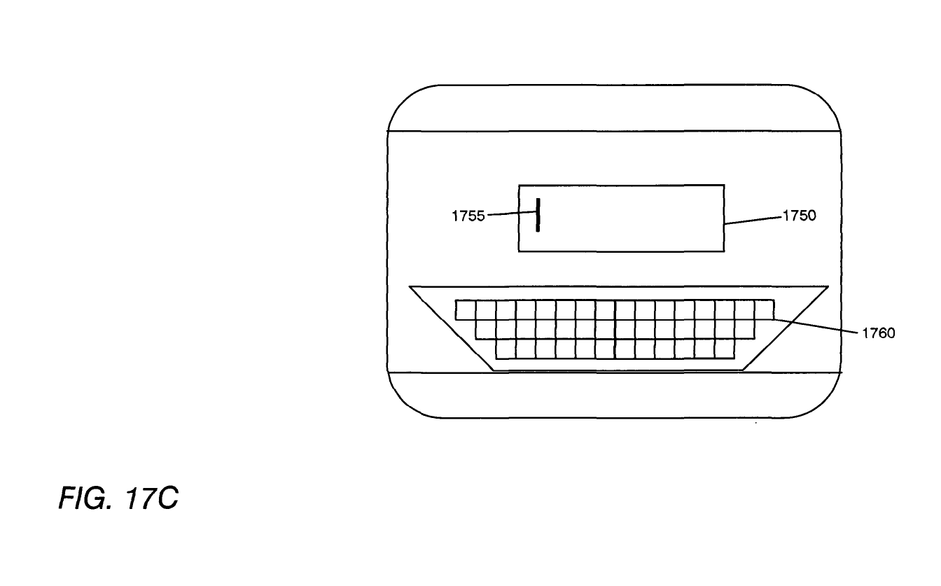

An exemplary login method, according to the third embodiment is illustrated in FIGS. 17A to 17C and the related method steps are shown in FIG. 18. In general, in this example, a user utilises their hand to identify themselves to the MCD 100. A secondary input is then used to further authorise the user. In some embodiments the secondary input may be optional. One way in which a user may be identified is by measuring the hand size of the user. This may be achieved by measuring certain feature characteristics that distinguish the hand size. Hand size may refer to specific length, width and/or area measurements of the fingers and/or the palm. To measure hand size, the user may be instructed to place their hand on the tablet as illustrated in FIG. 17A. FIG. 17A shows a user's hand 1710 placed on the touch-screen 110 of the MCD 100. Generally, on activation of the MCD 100, or after a period of time in which the MCD 100 has remained idle, the operating system of the MCD 100 will modify background area 800 such that a user must log into the device. At this stage, the user places their hand 1710 on the device, making sure that each of their five fingers 1715A to 1715E and the palm of the hand are making contact with the touch-screen 110 as indicated by activation areas 1720A to F. In variations of the present example, any combination or one or more fingers and/or palm touch areas may be used to uniquely identify a user based on their hand attributes, for example taking into account requirements of disabled users.

Turning to the method 1800 illustrated in FIG. 18, after the user has placed their hand on the MCD 100 as illustrated in FIG. 17A, the touch-screen 110 generates a touch signal, which as discussed previously may be received by a touch-screen controller or CPU 215 at step 1805. At step 1810, the touch areas are determined This may be achieved using the methods of, for example, FIG. 5B or FIG. 6D. FIG. 17B illustrates touch-screen data showing detected touch areas. A map as shown in FIG. 17B may not actually be generated in the form of an image; FIG. 17B simply illustrates for ease of explanation one set of data that may be generated using the touch-screen signal. The touch area data is shown as activation within a touch area grid 1730; this grid may be implemented as a stored matrix, bitmap, pixel map, data file and/or database. In the present example, six touch areas, 1735A to 1735F as illustrated in FIG. 17B, are used as input into an identification algorithm. In other variations more or less data may be used as input into the identification algorithm; for example, all contact points of the hand on the touch-screen may be entered into the identification algorithm as data or the touch-screen data may be processed to extract one or more salient and distinguishing data values. The data input required by identification algorithm depends upon the level of discrimination required from the identification algorithm, for example, to identify one user out of a group of five users (e.g. a family) an algorithm may require fewer data values than an algorithm for identifying a user out of a group of one hundred users (e.g. an enterprise organisation).

At step 1815, the identification algorithm processes the input data and attempts to identify the user at step 1825. In a simple form, the identification algorithm may simply comprise a look-up table featuring registered hand-area-value ranges; the data input into the algorithm is compared to that held in the look-up table to determine if it matches a registered user. In more complex embodiments, the identification algorithm may use advanced probabilistic techniques to classify the touch areas as belonging to a particular user, typically trained using previously registered configuration data. For example, the touch areas input into the identification algorithm may be processed to produce a feature vector, which is then inputted into a known classification algorithm. In one variation, the identification algorithm may be hosted remotely, allowing more computationally intensive routines to be used; in this case, raw or processed data is sent across a network to a server hosting the identification algorithm, which returns a message indicating an identified user or an error as in step 1820.

In a preferred embodiment of the present invention, the user is identified from a group of users. This simplifies the identification process and allows it to be carried out by the limited computing resources of the MCD 100. For example, if five users use the device in a household, the current user is identified from the current group of five users. In this case, the identification algorithm may produce a probability value for each registered user, e.g. a value for each of the five users. The largest probability value is then selected as the most likely user to be logging on and this user is chosen as the determined user as step 1825. In this case, if all probability values fail to reach a certain threshold, then an error message may be displayed as shown in step 1820, indicating that no user has been identified.

At step 1830, a second authentication step may be performed. A simple example of a secondary authentication step is shown in FIG. 17C, wherein a user is presented with a password box 1750 and a keyboard 1760. The user then may enter a personal identification number (PIN) or a password at cursor 1755 using keyboard 1760. Once the password is input, it is compared with configuration information; if correct, the user is logged in to the MCD 100 at step 1840; if incorrect, an error message is presented at step 1835. As well as, or in place of, logging into the MCD 100, at step 1840 the user may be logged into a remote device or network.

In the place of touch-screen 110, the secondary authentication means may also make use of any of the other sensors of the MCD 100. For example, the microphone 120 may be used to record the voice of the user. For example, a specific word or phrase may be spoken into the microphone 120 and this compared with a stored voice-print for the user. If the voice-print recorded on the microphone, or at least one salient feature of such a voice-print, matches the stored voice-print at the secondary authentication stage 1830 then the user will be logged in at step 1840. Alternatively, if the device comprises a camera 345 or 350, a picture or video of the user may be used to provide the secondary authentication, for example based on iris or facial recognition. The user could also associate a particular gesture or series of gestures with the user profile to provide a PIN or password. For example, a particular sequence of finger taps on the touch-screen could be compared with a stored sequence in order to provide secondary authentication at step 1830.

In an optional embodiment, a temperature sensor may be provided in MCD 100 to confirm that the first input is provided by a warm-blooded (human) hand. The temperature sensor may comprise a thermistor, which may be integrated into the touch-screen, or an IR camera. If the touch-screen 110 is able to record pressure data this may also be used to prevent objects other than a user's hand being used, for example, a certain pressure distribution indicative of human hand muscles may be required. To enhance security, further authentication may be required, for example, a stage of tertiary authentication may be used.

Once the user has been logged in to the device at step 1840 a user profile relating to the user is loaded at step 1845. This user profile may comprise user preferences and access controls. The user profile may provide user information for use with any of the other embodiments of the invention. For example, it may shape the “look and feel” of the UI, may provide certain arrangements of widgets or application icons, may identify the age of the user and thus restrict access to stored media content with an age rating, may be used to authorise the user on the Internet and/or control firewall settings. In MCDs 100 with television functionality, the access controls may restrict access to certain programs and/or channels within an electronic program guide (EPG). More details of how user data may be used to configure EPGs are provided later in the specification.

### Fourth Embodiment

### Control of a Remote Screen

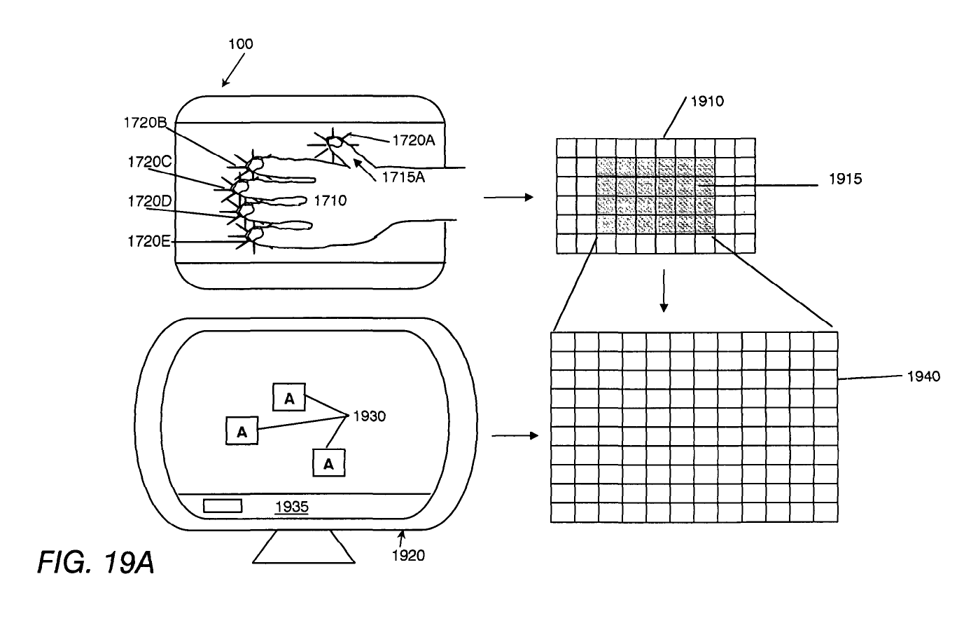

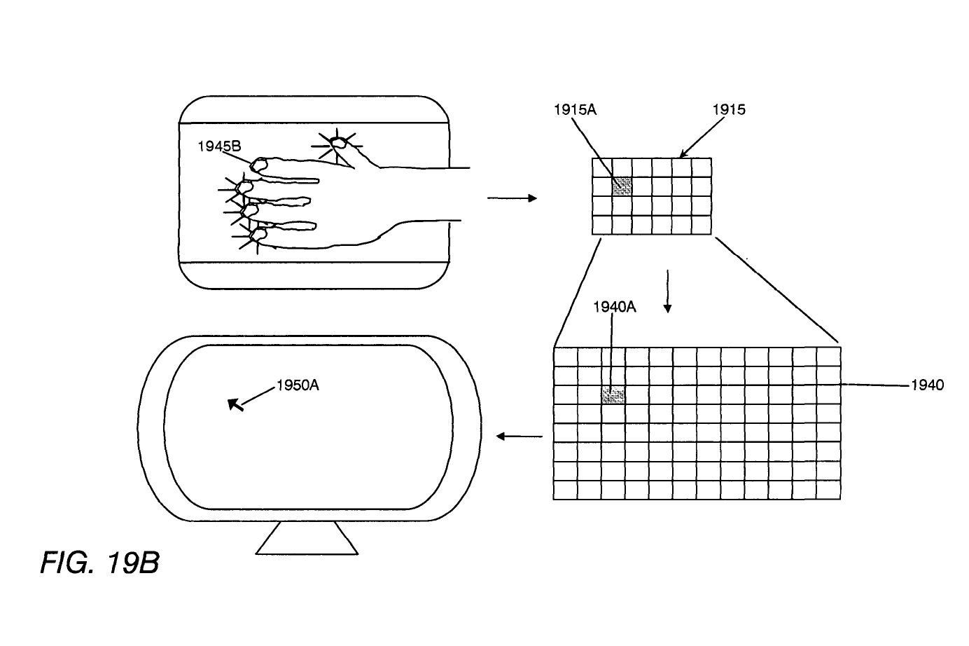

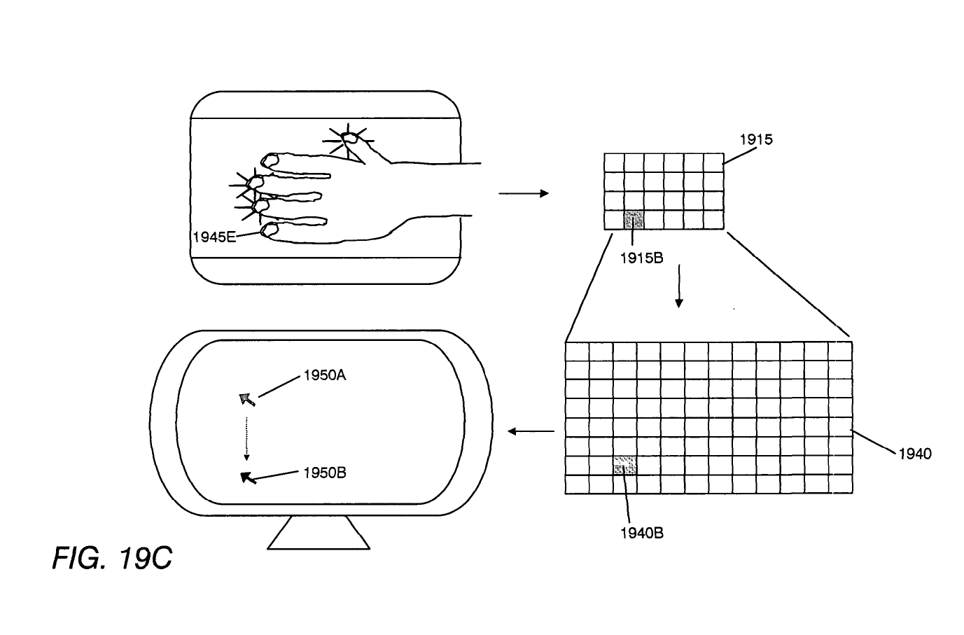

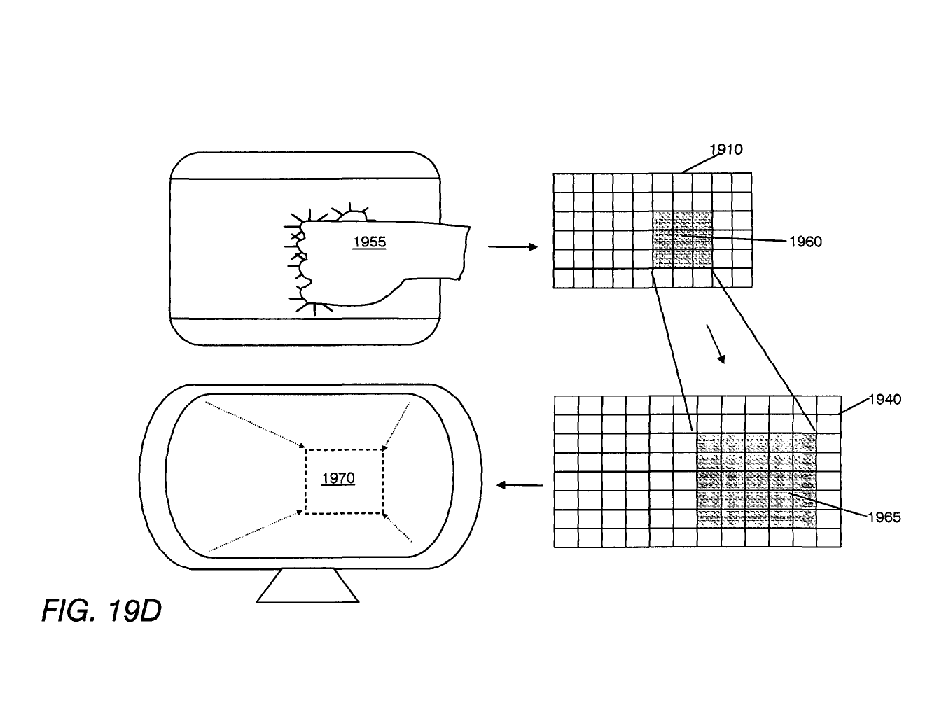

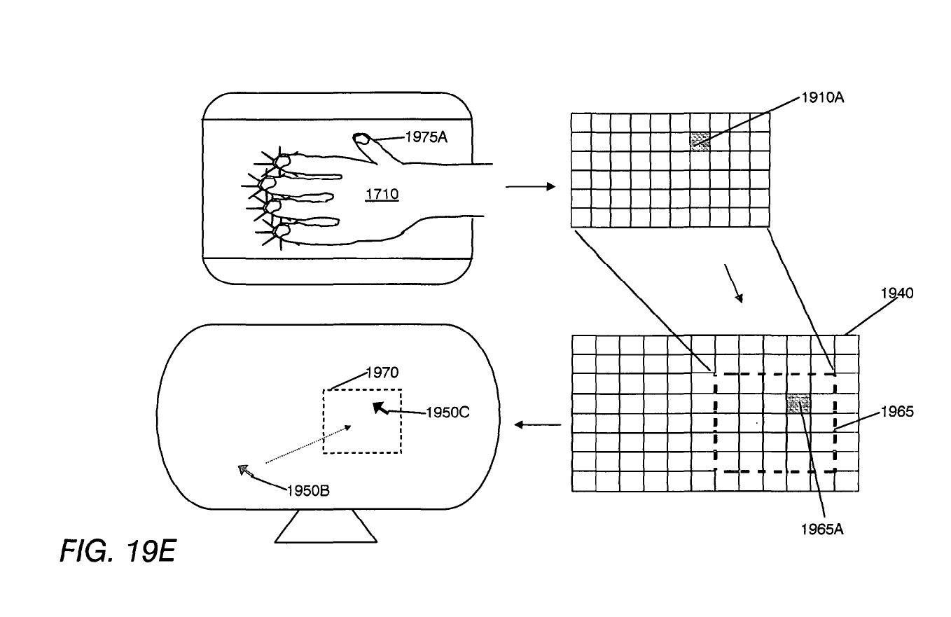

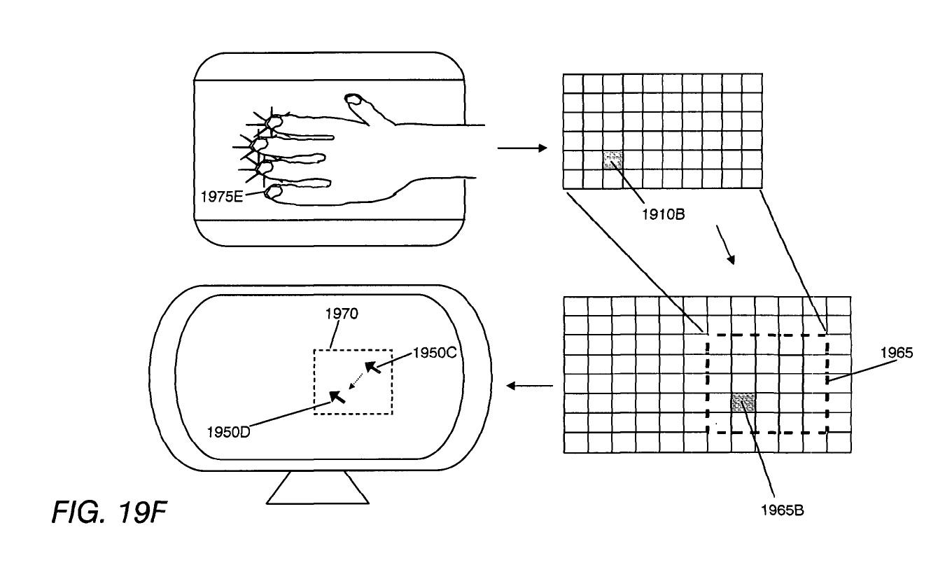

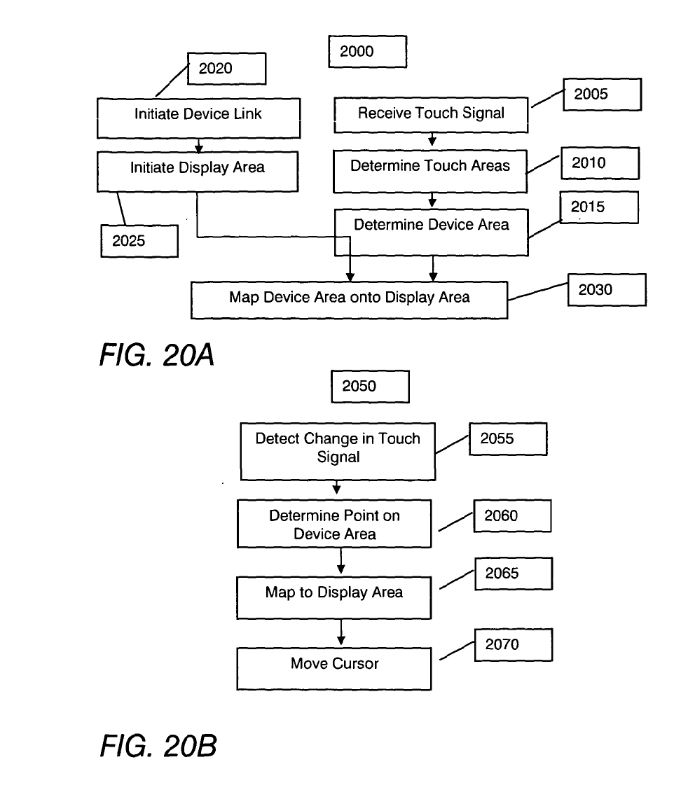

A method of controlling a remote screen according to a fourth embodiment of the present invention is illustrated in FIGS. 19A to 19F and shown in FIGS. 20A and 20B.

It is known to provide a laptop device with a touch-pad to manipulate a cursor on a UI displayed on the screen of the device. However, in these known devices problems arise due to the differences in size and resolution between the screen and the touch-pad; the number of addressable sensing elements in the track pad is much less than the number of addressable pixels in the screen. These differences create problems when the user has to navigate large distances upon the screen, e.g. move from one corner of the screen to another. These problems are accentuated with the use of large monitors and high-definition televisions, both of which offer a large screen area at a high pixel resolution.

The fourth embodiment of the present invention provides a simple and effective method of navigating a large screen area using the sensory capabilities of the MCD 100. The system and methods of the fourth embodiment allow the user to quickly manoeuvre a cursor around a UI displayed on a screen and overall provides a more intuitive user experience.

FIG. 19A shows the MCD 100 and a remote screen 1920. Remote screen 1920 may comprise any display device, for example a computer monitor, television, projected screen or the like. Remote screen 1920 may be connected to a separate device (not shown) that renders an image upon the screen. This device may comprise, for example, a PC 1020, a set-top box 1060, a games console 1050 or other media processor. Alternatively, rendering abilities may be built into the remote screen itself through the use of an in-built remote screen controller, for example, remote screen 1920 may comprise a television with integrated media functionality. In the description below reference to a “remote screen” may include any of the discussed examples and/or any remote screen controller. A remote screen controller may be implemented in any combination of hardware, firmware or software and may reside either with the screen hardware or by implemented by a separate device coupled to the screen.

The remote screen 1920 has a screen area 1925. The screen area 1925 may comprise icons 1930 and a dock or task bar 1935. For example, screen area 1925 may comprise a desktop area of an operating system or a home screen of a media application.

FIG. 20A shows the steps required to initialise the remote control method of the fourth embodiment. In order to control screen area 1925 of the remote screen 1920, the user of MCD 100 may load a particular widget or may select a particular operational mode of the MCD 100. The operational mode may be provided by application services 740 or OS services 720. When the user places their hand 1710 and fingers 1715 on the touch-screen 110, as shown by the activation areas 1720A to E, appropriate touch signals are generated by the touch-screen 110. These signals are received by a touch-screen controller or CPU 215 at step 2005. At step 2010, these touch signals may be processed to determine touch areas as described above. FIG. 19A provides a graphical representation of the touch area data generated by touch-screen 110. As discussed previously, such a representation is provided to aid explanation and need not accurately represent the precise form in which touch data is stored. The sensory range of the touch-screen in x and y directions is shown as grid 1910. When the user activates the touch-screen 110 at points 1720A to 1720E, a device area 1915 defined by these points is activated on the grid 1910. This is shown at step 2015. Device area 1915 encompasses the activated touch area generated when the user places his/her hand upon the MCD 100. Device area 1915 provides a reference area on the device for mapping to a corresponding area on the remote screen 1920. In some embodiments device area 1915 may comprise the complete sensory range of the touch-screen in x and y dimensions.

Before, after or concurrently with steps 2005 to 2015, steps 2020 and 2025 may be performed to initialise the remote screen 1920. At step 2010 the remote screen 1920 is linked with MCD 100. In an example where the remote screen 1920 forms the display of an attached computing device, the link may be implemented by loading a particular operating system service. The loading of the service may occur on start-up of the attached computing device or in response to a user loading a specific application on the attached computing device, for example by a user by selecting a particular application icon 1930. In an example where the remote screen 1920 forms a stand-alone media processor, any combination of hardware, firmware or software installed in the remote screen 1920 may implement the link. As part of step 2020 the MCD 100 and remote display 1920 may communicate over an appropriate communications channel. This channel may use any physical layer technology available, for example, may comprise an IR channel, a wireless communications channel or a wired connection. At step 2025 the display area of the remote screen is initialised. This display area is presented by grid 1940. In the present example, the display area is initially set as the whole display area. However, this may be modified if required.

Once both devices have been initialised and a communications link established, the device area 1915 is mapped to display area 1940 at step 2030. The mapping allows an activation of the touch-screen 110 to be converted into an appropriate activation of remote screen 1920. To perform the mapping a mapping function may be used. This may comprise a functional transform which converts co-ordinates in a first two-dimensional co-ordinate space, that of MCD 100, to co-ordinates in a second two-dimensional co-ordinate space, that of remote screen 1920. Typically, the mapping is between the co-ordinate space of grid 1915 to that of grid 1940. Once the mapping has been established, the user may manipulate their hand 1710 in order to manipulate a cursor within screen area 1925. This manipulation is shown in FIG. 19B.

The use of MCD 100 to control remote screen 1920 will now be described with the help of FIGS. 19B and 19C. This control is provided by the method 2050 of FIG. 20B. At step 2055, a change in the touch signal received by the MCD 100 is detected. As shown in FIG. 19B this may be due to the user manipulating one of fingers 1715, for example, raising a finger 1715B from touch-screen 110. This produces a change in activation at point 1945B, i.e. a change from the activation illustrated in FIG. 19A. At step 2060, the location of the change in activation in device area 1915 is detected. This is shown by activation point 1915A in FIG. 19B. At step 2065, a mapping function is used to map the location 1915A on device area 1915 to a point 1940A on display area 1940. For example, in the necessarily simplified example of FIG. 19D, device area 1915 is a 6×4 grid of pixels. Taking the origin as the upper left corner of area 1915, activation point 1915A can be said to be located at pixel co-ordinate (2,2). Display area 1940 is a 12×8 grid of pixels. Hence, the mapping function in the simplified example simply doubles the co-ordinates recorded within device area 1915 to arrive at the required co-ordinate in display area 1940. Hence activation point 1915A at (2, 2) is mapped to activation point 1940A at (4, 4). In advanced variations, complex mapping functions may be used to provide a more intuitive mapping for MCD 100 to remote screen 1920. At step 2070, the newly calculated co-ordinate 1940A is used to locate a cursor 1950A within display area. This is shown in FIG. 19B.

FIG. 19C shows how the cursor 1950A may be moved by repeating the method of FIG. 20B. In FIG. 19C, the user activates the touch-screen a second time at position 1945E; in this example the activation comprises the user raising their little finger from the touch-screen 110. As before, this change in activation at 1945E is detected at touch point or area 1915B in device area 1915. This is then mapped onto point 1940B in display area 1940. This then causes the cursor to move from point 1950A to 1950B.

The MCD 100 may be connected to the remote screen 1920 (or the computing device that controls the remote screen 1920) by any described wired or wireless connection. In a preferred embodiment, data is exchanged between MCD 100 and remote screen 1920 using a wireless network. The mapping function may be performed by the MCD 100, the remote screen 1920 or a remote screen controller. For example, if an operating system service is used, a remote controller may receive data corresponding to the device area 1915 and activated point 1915 from the MCD 100; alternatively, if mapping is performed at the MCD 100, the operating system service may be provided with the co-ordinates of location 1940B so as to locate the cursor at that location.

FIGS. 19D to 19F show a first variation of the fourth embodiment. This optional variation shows how the mapping function may vary to provide enhanced functionality. The variation may comprise a user-selectable mode of operation, which may be initiated on receipt of a particular gesture or option selection. Beginning with FIG. 19D, the user modifies their finger position upon the touch-screen. As shown in FIG. 19D, this may be achieved by drawing the fingers in under the palm in a form of grasping gesture 1955. This gesture reduces the activated touch-screen area, i.e. a smaller area now encompasses all activated touch points. In FIG. 19D, the device area 1960 now comprises a 3×3 grid of pixels.

When the user performs this gesture on the MCD 100, this is communicated to the remote screen 1920. This then causes the remote screen 1920 or remote screen controller to highlight a particular area of screen area 1925 to the user. In FIG. 19D this is indicated by rectangle 1970, however, any other suitable shape or indication may be used. The reduced display area 1970 is proportional to device area 1960; if the user moves his fingers out from under his/her palm rectangular 1970 will increase in area and/or modify in shape to reflect the change in touch-screen input. In the example of FIG. 19D, the gesture performed by hand 1955 reduces the size of the displayed area that is controlled by the MCD 100. For example, the controlled area of the remote screen 1920 shrinks from the whole display 1940 to selected area 1965. The user may use the feedback provided by the on-screen indication 1970 to determine the size of screen area they wish to control.

When the user is happy with the size of the screen area they wish to control, the user may perform a further gesture, for example, raising and lowering all five fingers in unison, to confirm the operation. This sets the indicated screen area 1970 as the display area 1965, i.e. as the area of the remote screen that is controlled by the user operating MCD. Confirmation of the operation also resets the device area of MCD 100; the user is free to perform steps 2005 to 2015 to select any of range 1910 as another device area. However the difference is that now this device area only controls a limited display area. The user then may manipulate MCD 100 in the manner of FIGS. 19A, 19B, 19C and 20B to control the location of a cursor within limited area 1970. This is shown in FIG. 19E.

In FIG. 19E the user performs gesture on the touch-screen to change the touch-screen activation, for example, raising thumb 1715A from the screen at point 1975A. This produces an activation point 1910A with the device area 1910. Now the mapping is between the device area 1910 and a limited section of the display area. In the example of FIG. 19E, the device area is a 10×6 grid of pixels, which controls an area 1965 of the screen comprising a 5×5 grid of pixels. The mapping function converts the activation point 1910A to an activation point within the limited display area 1965. In the example of FIG. 19E, point 1910A is mapped to point 1965A. This mapping may be performed as described above, the differences being the size of the respective areas. Activation point 1965A then enables the remote screen 1920 or remote screen controller to place the cursor at point 1950C within limited screen area 1970. The cursor thus has moved from point 1950B to point 1950C.

FIG. 19F shows how the cursor may then be moved within the limited screen area 1970. Performing the method of FIG. 20B, the user then changes the activation pattern on touch-screen 110. For example, the user may lift his little finger 1715E as shown in FIG. 19F to change the activation pattern at the location 1975E. This then causes a touch point or touch area to be detected at location 1910B within device area 1910. This is then mapped to point 1965B on this limited display area 1965. The cursor is then moved within limited screen area 1970, from location 1950C to location 1950D.

Using the first variation of the fourth embodiment, the whole or part of the touch-screen 110 may be used to control a limited area of the remote screen 1920 and thus offer more precise control Limited screen area 1970 may be expanded to encompass the whole screen area 1925 by activating a reset button displayed on MCD 100 or by reversing the gesture of FIG. 19C.

In a second variation of the fourth embodiment, multiple cursors at multiple locations may be displayed simultaneously. For example, two or more of cursors 1950A to D may be displayed simultaneously.

By using the method of the fourth embodiment, the user does not have to scroll using a mouse or touch pad from one corner of a remote screen to another corner of the remote screen. They can make use of the full range offered by the fingers of a human hand.

### Fifth Embodiment

### Media Manipulation Using MCD

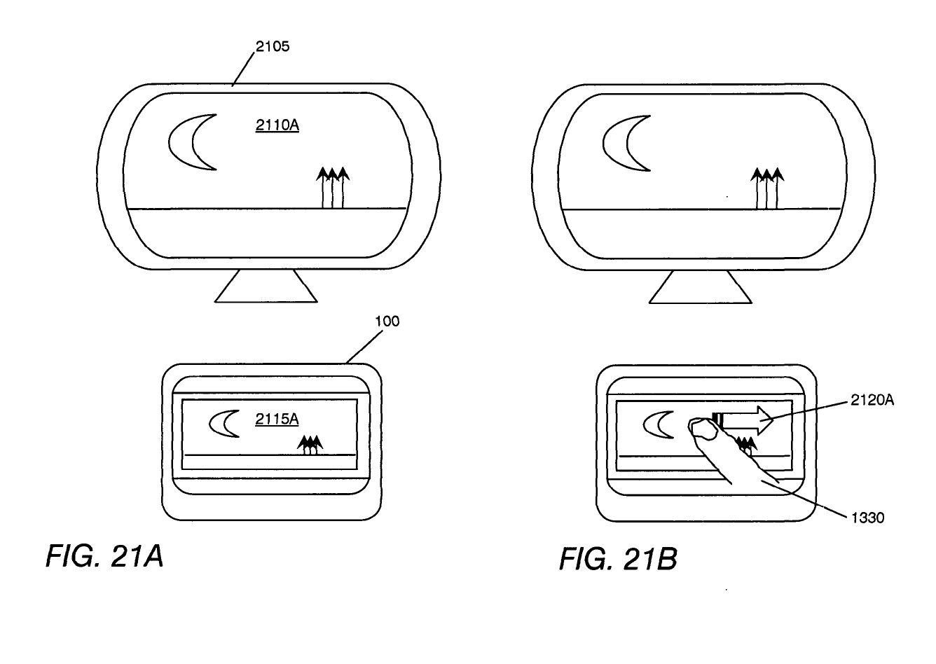

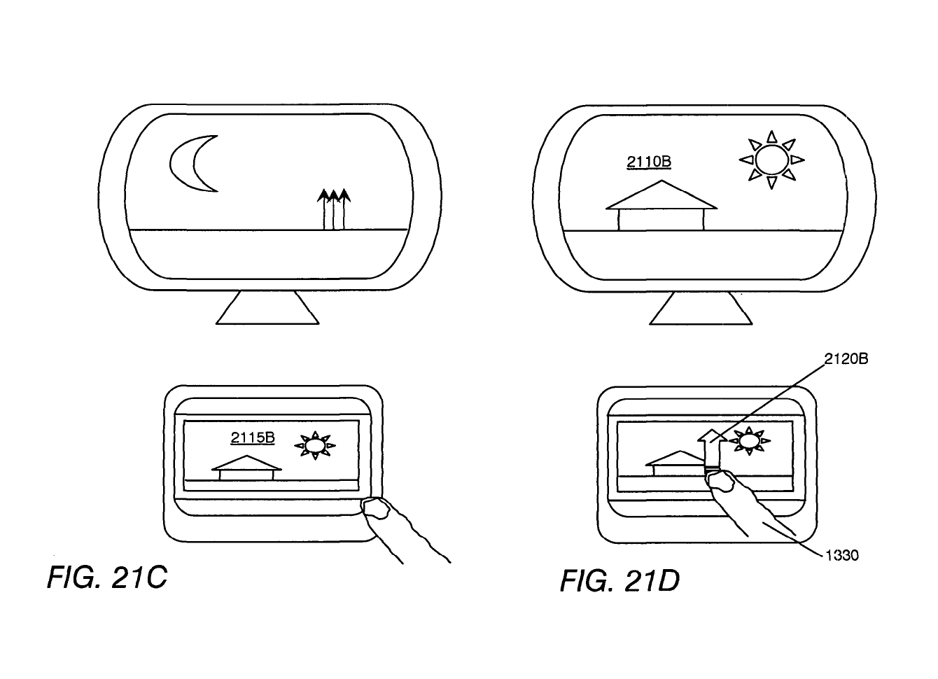

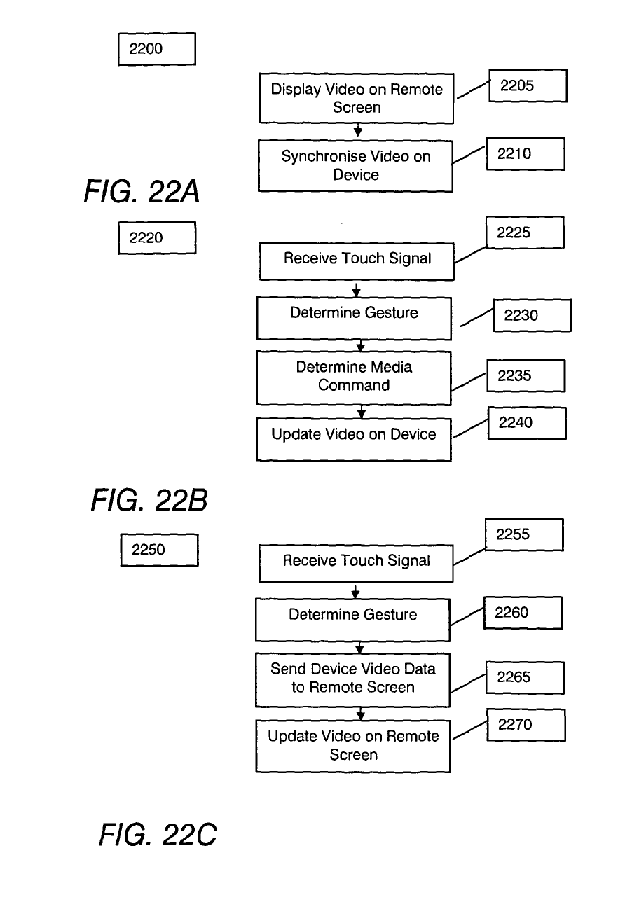

FIGS. 21A to 21D, and the accompanying methods of FIGS. 22A to 22C, show how the MCD 100 may be used to control a remote screen. As with the previous embodiment, reference to a “remote screen” may include any display device and/or any display device controller, whether it be hardware, firmware or software based in either the screen itself or a separate device coupled to the screen. A “remote screen” may also comprise an integrated or coupled media processor for rendering media content upon the screen. Rendering content may comprise displaying visual images and/or accompanying sound. The content may be purely auditory, e.g. audio files, as well as video data as described below.

In the fifth embodiment, the MCD 100 is used as a control device to control play media playback. FIG. 21A shows the playback of a video on a remote screen 2105. This is shown as step 2205 in the method 2200 of FIG. 22A. At a first point in time, a portion of the video 2110A is displayed on the remote screen 2105. At step 2210 in FIG. 22A the portion of video 2110A shown on remote screen 2105 is synchronised with a portion 2115A of video shown on MCD 100. This synchronisation may occur based on communication between remote screen 2105 and MCD 100, e.g. over a wireless LAN or IR channel, when the user selects a video, or a particular portion of a video, to watch using a control device of remote screen 2105. Alternatively, the user of the MCD 100 may initiate a specific application on the MCD 100, for example a media player, in order to select a video and/or video portion. The portion of video displayed on MCD 100 may then be synchronised with the remote screen 2105 based on communication between the two devices. In any case, after performing method 2200 the video portion 2110A displayed on the remote screen 2105 mirrors that shown on the MCD 100. Exact size, formatting and resolution may depend on the properties of both devices.

FIG. 21B and the method of FIG. 22B show how the MCD 100 may be used to manipulate the portion of video 2115A shown on the MCD 100. Turning to method 2220 of FIG. 22B, at step 2225A, a touch signal is received from the touch-screen 110 of the MCD 100. This touch signal may be generated by finger 1330 performing a gesture upon the touch-screen 110. At step 2230 the gesture is determined. This may involve matching the touch signal or processed touch areas with a library of known gestures or gesture series. In the present example, the gesture is a sideways swipe of the finger 1230 from left to right as shown by arrow 2120A. At step 2235 a media command is determined based on the identified gesture. This may be achieved as set out above in relation to the previous embodiments. The determination of a media command based on a gesture or series of gestures may be made by OS services 720, UI framework 730 or application services 740. For example, a simple case, each gesture may have a unique identifier and be associated in a look-up table with one or more associated media commands. For example, a sideways swipe of a finger from left to right may be associated with a fast-forward media command and the reverse gesture from right to left may be associated with a rewind command; a single tap may pause the media playback and multiple taps may cycle through a number of frames in proportion to the number of times the screen is tapped.

Returning to FIG. 21B, the gesture 2120A is determined to be a fast-forward gesture. At step 2240, the portion of video 2115A on the device is updated in accordance with the command, i.e. is manipulated. In present embodiment, “manipulation” refers to any alteration of the video displayed on the device. In the case of video data it may involve, moving forward or back a particular number of frames; pausing playback; and/or removing, adding or otherwise altering a number of frames. Moving from FIG. 21B to FIG. 21C, the portion of video is accelerated through a number of frames. Hence now, as shown in FIG. 21C a manipulated portion of video 2115B is displayed on MCD 100. As can be seen from FIG. 21C, the manipulated portion of video 2115B differs from the portion of video to 2110A displayed on remote screen 2105, in this specific case the portion of video 2110A displayed on remote screen 2105 represents a frame or set of frames that precede the frame or set of frames representing the manipulated portion of video 2115B. As well as gesture 2120A the user may perform a number of additional gestures to manipulate the video on the MCD 100, for example, may fast-forward and rewind the video displayed on the MCD 100, until they reach a desired location.

Once a desired location is reached, method 2250 of FIG. 22C may be performed to display the manipulated video portion 2115B on remote screen 2105. At step 2255 a touch signal is received. At step 2260 a gesture is determined. In this case, as shown in FIG. 21D, the gesture comprises the movement of a finger 1330 in an upwards direction 2120B on touch-screen 110, i.e. a swipe of a finger from the base of the screen to the upper section of the screen. Again, this gesture may be linked to a particular command. In this case, the command is to send data comprising the current position (i.e. the manipulated form) of video portion 2115B on the MCD 100 to remote screen 2105 at step 2265. As before this may be sent over any wireless method, including but not limited to a wireless LAN, a UMTS data channel or an IR channel. In the present example, said data may comprise a time stamp or bookmark indicating the present frame or time location of the portion of video 2115B displayed on MCD 100. In other implementations, where more extensive manipulation has been performed, a complete manipulated video file may be sent to remote screen. At step 2270 the remote screen 2105 is updated to show the portion of video data 2110B shown on the device, for example a remote screen controller may receive data from the MCD 100 and perform and/or instruct appropriate media processing operations to provide the same manipulations at the remote screen 2105. FIG. 21D thus shows that both the MCD 100 and remote screen 2105 display the same (manipulated) portion of video data 2115B and 2110B.

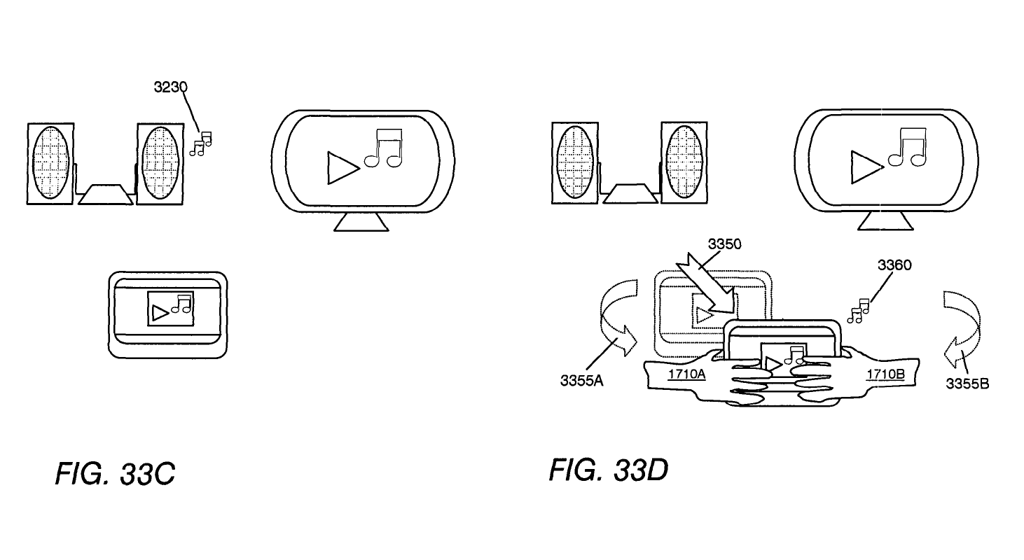

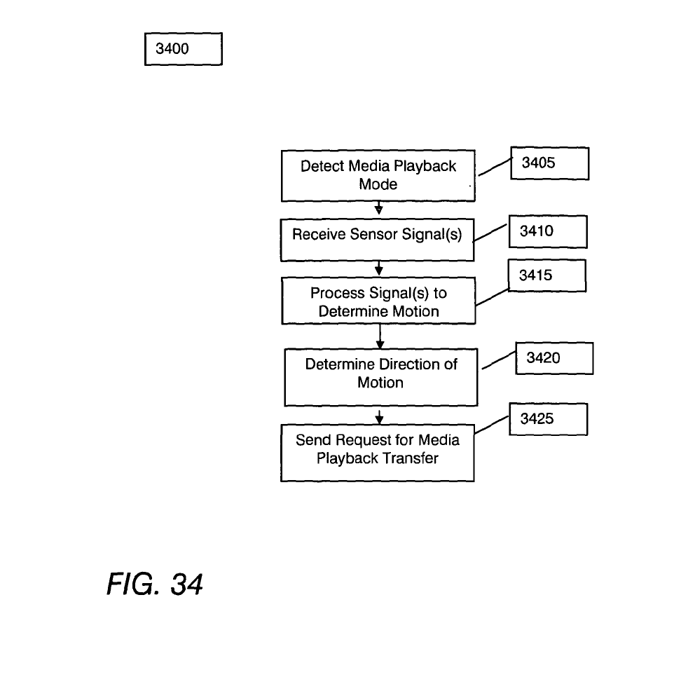

Certain optional variations of the fifth embodiment may be further provided. In a first variation, multiple portions of video data may be displayed at the same time on MCD 100 and/or remote screen 2105. For example, the MCD 100 may, on request from the user, provide a split-screen design that shows the portion of video data 2115A that is synchronised with the remote screen 2105 together with the manipulated video portion 2115B. In a similar manner, the portion of manipulated video data 2110B may be displayed as a picture-in-picture (PIP) display, i.e. in a small area of remote screen 2105 in addition to the full screen area, such that screen 2105 shows the original video portion 2110A on the main screen and the manipulated video portion 2110B in the small picture-in-picture screen. The PIP display may also be used instead of a split screen display on the MCD 100. The manipulation operation as displayed on the MCD 100 (and any optional PIP display on remote screen 2105) may be dynamic, i.e. may display the changes performed on video portion 2115A, or may be static, e.g. the user may jump from a first frame of the video to a second frame. The manipulated video portion 2115B may also be sent to other remote media processing devices using the methods described later in this specification. Furthermore, in one optional variation, the gesture shown in FIG. 21D may be replaced by the video transfer method shown in FIG. 33B and FIG. 34. Likewise, the synchronisation of video shown in FIG. 21A may be achieved using the action shown in FIG. 33D.

In a second variation, the method of the fifth embodiment may also be used to allow editing of media on the MCD 100. For example, the video portion 2110A may form part of a rated movie (e.g. U, PG, PG-13, 15, 18 etc). An adult user may wish to cut certain elements from the movie to make it suitable for a child or an acquaintance with a nervous disposition. In this variation, a number of dynamic or static portions of the video being shown on the remote display 2105 may be displayed on the MCD 100. For example, a number of frames at salient points within the video stream may be displayed in a grid format on the MCD 100; e.g. each element of the grid may show the video at 10 minutes intervals or at chapter locations. In one implementation, the frames making up each element of the grid may progress in real-time thus effectively displaying a plurality of “mini-movies” for different sections of the video, e.g. for different chapters or time periods.

Once portions of the video at different time locations are displayed on the MCD 100, the user may then perform gestures on the MCD 100 to indicate a cut. This may involve selecting a particular frame or time location as a cut start time and another particular frame or time location as a cut end time. If a grid is not used, then the variation may involve progressing through the video in a particular PIP display on the MCD 100 until a particular frame is reached, wherein the selected frame is used as the cut start frame. A similar process may be performed using a second PIP on the MCD 100 to designate a further frame, which is advanced in time from the cut start frame, as the cut end time. A further gesture may then be used to indicate the cutting of content from between the two selected cut times. For example, if two PIPs are displayed the user may perform a zigzag gesture from one PIP to another PIP; if a grid is used, the user may select a cut start frame by tapping on a first displayed frame and select a cut end frame by tapping on a second displayed frame and then perform a cross gesture upon the touch-screen 110 to cut the intermediate material between the two frames. Any gesture can be assigned to cut content.

Cut content may either be in the form of an edited version of a media file (a “hard cut”) or in the form of metadata that instructs an application to remove particular content (a “soft cut”). The “hard cut” media file may be stored on the MCD 100 and/or sent wirelessly to a storage location (e.g. NAS 1025) and/or the remote screen 2105. The “soft cut” metadata may be sent to remote screen 2105 as instructions and/or sent to a remote media processor that is streaming video data to instruct manipulation of a stored media file. For example, the media player that plays the media file may receive the cut data and automatically manipulate the video data as its playing to perform the cut.

A further example of a “soft cut” will now be provided. In this example, a remote media server may store an original video file. The user may be authorised to stream this video file to both the remote device 2105 and the MCD 100. On performing an edit, for example that described above, the cut start time and cut end time are sent to the remote media server. The remote media server may then: create a copy of the file with the required edits, store the times against a user account (e.g. a user account as described herein), and/or use the times to manipulate a stream.

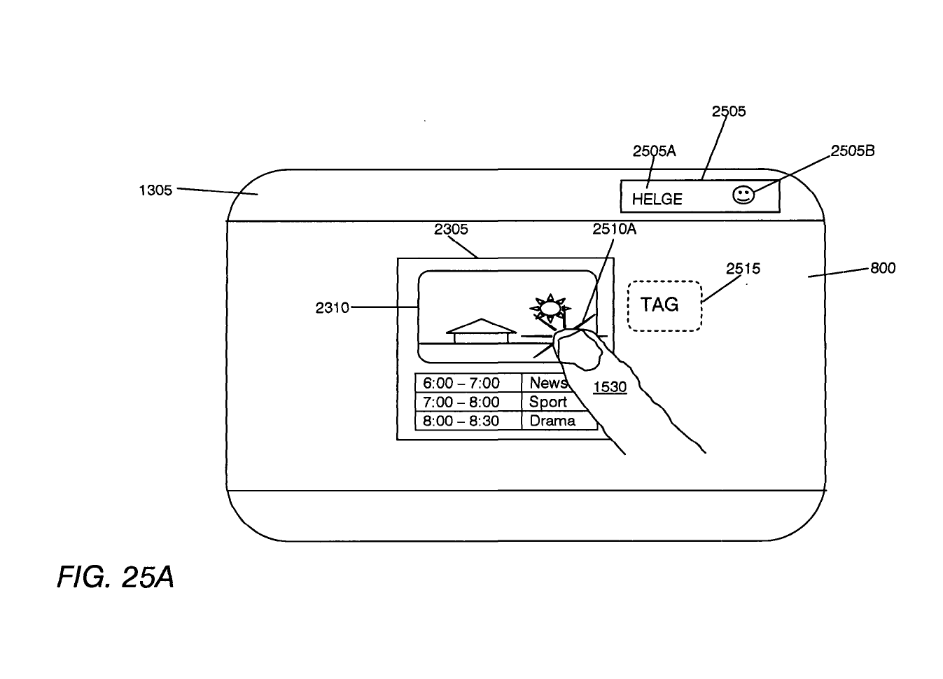

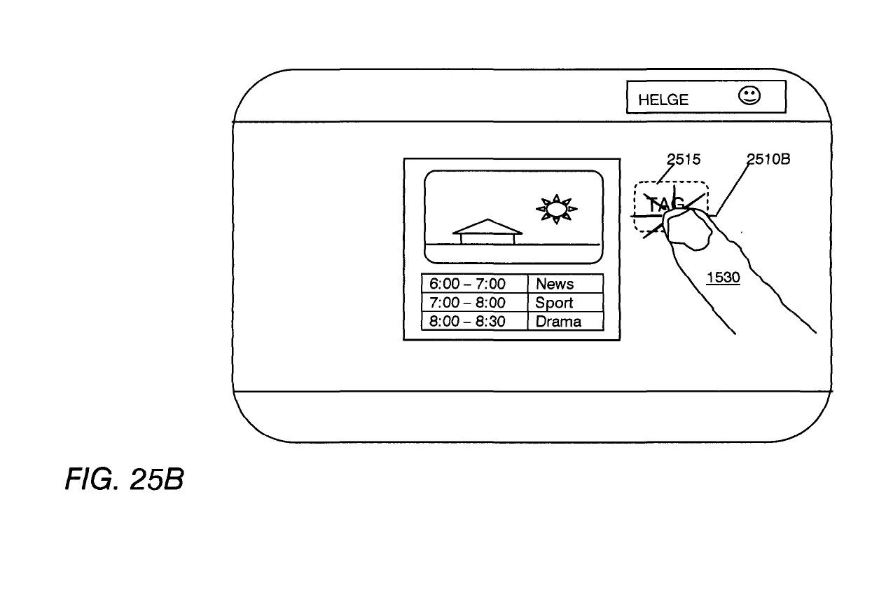

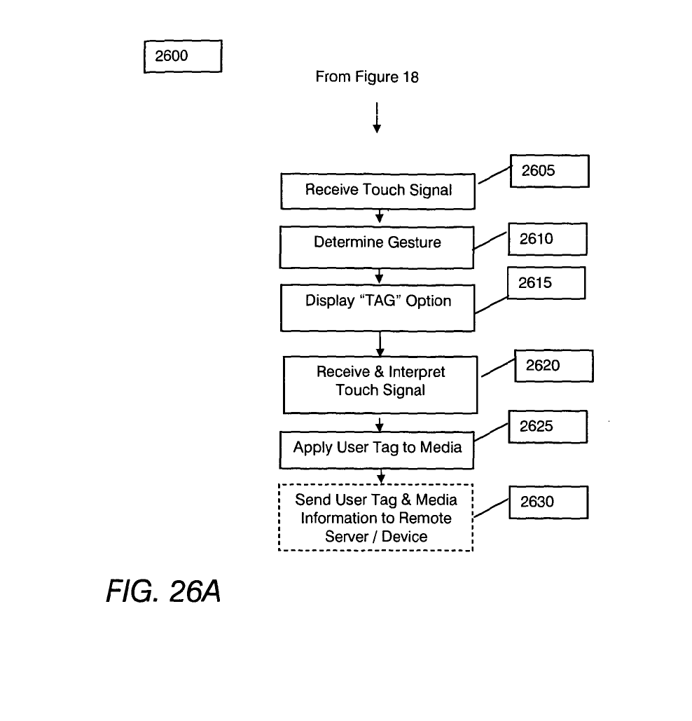

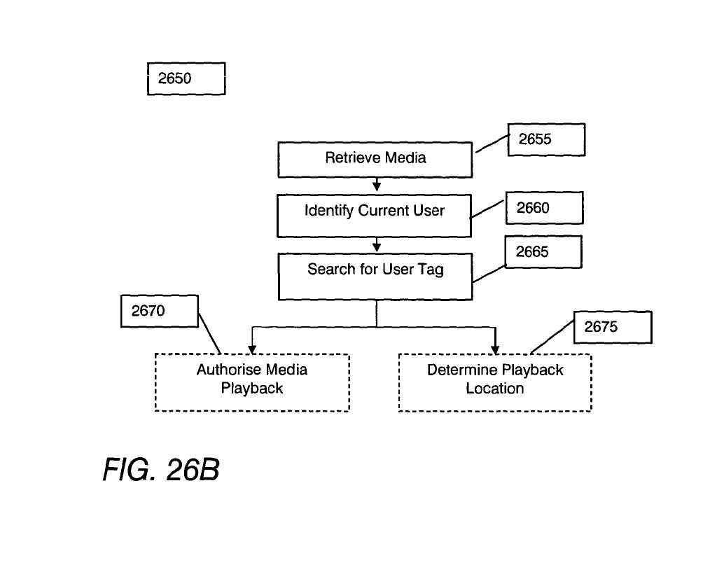

The manipulated video data as described with relation to the present embodiment may further be tagged by a user as described in relation to FIGS. 25A to D and FIG. 26A. This will allow a user to exit media playback with relation to the MCD 100 at the point (2115B) illustrated in FIG. 21C; at a later point in time they may return to view the video and at this point the video portion 2215B is synched with the remote screen 2105 to show to video portion 2110B on the remote screen.

### Sixth Embodiment

### Dynamic EPG

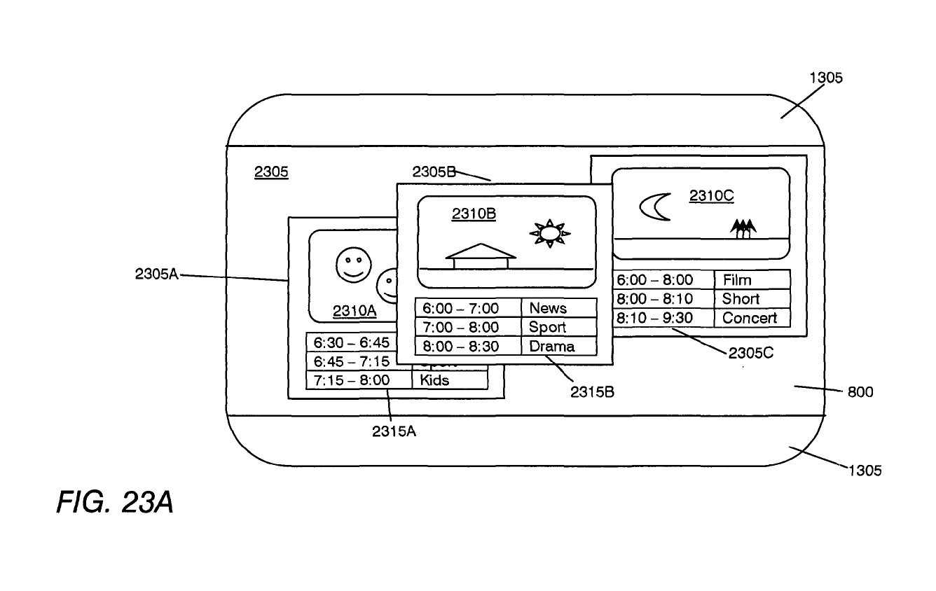

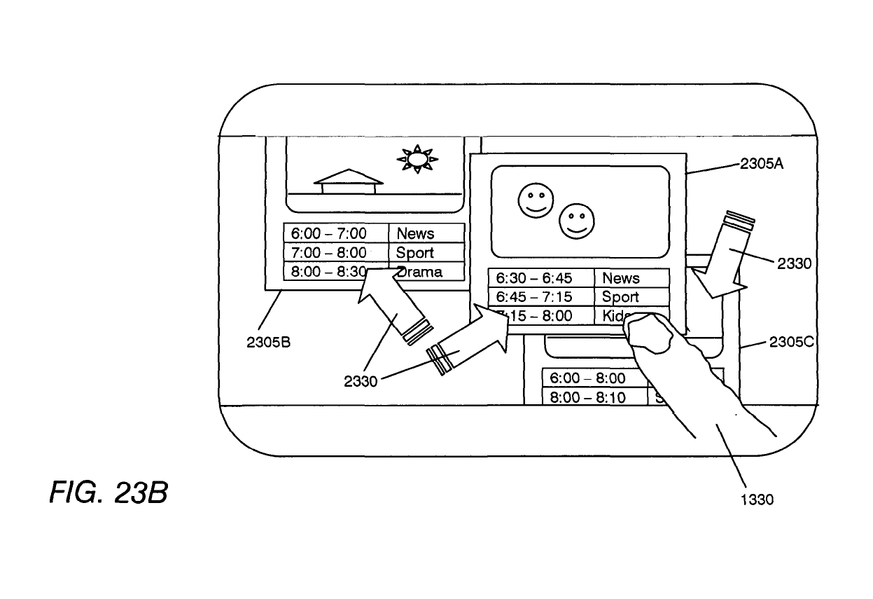

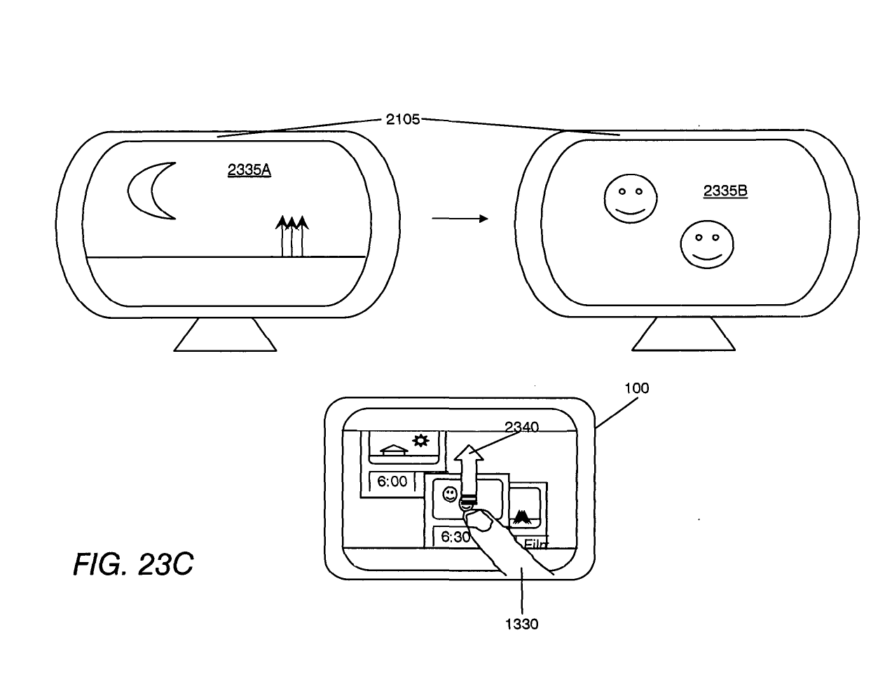

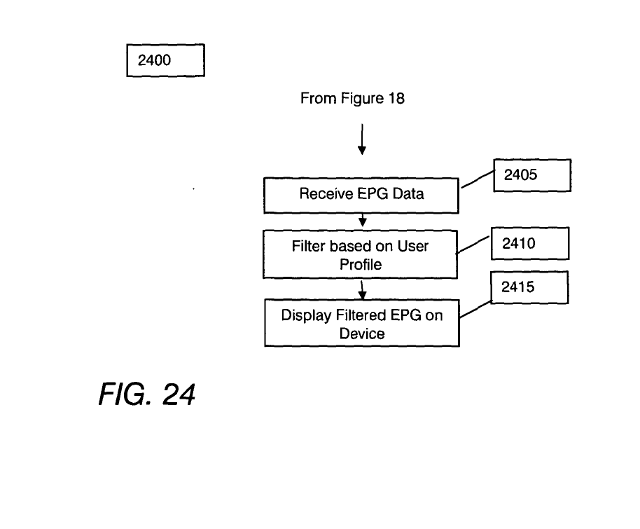

A sixth embodiment of the present invention is shown in FIGS. 23A, 23B, 23C and FIG. 24. The sixth embodiment is directed to the display of video data, including electronic programme guide (EPG) data.

Most modern televisions and set-top boxes allow the display of EPG data. EPG data is typically transmitted along with video data for a television (“TV”) channel, for example, broadcast over radio frequencies using DVB standards; via co-axial or fibre-optical cable; via satellite; or through TCP/IP networks. In the past “TV channel” referred to a particular stream of video data broadcast over a particular range of high frequency radio channels, each “channel” having a defined source (whether commercial or public). Herein, “TV channel” includes past analogue and digital “channels” and also includes any well-defined collection or source of video stream data, for example, may include a source of related video data for download using network protocols. A “live” broadcast may comprise the transmission or a live event or a pre-recorded programme.

EPG data for a TV channel typically comprises temporal programme data, e.g. “listings” information concerning TV programmes that change over time with a transmission or broadcast schedule. A typical EPG shows the times and titles of programmes for a particular TV channel (e.g. “Channel 5”) in a particular time period (e.g. the next 2 or 12 hours). EPG data is commonly arranged in a grid or table format. For example, a TV channel may be represented by a row in a table and the columns of the table may represent different blocks of time; or the TV channel may be represented by a column of a table and the rows may delineate particular time periods. It is also common to display limited EPG data relating to a particular TV programme on receipt of a remote control command when the programme is being viewed; for example, the title, time period of transmission and a brief description. One problem with known EPG data is that it is often difficult for a user to interpret. For example, in modern multi-channel TV environments, it may be difficult for a user to read and understand complex EPG data relating to a multitude of TV channels. EPG data has traditionally developed from paper-based TV listings; these were designed when the number of terrestrial TV channels was limited.

The sixth embodiment of the present invention provides a dynamic EPG. As well as text and/or graphical data indicating the programming for a particular TV channel, a dynamic video stream of the television channel is also provided. In a preferred embodiment, the dynamic EPG is provided as channel-specific widgets on the MCD 100.

FIG. 23A shows a number of dynamic EPG widgets. For ease of explanation, FIG. 23A shows widgets 2305 for three TV channels; however, many more widgets for many more TV channels are possible. Furthermore, the exact form of the widget may vary with implementation. Each widget 2305 comprises a dynamic video portion 2310, which displays a live video stream of the TV channel associated with the widget. This live video stream may be the current media content of a live broadcast, a scheduled TV programme or a preview of a later selected programme in the channel. As well as the dynamic video stream 2310, each widget 2305 comprises EPG data 2315. The combination of video stream data and EPG data forms the dynamic EPG. In the present example the EPG data 2315 for each widget lists the times and titles of particular programmes on the channel associated with the widget. The EPG data may also comprise additional information such as the category, age rating, or social to media rating of a programme. The widgets 2305 may be, for example, displayed in any manner described in relation to FIGS. 9A to 9H or may be ordered in a structured manner as described in the first embodiment.

The widgets may be manipulated using with the organisation and pairing methods of the first and second embodiments. For example, taking the pairing examples of the second embodiment, if a calendar widget is also concurrently shown, the user may drag a particular day from the calendar onto a channel widget 2305 to display EPG data and a dynamic video feed for that particular day. In this case, the video feed may comprise preview data for upcoming programmes rather that live broadcast data. Alternatively, the user may drag and drop an application icon comprising a link to financial information, e.g. “stocks and shares” data, onto a particular widget or group (e.g. stack) of widgets, which may filter the channel(s) of the widget or group of widgets such that only EPG data and dynamic video streams relating to finance are displayed. Similar examples also include dragging and dropping icons and/or widgets relating to a particular sport to show only dynamic EPG data relating to programmes featuring the particular sport and dragging and dropping an image or image icon of an actor or actress onto a dynamic EPG widget to return all programmes featuring the actor or actress. A variation of the latter example involves the user viewing a widget in the form of an Internet browser displaying a media related website. The media related website, such as the Internet Movie Database (IMDB), may show the biography of a particular actor or actress. When the Internet browser widget is dragged onto a dynamic EPG widget 2305, the pairing algorithm may extract the actor or actress data currently being viewed (for example, from the URL or metadata associated with the HTML page) and provide this as search input to the EPG software. The EPG software may then filter the channel data to only display programmes relating to the particular actor or actress.

The dynamic EPG widgets may be displayed using a fortune wheel or rolodex arrangement as shown in FIGS. 9E and 9F. In certain variations, a single widget may display dynamic EPG data for multiple channels, for example in a grid or table format.

FIG. 23B shows how widgets may be re-arranged by performing swiping gestures 2330 on the screen. These gestures may be detected and determined based on touch-screen input as described previously. The dynamic video data may continue to play even when the widget is being moved; in other variations, the dynamic video data may pause when the widget is moved. As is apparent on viewing FIG. 23B, in a large multi-channel environment, the methods of the first embodiment become particularly useful to organise dynamic EPG widgets after user re-arrangement.

In a first variation of the sixth embodiment, the dynamic EPG data may be synchronised with one or more remote devices, such as remote screen 2105. For example, the UI shown on the MCD 100 may be synchronised with the whole or part of the display on a remote screen 2105, hence the display and manipulation of dynamic EPG widgets on the MCD 100 will be mirrored on the whole or part of the remote display 2105.

In FIG. 23C, remote screen 2105 displays a first video stream 2335A, which may be a live broadcast. This first video stream is part of a first TV channel's programming A first dynamic EPG widget 2305C relating to the first TV channel is displayed on the MCD 100, wherein the live video stream 2310C of the first widget 2305C mirrors video stream 2335A. In the present example, through re-arranging EPG widgets as shown in FIG. 23B, the user brings a second dynamic EPC widget 2305A relating to a second TV channel to the foreground. The user views the EPG and live video data and decides that they wish to view the second channel on the remote screen 2105. To achieve this, the user may perform a gesture 2340 upon the second widget 2305A. This gesture may be detected and interpreted by the MCD 100 and related to a media playback command; for example, as described and shown in previous embodiments such as method 2250 and FIG. 21D. In the case of FIG. 23C an upward swipe beginning on the second video stream 2310A for the second dynamic EPG widget, e.g. upward in the sense of from the base of the screen to the top of the screen, sends a command to the remote screen 2105 or an attached media processor to display the second video stream 2310A for the second channel 2335b upon the screen 2105. This is shown in the screen on the right of FIG. 23C, wherein a second video stream 2335B is displayed on remote screen 2105. In other variations, actions such as those shown in FIG. 33B may be used in place of the touch-screen gesture.

In a preferred embodiment the video streams for each channel are received from a set-top box, such as one of set-up boxes 1060. Remote screen 2105 may comprise one of televisions 1050. Set-top boxes 1060 may be connected to a wireless network for IP television or video data may be received via satellite 1065A or cable 1065B. The set-top box 1060 may receive and process the video streams. The processed video streams may then be sent over a wireless network, such as wireless networks 1040A and 1040B, to the MCD 100. If the wireless networks have a limited bandwidth, the video data may be compressed and/or down-sampled before sending to the MCD 100.

### Seventh Embodiment

### User-Defined EPG Data

A seventh embodiment of the present invention is shown in FIGS. 24, 25A, 25B, 26A and 26B. This embodiment involves the use of user metadata to configure widgets on the MCD 100.

A first variation of the seventh embodiment is shown in the method 2400 of FIG. 24, which may follow on from the method 1800 of FIG. 18. Alternatively, the method 2400 of FIG. 24 may be performed after an alternative user authentication or login procedure. At step 2405, EPG data is received on the MCD 100; for example, as shown in FIG. 23A. At step 2410, the EPG data is filtered based on a user profile; for example, the user profile loaded at step 1845 in FIG. 18. The user profile may be a universal user profile for all applications provided, for example, by OS kernel 710, OS services 720 or application services 740, or may be application-specific, e.g. stored by, for use with, a specific application such as a TV application. The user profile may be defined based on explicit information provided by the user at a set-up stage and/or may be generated over time based on MCD and application usage statistics. For example, when setting up the MCD 100 a user may indicate that he or she is interested in a particular genre of programming, e.g. sports or factual documentaries or a particular actor or actress. During set-up of one or more applications on the MCD 100 the user may link their user profile to user profile data stored on the Internet; for example, a user may link a user profile based on the MCD 100 with data stored on a remote server as part of a social media account, such as one set up with Facebook, Twitter, Flixster etc. In a case where a user has authorised the operating software of the MCD 100 to access a social media account, data indicating films and television programmes the user likes or is a fan of, or has mentioned in a positive context, may be extracted from this social media application and used as metadata with which to filter raw EPG data. The remote server may also provide APIs that allow user data to be extracted from authorised applications. In other variations, all or part of the user profile may be stored remotely and access on demand by the MCD 100 over wireless networks.

The filtering at step 2140 may be performed using deterministic and/or probabilistic matching. For example, if the user specifies that they enjoy a particular genre of film or a particular television category, only those genres or television categories may be displayed to the user in EPG data. When using probabilistic methods, a recommendation engine may be provided based on user data to filter EPG data to show other programmes that the current user and/or other users have also enjoyed or programmes that share certain characteristics such as a particular actor or screen-writer.

At step 2415, filtered EPG data is shown on the MCD. The filtered EPG data may be displayed using dynamic EPG widgets 2305 as shown in FIG. 23A, wherein live video streams 2310 and EPG data 2315, and possibly the widgets 2305 themselves, are filtered accordingly. The widgets that display the filtered EPG data may be channel-based or may be organised according to particular criteria, such as those used to filter the EPG data. For example, a “sport” dynamic EPG widget may be provided that shows all programmes relating to sport or a “Werner Herzog” dynamic EPG widget that shows all programmes associated with the German director. Alternatively, the filtering may be performed at the level of the widgets themselves; for example, all EPG widgets associated with channels relating to “sports” may be displayed in a group such as the stacks of the “rolodex” embodiment of FIG. 9F.

The EPG data may be filtered locally on the MCD 100 or may be filtered on a remote device. The remote device may comprise a set-top box, wherein the filtering is based on the information sent to the set-top box by the MCD 100 over a wireless channel. The remote device may alternatively comprise a remote server accessible to the MCD 100.

The filtering at step 2410 may involve restricting access to a particular channels and programmes. For example, if a parent has set parental access controls for a child user, when that child user logs onto the MCD 100, EPG data may be filtered to only show programmes and channels, or program and channel widgets, suitable for that user. This suitability may be based on information provided by the channel provider or by third parties.

The restrictive filtering described above may also be adapted to set priority of television viewing for a plurality of users on a plurality of devices. For example, three users may be present in a room with a remote screen; all three users may have an MCD 100 which they have logged into. Each user may have a priority associated with their user profile; for example, adult users may have priority over child users and a female adult may have priority over her partner. When all three users are present in the room and logged into their respective MCDs, only the user with the highest priority may be able to modify the video stream displayed on the remote screen, e.g. have the ability to perform the action of FIG. 21D. The priority may be set directly or indirectly on the fourth embodiment; for example, a user with the largest hand may have priority. Any user with secondary priority may have to watch content on their MCD rather than the remote screen. Priority may also be assigned, for example in the form of a data token than may be passed between MCD users.

A second variation of the seventh embodiment is shown in FIGS. 25A, 25B, 26A and 26C. These Figures show how media content, such as video data received with EPG data, may be “tagged” with user data. “Tagging” as described herein relates to assigning particular metadata to a particular data object. This may be achieved by recording a link between the metadata and the data object in a database, e.g. in a relational database sense or by storing the metadata with data object. A “tag” as described herein is a piece of metadata and may take the form of a text and/or graphical label or may represent the database or data item that records the link between the metadata and data object.

Typically, TV viewing is a passive experience, wherein televisions are adapted to display EPG data that has been received either via terrestrial radio channels, via cable or via satellite. The present variation provides a method of linking user data to media content in order to customise future content supplied to a user. In a particular implementation the user data may be used to provide personalised advertisements and content recommendations.

FIG. 25A shows a currently-viewed TV channel widget that is being watched by a user. This widget may be, but is not limited to, a dynamic EPG widget 2305. The user is logged into the MCD 100, e.g. either logged into an OS or a specific application or group of applications. Log-in may be achieved using the methods of FIG. 18. As shown in FIG. 25A, the current logged-in user may be indicated on the MCD 100. In the example of FIG. 25A, the current user is displayed by the OS 710 in reserved system area 1305. In particular, a UI component 2505 is provided that shows the user's (registered) name 2505A and an optional icon or a picture 2505B relating to the user, for example a selected thumbnail image of the user may be shown.

While viewing media content, in this example a particular video stream 2310 embedded in a dynamic EPG widget 2305 that may be live or recorded content streamed from a set-top box or via an IP channel, a user may perform a gesture on the media content to associate a user tag with the content. This is shown in method 2600 of FIG. 26A. FIG. 26A may optionally follow FIG. 18 in time.

Turning to FIG. 26A, at step 2605 a touch signal is received. This touch signal may be received as described previously following a gesture 2510A made by the user's finger 1330 on the touch-screen area displaying the media content. At step 2610 the gesture is identified as described previously, for example by CPU 215 or a dedicated hardware, firmware or software touch-screen controller, and may be context specific. As further described previously, as part of step 2610, the gesture 2510A is identified as being linked or associated with a particular command, in this case a “tagging” command. Thus when the particular gesture 2510A, which may be a single tap within the area of video stream 2310, is performed, a “tag” option 2515 is displayed at step 2615. This tag option 2515 may be displayed as a UI component (textual and/or graphical) that is displayed within the UI.

Turning to FIG. 25B, once a tag option 2515 is displayed, the user is able to perform another gesture 2510B to apply a user tag to the media content. In step 2620 the touch-screen input is again received and interpreted; it may comprise a single or double tap. At step 2625, the user tag is applied to the media content. The “tagging” operation may be performed by the application providing the displayed widget or by one of OS services 720, UI framework 730 or application services 740. The latter set of services is preferred.

A preferred method of applying a user tag to media content will now be described. When a user logs in to the MCD 100, for example with respect to the MCD OS, a user identifier for the logged in user is retrieved. In the example of FIG. 25B, the user is “Helge”; the corresponding user identifier may be a unique alphanumeric string or may comprise an existing identifier, such as an IMEI number of an installed SIM card. When a tag is applied the user identifier is linked to the media content. This may be performed as discussed above; for example, a user tag may comprise a database, file or look-up table record that stores the user identifier together with a media identifier that uniquely identifies the media content and optional data, for example that relating to the present state of the viewed media content. In the example of FIG. 25B, as well as a media identifier, information relating to the current portion of the video data being viewed may also be stored.

At step 2630 in method 2600 there is the optional step of sending the user tag and additional user information to a remote device or server. The remote device may comprise, for example, set top box 1060 and the remote server may comprise, for example, a media server in the form of an advertisement server or a content recommendation server. If the user tag is sent to a remote server, the remote server may tailor future content and/or advertisement provision based on the tag information. For example, if the user has tagged media of a particular genre, then media content of the same genre may be provided to, or at least recommended to, the user on future occasions. Alternatively, if the user tags particular sports content then advertisements tailored for the demographics that view such sports may be provided; for example, a user who tags football (soccer) games may be supplied with advertisements for carbonated alcoholic beverages and shaving products.

A third variation of the seventh embodiment involves the use of a user tag to authorise media playback and/or determine a location within media content at which to begin playback.

The use of a user tag is shown in method 2650 in FIG. 26B. At step 2655 a particular piece of media content is retrieved. The media content may be in the form of a media file, which may be retrieved locally from the MCD 100 or accessed for streaming from a remote server. In a preferred embodiment a media identifier that uniquely identifies the media file is also retrieved. At step 2660, a current user is identified. If playback is occurring on an MCD 100, this may involve determining the user identifier of the currently logged in user. In a user wishes to playback media content on a device remote from MCD 100, they may use the MCD 100 itself to identify themselves. For example, using the location based services described below the user identifier of a user logged into a MCD 100 that is geographically local the remote device may be determined, e.g. the user of a MCD 100 within 5 metres of a laptop computer. At step 2665, the retrieved user and media identifiers are used to search for an existing user tag. If no such tag is found an error may be signalled and media playback may be restricted or prevented. If a user tag is found it may be used in a number of ways.

At step 2670 the user tag may be used to authorise the playback of the media file. In this case, the mere presence of a user tag may indicate that the user is authorised and thus instruct MCD 100 or a remote device to play the file. For example, a user may tag a particular movie that they are authorised to view on the MCD 100. The user may then take the MCD 100 to a friend's house. At the friend's house, the MCD 100 is adapted to communicate over one of a wireless network within the house, an IR data channel or telephony data networks (3G/4G). When the user initiates playback on the MCD 100, and instructs the MCD 100 to synchronise media playback with a remote screen at the friends house, for example in the manner shown in FIG. 21D or FIG. 33C, the MCD 100 may communicate with an authorisation server, such as the headend of an IPTV system, to authorise the content and thus allow playback on the remote screen.

The user tag may also synchronise playback of media content. For example, if the user tag stores time information indicating the portion of the media content displayed at the time of tagging, then the user logs out of the MCD 100 or a remote device, when the user subsequently logs in to the MCD 100 or remote device at a later point in time and retrieves the same media content, the user tag may be inspected and media playback initiated from the time information indicated in the user tag. Alternatively, when a user tags user content this may activate a monitoring service which associates time information such as a time stamp with the user tag when the user pauses or exits the media player.

### Eighth Embodiment

### Location Based Services in a Home Environment

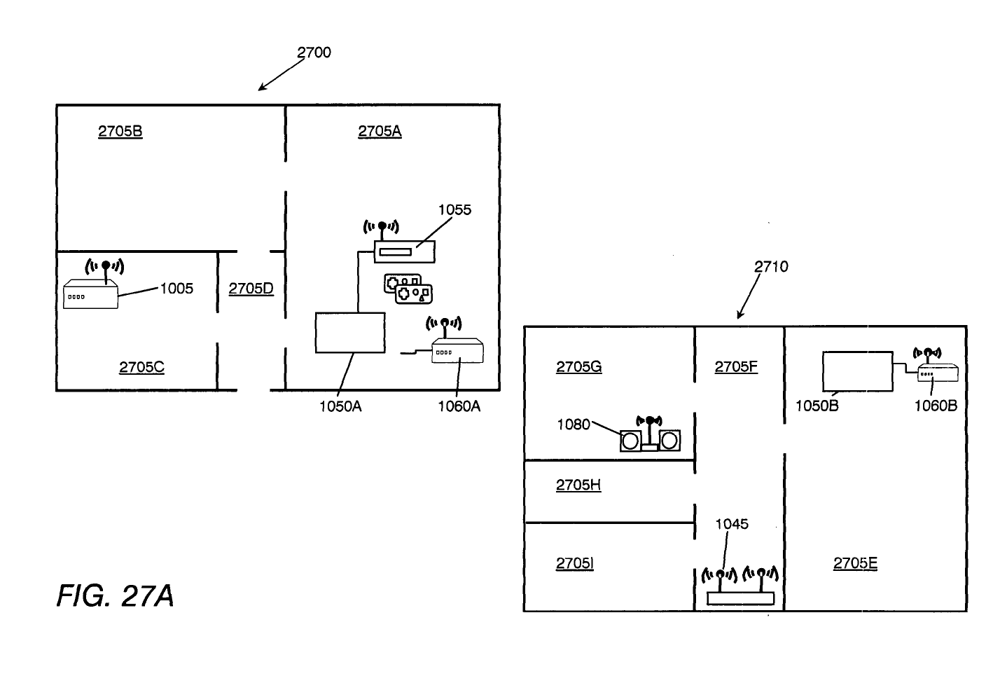

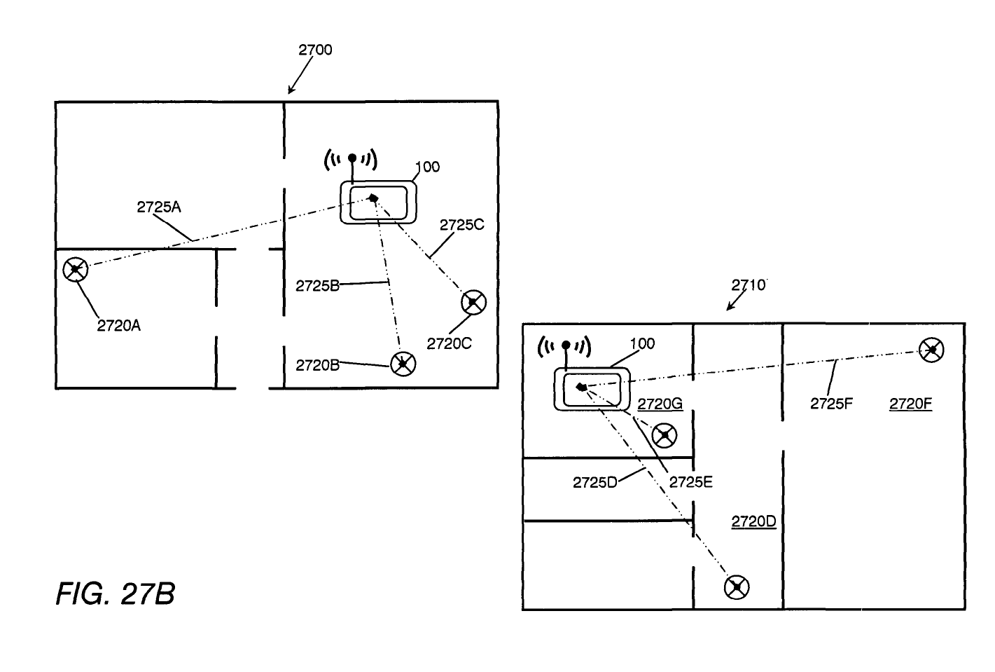

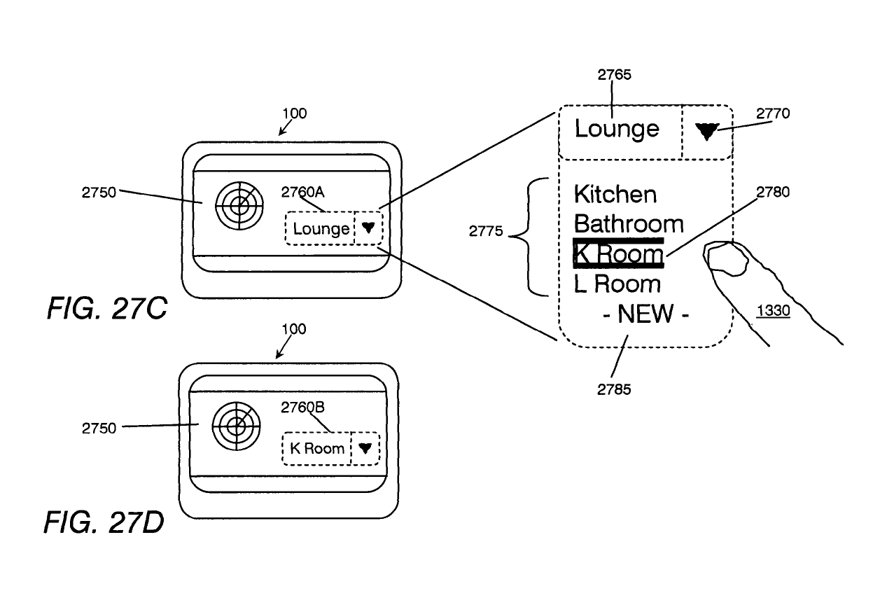

FIGS. 27A to 31B illustrate adaptations of location-based services for use with the MCD 100 within a home environment.

Location based services comprise services that are offered to a user based on his/her location. Many commercially available high-end telephony devices include GPS capabilities. A GPS module within such devices is able to communicate location information to applications or web-based services. For example, a user may wish to find all Mexican restaurants within a half-kilometer radius and this information may be provided by a web server on receipt of location information. GPS-based location services, while powerful, have several limitations: they require expensive hardware, they have limited accuracy (typically accurate to within 5-10 metres, although sometime out by up to 30 metres), and they do not operate efficiently in indoor environments (due to the weak signal strength of the satellite communications). This has prevented location based services from being expanded into a home environment.

FIGS. 27A and 27B show an exemplary home environment. The layout and device organisation shown in these Figures is for example only; the methods described herein are not limited to the specific layout or device configurations shown. FIG. 27A shows one or more of the devices of FIG. 10 arranged within a home. A plan of a ground floor 2700 of the home and a plan of a first floor 2710 of the home are shown. The ground floor 2700 comprises: a lounge 2705A, a kitchen 2705B, a study 2705C and an entrance hall 2705D. Within the lounge 2705A is located first television 1050A, which is connected to first set-top box 1060A and games console 1055. Router 1005 is located in study 2705C. In other examples, one or more devices may be located in the kitchen 2705B or hallway 2705D. For example, a second TV may be located in the kitchen 2705B or a speaker set may be located in the lounge 2705A. The first floor 2710 comprises: master bedroom 2705E (referred to in this example as “L Room”), stairs and hallway area 2705F, second bedroom 2705G (referred in this example as “K Room”), bathroom 2705H and a third bedroom 27051. A wireless repeater 1045 is located in the hallway 2705F; the second TV 1075B and second set-top box 1060B are located in the main bedroom 2075E; and a set of wireless speakers 1080 are located in the second bedroom 2705G. As before such configurations are to aid explanation and are not limiting.

The eighth embodiment uses a number of wireless devices, including one or more MCDs, to map a home environment. In a preferred embodiment, this mapping involves wireless trilateration as shown in FIG. 27B Wireless trilateration systems typically allow location tracking of suitably adapted radio frequency (wireless) devices using one or more wireless LANs. Typically an IEEE 802.11 compliant wireless LAN is constructed with a plurality of wireless access points. In the present example, there is a first wireless LAN 1040A located on the ground floor 2700 and a second wireless LAN 1040B located on the first floor 2710; to however in other embodiments a single wireless LAN may cover both floors. The wireless devices shown in FIG. 10 form the wireless access points. A radio frequency (wireless) device in the form of an MCD 100 is adapted to communicate with each of the wireless access points using standard protocols. Each radio frequency (wireless) device may be uniquely identified by an address string, such as the network Media Access Control (MAC) address of the device. In use, when the radio frequency (wireless) device communicates with three or more wireless access points, the device may be located by examining the signal strength (Received Signal Strength Indicator—RSSI) of radio frequency (wireless) communications between the device and each of three or more access points. The signal strength can be converted into a distance measurement and standard geometric techniques used to determine the location co-ordinate of the device with respect to the wireless access points. Such a wireless trilateration system may be implemented using existing wireless LAN infrastructure. An example of a suitable wireless trilateration is that provided by Pango Networks Incorporated. In certain variations, trilateration data may be combined with other data, such as telephony or GPS data to increase accuracy. Other equivalent location technologies may also be used in place of trilateration.

FIG. 27B shows how an enhanced wireless trilateration system may be used to locate the position of the MCD 100 on each floor. On the ground floor 2700, each of devices 1005, 1055 and 1060A form respective wireless access points 2720A, 2720B and 2720C. The wireless trilateration method is also illustrated for the first floor 2710. Here, devices 1045, 1080 and 1060B respectively form wireless access points 2720D, 2720E and 2720F. The MCD 100 communicates over the wireless network with each of the access points 2720. These communications 2725 are represented by dashed lines in FIG. 27B. By examining the signal strength of each of the communications 2725, the distance between the MCD 100 and each of the wireless access points 2720 can be estimated. This may be performed for each floor individually or collectively for all floors. Known algorithms are available for performing this estimation. For example, an algorithm may be provided that takes a signal strength measurement (e.g. the RSSI) as an input and outputs a distance based on a known relation between signal strength and distance. Alternatively, an algorithm may take as input the signal strength characteristics from all three access points, together with known locations of the access points. The known location of each access points may be set during initial set up of the wireless access points 2720. The algorithms may take into account the location of structures such as walls and furniture as defined on a static floor-plan of a home.

In a simple algorithm, estimated distances for three or more access points 2720 are calculated using the signal strength measurements. Using these distances as radii, the algorithm may calculate the intersection of three or more circles drawn respectively around the access points to calculate the location of the MCD 100 in two-dimensions (x, y coordinates). If four wireless access points are used, then the calculations may involve finding the intersection of four spheres drawn respectively around the access points to provide a three-dimensional co-ordinate (x, y, z). For example, access points 2720D, 2720E and 2720F may be used together with access point 2720A.

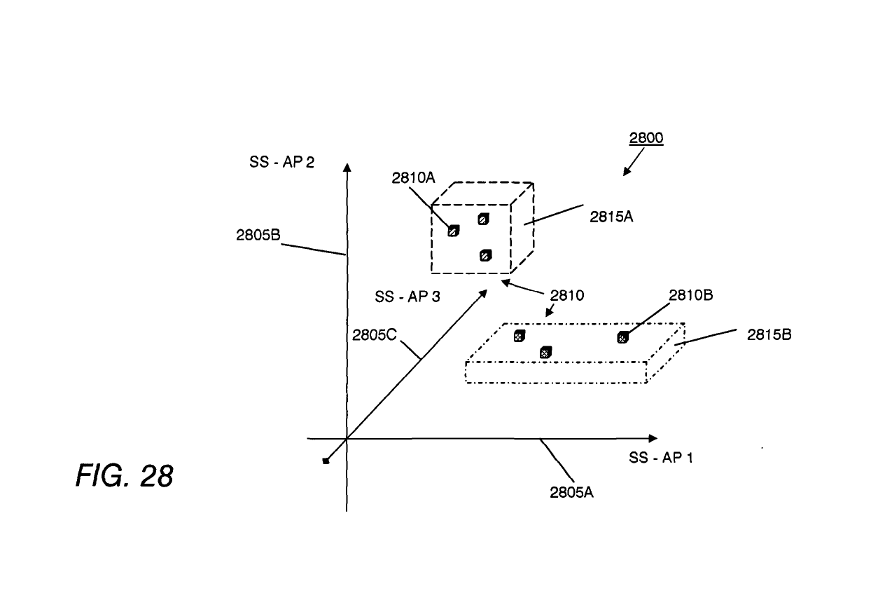

A first variation of the eighth embodiment will now be described. An alternative, and more accurate, method for determining the location of an MCD 100 within a home environment involves treating the signal strength data from communications with various access points as data for input to a classification problem. In some fields this is referred to as location fingerprinting. The signal strength data taken from each access point is used as an input variable for a pattern classification algorithm. For example, for the two dimensions of a single floor, FIG. 28 illustrates an exemplary three-dimensional space 2800. Each axis 2805 relates to a signal strength measurement from a particular access point (AP). Hence, if an MCD 100 at a particular location communicates with three access points, the resultant data comprises a co-ordinate in the three dimensional space 2800. In terms of a pattern classification algorithm, the signal strength data from three access points may be provided as a vector of length or size 3. In FIG. 28, data points 2810 represent particular signal strength measurements for a particular location. Groupings in the three-dimensional space of such data points represent the classification of a particular room location, as such represent the classifications made by a suitably configured classification algorithm. A method of configuring such an algorithm will now be described.

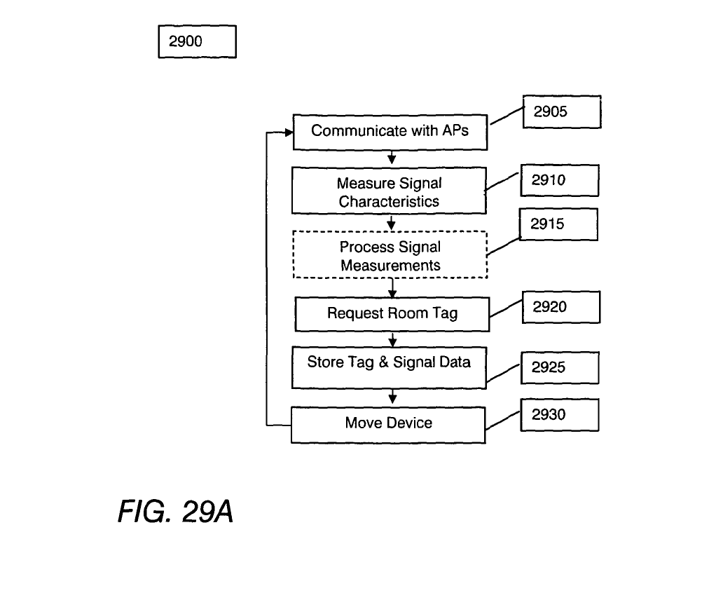

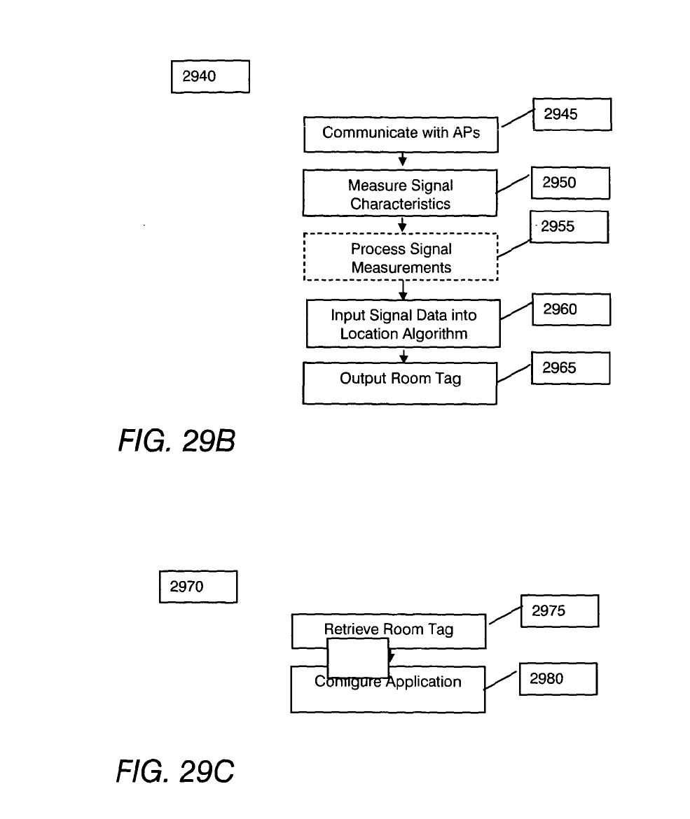

Method 2900 as shown in FIG. 29A illustrates how the classification space shown in FIG. 28 may be generated. The classification space visualized in FIG. 28 is for example only; signal data from N access points may be used wherein the classification algorithm solves a classification problem in N-dimensional space. Returning to the method 2900, at step 2905 a user holding the MCD 100 enters a room of the house and communicates with the N access points. For example, this is shown for both floors in FIG. 27B. At step 2910 the signal characteristics are measured. These characteristics may be derived from the RSSI of communications 2725. This provides a first input vector for the classification algorithm (in the example of FIG. 28—of length or size 3). At step 2915, there is the optional step of processing the signal measurements. Such processing may involve techniques such as noise filtering, feature extraction and the like. The processed signal measurements form a second, processed, input vector for the classification algorithm. The second vector may not be the same size as the first, for example, depending on the feature extraction techniques used. In the example of FIG. 28, each input vector represents a data point 2810.

In the second variation of the eighth embodiment, each data point 2810 is associated with a room label. During an initial set-up phase, this is provided by a user. For example, after generating an input vector, the MCD 100 requests a room tag from a user at step 2920. The process of inputting a room tag in response to such a request is shown in FIGS. 27C and 27D.

FIG. 27C shows a mapping application 2750 that is displayed on the MCD 100. The mapping application may be displayed as a widget or as a mode of the operating system. The mapping application 2750 allows the user to enter a room tag through UI component 2760A. In FIG. 27C, the UI component comprises a selection box with a drop down menu. For example, in the example shown in FIG. 27C, “lounge” (i.e. room 2765 in FIG. 27A) is set as the default room. If the user is in the “lounge” then they confirm selection of the “lounge” tag; for example by tapping on the touch-screen 110 area where the selection box 2760A is displayed. This confirmation associates the selected room tag with the previously generated input vector representing the current location of the MCD 100; i.e. in this example links a three-variable vector with the “lounge” room tag. At step 2925 this data is stored, for example as a fourth-variable vector. At step 2930 the user may move around the same room, or move into a different room, and then repeat method 2900. The more differentiated data points that are accumulated by the user the more accurate location will become.

In certain configuration, the MCD 100 may assume that all data received from the MCD 100 during a training phase is assumed to be associated with currently associated room tag. For example, rather than selecting “lounge” each time the user moves in the “lounge” the MCD 100 may assume all subsequent points are “lounge” unless told otherwise. Alternatively, the MCD 100 may assume all data received during a time period (e.g. 1 minute) after selection of a room tag relates to the selected room. These configurations save the user from repeatedly having to select a room for each data point.

If the user is not located in the lounge then they may tap on drop-down icon 2770, which forms part of UI component 2760A. This then presents a list 2775 of additional rooms. This list may be preset based on typical rooms in a house (for example, “kitchen”, “bathroom”, “bedroom ‘n’”, etc) and/or the user may enter and/or edit bespoke room labels. In the example of FIG. 27C a user may add a room tag by tapping on “new” option 2785 within the list or may edit a listed room tag by performing a chosen gesture on a selected list entry. In the example of FIG. 27C, the user has amended the standard list of rooms to include user labels for the bedrooms (“K Room” and “L Room” are listed).

Imagining room tag selection in FIG. 27B, the MCD on the ground floor 2700 is located in the lounge. The user thus selects “lounge” from UI component 2760A. On the first floor 2710, the user is in the second bedroom, which has been previously labeled “K Room” by the user. The user thus uses UI component 2760A and drop-down menu 2775 to select “K Room” 2780 instead of “lounge” as the current room label. The selection of an entry in the list may be performed using a single or double tap. This then changes the current tag as shown in FIG. 27D.

FIG. 28 visually illustrates how a classification algorithm classifiers the data produced by method 2900. For example, in FIG. 28 data point 2810A has the associated room tag “lounge” and data point 2810B has the associated room tag “K Room”. As the method 2900 is repeated, the classification algorithm is able to set, in this case, three-dimensional volumes 2815 representative of a particular room classification. Any data point within volume 2815A represents a classification of “lounge” and any data point within volume 2815B represents a classification of “K Room”. In FIG. 28, the classification spaces are cuboid; this is a necessary simplification for ease of example; in real-world applications, the visualized three-dimensional volumes will likely be non-uniform due to the variation in signal characteristics caused by furniture, walls, multi-path effects etc. The room classifications are preferably dynamic; i.e. may be updated over time as the use enters more data points using the method 2900. Hence, as the user moves around a room with a current active tag, they collect more data points and provide a more accurate map.

Once a suitable classification algorithm has been trained, the method 2940 of FIG. 29B may be performed to retrieve a particular room tag based on the location of the MCD 100. At step 2945, the MCD 100 communicates with a number of wireless access points. As in steps 2910 and 2915, the signal characteristics are measured at step 2950 and optional processing of the signal measurements may then be performed at step 2955. As before, the result of steps 2950 and option step 2955 is an input vector for the classification algorithm. At step 2960 this vector is input into the classification algorithm. The location algorithm then performs steps equivalent to representing the vector as a data point within the N dimensional space, for example space 2800 of FIG. 28. The classification algorithm to determine whether the data point is located within one of the classification volumes, such as volumes 2815. For example, if data point 2810B represents the input vector data, the classification algorithm determines that this is located within volume 2815B, which represents a room tag of “K Room”, i.e. room 2705G on the first floor 2710. By using known calculations for determining whether a point is in an N-dimensional (hyper)volume, the classification algorithm can determine the room tag. This room tag is output by the classification algorithm at step 2965. If the vector does not correspond to a data point within a known volume, an error or “no location found” message may be displayed to the user. If this is the case, the user may manually tag the room they are located in to update and improve the classification.

The output room tags can be used in numerous ways. In method 2970 of FIG. 29C, the room tag is retrieved at step 2975. This room tag may be retrieved dynamically by performing the method of FIG. 29B or may be retrieved from a stored value calculated at an earlier time period. A current room tag may be made available to applications via OS services 720 or application services 740. At step 2980, applications and services run from the MCD 100 can then make use of the room tag. One example is to display particular widgets or applications in a particular manner when a user enters a particular room. For example, when a user enters the kitchen, they may be presented with recipe websites and applications; when a user enters the bathroom or bedroom relaxing music may be played. Alternatively, when the user enters the lounge, they may be presented with options for remote control of systems 1050, 1060 and 1055, for example the methods of the fifth, sixth, seventh, ninth and tenth embodiments. Another example involves assigning priority for applications based on location, for example, an EPG widget such as that described in the sixth embodiment, may be more prominently displayed if the room tag indicates that the user is within distance of a set-top box. The room location data may also be used to control applications. In one example, a telephone application may process telephone calls and/or messaging systems according to location, e.g. putting a call on silent if a user is located in their bedroom. Historical location information may also be used, if the MCD 100 has not moved room location for a particular time period an alarm may be sounded (e.g. for the elderly) or the user may be assumed to be asleep.

Room tags may also be used to control home automation systems. For example, when home automation server 1035 communicates with MCD 100, the MCD 100 may send home automation commands based on the room location of the MCD 100. For example, energy use may be controlled dependent on the location of the MCD 100; lights may only be activated when a user is detected within a room and/or appliances may be switched off or onto standby when the user leaves a room. Security zones may also be set up: particular users may not be allowed entry to particular room, for example a child user of an MCD 100 may not be allowed access to an adult bedroom or a dangerous basement.

Room tags may also be used to facilitate searching for media or event logs. By tagging (either automatically or manually) media (music, video, web sites, photos, telephone calls, logs etc.) or events with a room tag, a particular room or set of rooms may be used as a search filter. For example, a user may be able to recall where they were when a particular event occurred based on the room tag associate with the event.

### Ninth Embodiment

### Location Based Services for Media Playback

A ninth embodiment of the present invention makes use of location-based services in a home environment to control media playback. In particular, media playback on a remote device is controlled using the MCD 100.

Modern consumers of media content often have multiple devices that play and/or otherwise manipulate media content. For example, a user may have multiple stereo systems and/or multiple televisions in a home. Each of these devices may be capable of playing audio and/or video data. However, currently it is difficult for a user to co-ordinate media playback across these multiple devices.

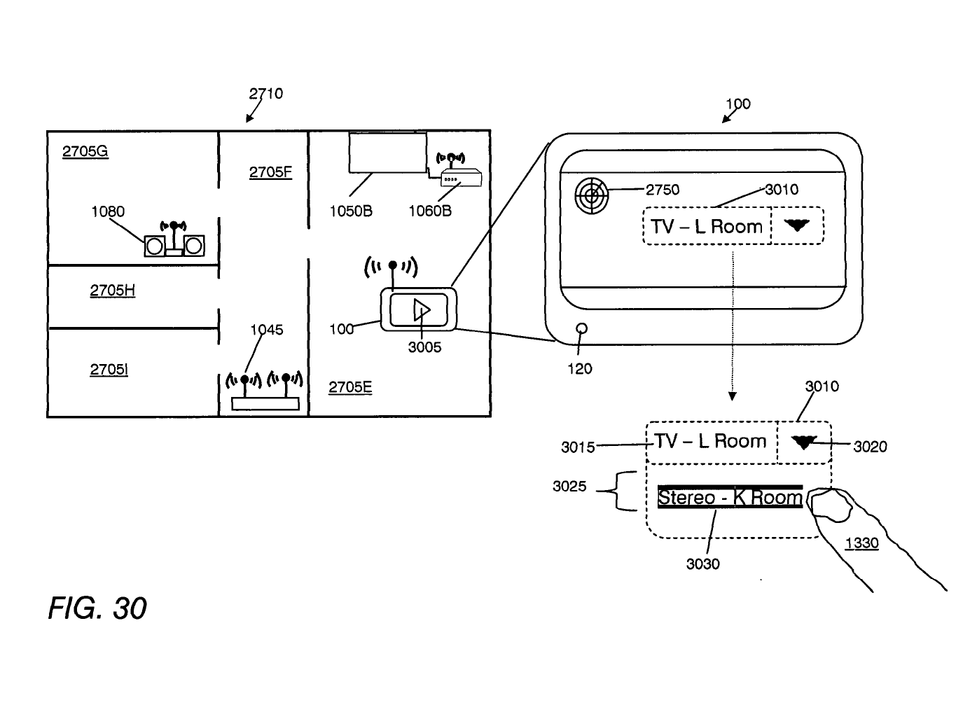

A method of controlling one or remote devices is shown in FIG. 30. These devices are referred to herein as remote playback devices as they are “remote” in relation to the MCD 100 and they may comprise any device that is capable of processing and/or playing media content. Each remote playback device is coupled to one or more communications channel, e.g. wireless, IR, Bluetooth™ etc. A remote media processor receives commands to process media over one of these channels and may form part of, or be separate from, the remote playback device. The coupling and control may be indirect, for example, TV 1050B may be designated a remote playback device as it can playback media; however it may be coupled to a communications channel via set-top box 1060B and the set-top box may process the media content and send signal data to TV 1050B for display and/or audio output.

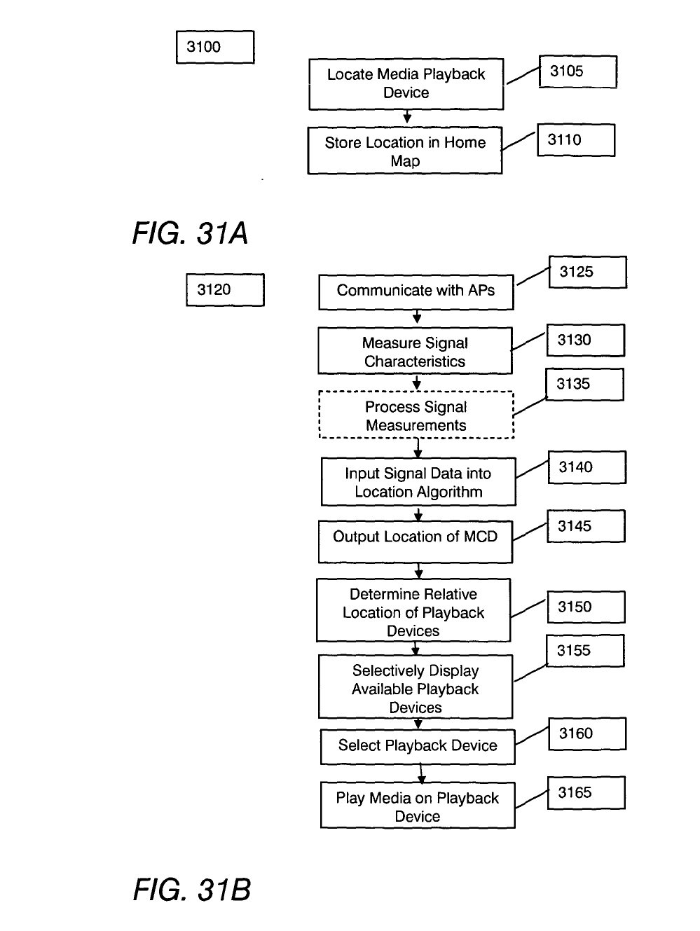

FIG. 30 shows a situation where a user is present in the master bedroom (“L Room”) 2705E with an MCD 100. For example, the user may have recently entered the bedroom holding an MCD 100. In FIG. 30 the user has entered a media playback mode 3005 on the device. The mode may comprise initiating a media playback application or widget or may be initiated automatically when media content is selected on the MCD 100. On entering the media playback mode 3005, the user is provided, via the touch-screen 110, with the option to select a remote playback device to play media content. Alternatively, the nearest remote playback device to the MCD 100 may be automatically selected for media playback. Once a suitable remote playback device is selected, the control systems of the MCD 100 may send commands to the selected remote playback device across a selected communication channel to play media content indicated by the user on the MCD 100. This process will now be described in more detail with reference to FIGS. 31A and 31B.

A method of registering one or more remote playback device with a home location based service is shown in FIG. 31A. At step 3105 one or more remote playback devices are located. This may be achieved using the classification or wireless trilateration methods described previously. In the remote playback device is only coupled to a wireless device, e.g. TV 1050B, the location of the playback device may be set as the location of the coupled wireless device, e.g. the location of TV 1050B may be set as the location of set-top box 1060B. For example, in FIG. 30, set-top box 1060B may communicate with a plurality of wireless access points in order to determine its location. Alternatively, when installing a remote playback device, e.g. set-top box 1060B, the user may manually enter its location, for example on a predefined floor plan, or may place the MCD 100 in close proximity to the remote playback device (e.g. stand by or place MCD on top of TV 1050B), locate the MCD 100 (using one of the previously described methods or GPS and the like) and set the location of the MCD 100 at that point in time as the location of the remote playback device. A remote media processor may be defined by the output device to which it is coupled, for example, set-top box 1060B may be registered as “TV”, as TV 1050B, which is coupled to the set-top box 1060B, actually outputs the media content.

At step 3110, the location of the remote playback device is stored. The location may be stored in the form of a two or three dimensional co-ordinate in a co-ordinate system representing the home in question (e.g. (0,0) is the bottom left-hand corner of both the ground floor and the first floor). Typically, for each floor only a two-dimension co-ordinate system is required and each floor may be identified with an additional integer variable. In other embodiments, the user may define or import a digital floor plan of the home and the location of each remote playback device in relation to this floor plan is stored. Both the co-ordinate system and digital floor plan provide a home location map. The home location map may be shown to a user via the MCD 100 and may resemble the plans of FIG. 27A or 30. In simple variations, only the room location of each remote playback device may be set, for example, the user, possibly using MCD 100, may apply a room tag to each remote playback device as shown in FIG. 27C.

Once the location of one or more remote playback devices has been defined, the method 3120 for remote controlling a media playback device shown in FIG. 31B may be performed. For example, this method may be performed when the user walks into “L Room” holding the MCD 100. At step 3125, the MCD 100 communicates with a number of access points (APs) in order to locate the MCD 100. This may involve measuring signal characteristics at step 3130 and optionally processing the signal measurements at step 3135 as described in the previous embodiment. At step 3140 the signal data (whether processed or not) may be input in to a location algorithm. The location algorithm may comprise any of those described previously, such as the trilateration algorithm or the classification algorithm. The algorithm is adapted to output the location of the MCD 100 at step 3145.

In a preferred embodiment, the location of the MCD 100 is provided by the algorithm in the form of a location or co-ordinate within a previously stored home location map. In a simple alternate embodiment, the location of the MCD 100 may comprise a room tag. In the former case, at step 3150 the locations of one or more remote playback devices relative to the MCD 100 are determined. For example, if the home location map represents a two-dimensional coordinate system, the location algorithm may output the position of the MCD 100 as a two-dimensional co-ordinate. This two-dimensional co-ordinate can be compared with two-dimensional co-ordinates for registered remote playback devices. Known geometric calculations, such as Euclidean distance calculations, may then use an MCD co-ordinate and a remote playback device co-ordinate to determine the distance between the two devices. These calculations may be repeated for all or some of the registered remote playback devices. In more complex embodiments, the location algorithm may take into account the location of walls, doorways and pathways to output a path distance rather than a Euclidean distance; a path distance being the distance from the MCD 100 to a remote playback device that is navigable by a user. In cases where the location of each device comprises a room tag, the relative location of a remote playback device may be represented in terms of a room separation value; for example, a matching room tag would have a room separation value of 0, bordering room tags a room separation value of 1, and rooms tags for rooms 2705E and 2705G a room separation value of 2.

At step 3155, available remote playback devices are selectively displayed on the MCD 100 based on the results of step 3150. All registered remote playback devices may be viewable or the returned processors may be filtered based on relative distance, e.g. only processors within 2 metres of the MCD or within the same room as the MCD may be viewable. The order of display or whether a remote playback device is immediately viewable on the MCD 100 may depend on proximity to the MCD 100. In FIG. 30, a location application 2750, which may form part of a media playback mode 3005, OS services 720 or application services 740, displays the nearest remote playback device to MCD 100 in UI component 3010. In FIG. 30 the remote playback device is TV 1050B. Here TV 1050B is the device that actually outputs the media content; however, processing of the media is performed by the set-top box. Generally, only output devices are displayed to the user, the coupling between output devices and media processors is managed transparently by MCD 100.

At step 3160 a remote playback device is selected. According to user-configurable settings, the MCD 100 may be adapted to automatically select a nearest remote playback device and begin media playback at step 3165. In alternative configurations, the user may be given the option to select the required media playback device, which may not be the nearest device. The UI component 3010, which in this example identifies the nearest remote playback device, may comprise a drop-down component 3020. On selecting this drop down-component 3020 a list 3025 of other nearby devices may be displayed. This list 3025 may be ordered by proximity to the MCD 100. In FIG. 30, on the first floor 2710, wireless stereo speakers 1080 comprise the second nearest remote playback device and are thus shown in list 3025. The user may select the stereo speakers 1080 for playback instead of TV 1050B by, for example, tapping on the drop-down component 3020 and then selecting option 3030 with finger 1330. Following selection, at step 3165, media playback will begin on stereo speakers 1080. In certain configurations, an additional input may be required (such as playing a media file) before media playback begins at step 3165. Even though the example of FIG. 30 has been shown in respect of the first floor 2710 of a building, the method 3120 may performed in three-dimensions across multiple floors, e.g. devices such as first TV 1050A or PCs 1020. If location is performed based on room tags, then nearby devices may comprise all devices within the same room as the MCD 100.

In a first variation of the ninth embodiment, a calculated distance between the MCD 100 and a remote playback device may be used to control the volume at which media is played. In the past there has often been the risk of “noise shock” when directing remote media playback. “Noise shock” occurs when playback is performed at an inappropriate volume, thus “shocking” the user. One way in which manufacturers of stereo systems have attempted to reduce “noise shock” is by setting volume limiters or fading up playback. The former solution has the problem that volume is often relative to a user and depends on their location and background ambient noise; a sound level that during the day in a distant room may be considered quiet, may be actually be experienced as very loud when late at night and close to the device. The latter solution still fades up to a predefined level and so simply delays the noise shock by the length of time over which the fade-up occurs; it may also be difficult to control or over-ride the media playback during fade-up.

In the present variation of the ninth embodiment, the volume at which a remote playback device plays back media content may be modulated based on the distance between the MCD 100 and the remote playback device; for example, if the user is close to the remote processor then the volume may be lowered; if the user is further away from the device, then the volume may be increased. The distance may be that calculated at step 3150. Alternatively, other sensory devices may be used as well as or instead of the distance from method 3120; for example, the IR channel may be used to determine distance based on attenuation of a received IR signal of a known intensity or power, or distances could be calculated based on camera data. If the location comprise a room tag, the modulation may comprise modulating the volume when the MCD 100 (and by extension user) is in the same room as the remote playback device.

The modulation may be based on an inbuilt function or determined by a user. It may also be performed on the MCD 100, i.e. volume level data over time may be sent to the remote playback device, or on the remote playback device, i.e. MCD 100 may instruct playback using a specified modulation function of the remote playback device, wherein the parameters of the function may also be determined by the MCD 100 based on the location data. For example, a user may specify a preferred volume when close to the device and/or a modulation function, this specification may instruct how the volume is to be increased from the preferred volume as a function of the distance between the MCD 100 and the remote playback device. The modulation may take into consideration ambient noise. For example, an inbuilt microphone 120 could be used to record the ambient noise level at the MCD's location. This ambient noise level could be used together with, or instead of, the location data to modulate or further modulate the volume. For example, if the user was located far away from the remote playback device, as for example calculated in step 3150, and there was a fairly high level of ambient noise, as for example, recorded using an inbuilt microphone, the volume may be increased from a preferred or previous level. Alternatively, if the user is close to the device and ambient noise is low, the volume may be decreased from a preferred or previous level.

### Tenth Embodiment

### Instructing Media Playback on Remote Devices

A tenth embodiment uses location data together with other sensory data to instruct media to playback on a specific remote playback device.

As discussed with relation to the ninth embodiment it is currently difficult for a user to instruct and control media playback across multiple devices. These difficulties are often compounded when there are multiple playback devices in the same room. In this case location data alone may not provide enough information to identify an appropriate device for playback. The present variations of the tenth embodiment resolve these problems.

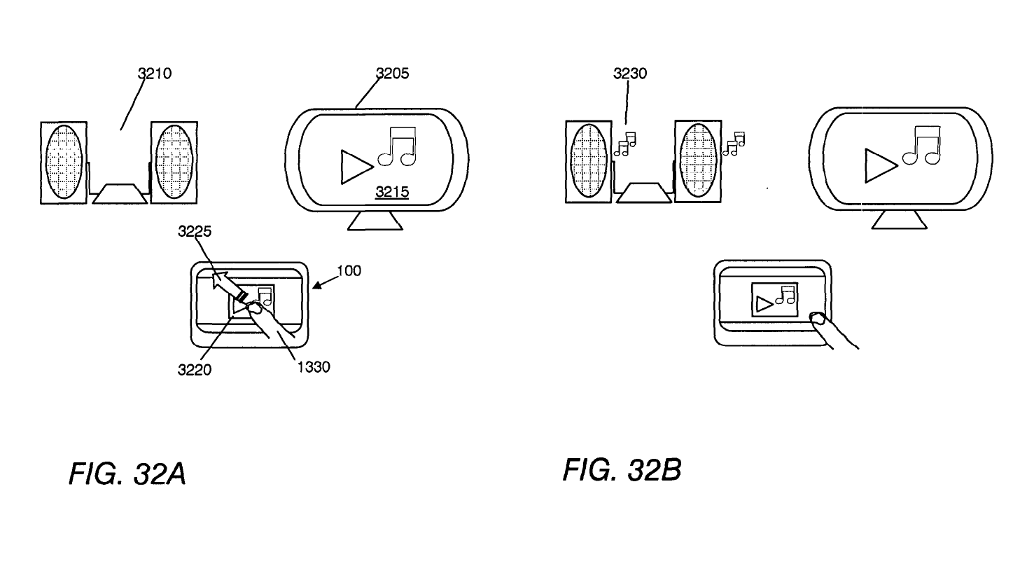

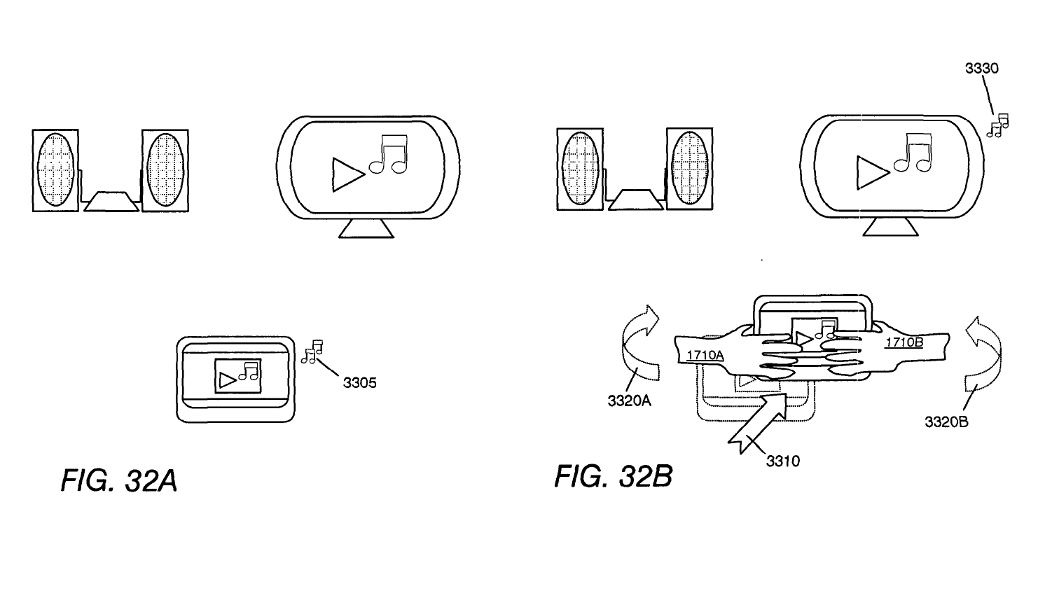

A first variation of the tenth embodiment is shown in FIGS. 32A and 32B. These Figures illustrate a variation wherein a touch-screen gesture directs media playback when there are two or more remote playback devices in a particular location.

In FIG. 32A, there are two possible media playback devices in a room. The room may be lounge 2705A. In this example the two devices comprise: remote screen 3205 and wireless speakers 3210. Both devices are able to play media files, in this case audio files. For remote screen, the device may be manually or automatically set to a media player mode 3215.

Using steps 3125 to 3150 of FIG. 31B (or any equivalent method), the location of devices 3205, 3210 and MCD 100 may be determined and, for example, plotted as points within a two or three-dimensional representation of a home environment. It may be that devices 3205 and 3210 are the same distance from MCD 100, or are seen to be an equal distance away taking into account error tolerances and/or quantization. In FIG. 32A, MCD 100 is in a media playback mode 3220. The MCD 100 may or may not be playing media content using internal speakers 160.

As illustrated in FIG. 32A, a gesture 3225, such as a swipe by finger 1330, on the touch-screen 110 on the MCD 100 may be used to direct media playback on a specific device. When performing the gesture the plane of the touch-screen may be assumed to be within a particular range, for example between horizontal with the screen facing upwards and vertical with the screen facing the user. Alternatively, internal sensors such as an accelerometer and/or a gyroscope within MCD 100 may determine the orientation of the MCD 100, i.e. the angle the plane of the touch-screen makes with horizontal and/or vertical axes. In any case, the direction of the gesture is determined in the plane of the touch-screen, for example by registering the start and end point of the gesture. It may be assumed that MCD 100 will be held with the top of the touch-screen near horizontal, and that the user is holding the MCD 100 with the touch-screen facing towards them. Based on known geometric techniques for mapping one plane onto another, and using either the aforementioned estimated angle orientation range and/or the internal sensor data, the direction of gesture in the two or three dimensional representation of the home environment, i.e. a gesture vector, can be calculated. For example, if a two-dimensional floor plan is used and each of the three devices is indicated by a co-ordinate in the plan, the direction of the gesture may be mapped from the detected or estimate orientation of the touch-screen plane to the horizontal plane of the floor plan. When evaluated in the two or three dimensional representation of the home environment the direction of the gesture vector indicates a device, e.g. any, or the nearest device, within a direction from the MCD 100 indicated by the gesture vector is selected.

The indication of a device may be performed probabilistically, i.e. the most likely indicated device may begin playing, or deterministically. For example, a probability function may be defined that takes the co-ordinates of all local devices (e.g. 3205, 3210 and 100) and the gesture or gesture vector and calculates a probability of selection for each remote device; the device with the highest probability value is then selected. A threshold may be used when probability values are low; i.e. playback may only occur when the value is above a given threshold. In a deterministic algorithm, a set error range may be defined around the gesture vector, if a device resides in this range it is selected.

For example, in FIG. 32A, the gesture 2335 is towards the upper left corner of the touch-screen 110. If devices 3205, 3210 and 100 are assumed to be in a common two-dimensional plane, then the gesture vector in this plane is in the direction of wireless speakers 3210. Hence, the wireless speakers 3210 are instructed to begin playback as illustrated by notes 3230 in FIG. 32B. If the gesture had been towards the upper right corner of the touch-screen 110, remote screen 3205 would have been instructed to begin playback. When playback begins on an instructed remote device, playback on the MCD 100 may optionally cease.

In certain configurations, the methods of the first variation may be repeated for two or more gestures simultaneously or near simultaneously. For example, using a second finger 1330 a user could direct playback on remote screen 3205 as well as wireless speakers 3210.

A second variation of the tenth embodiment is shown in FIGS. 33A, 33B and FIG. 34. These Figures illustrate a method of controlling media playback between the MCD 100 and one or more remote playback devices. In this variation, movement of the MCD 100 is used to direct playback, as opposed to touch-screen data as in the first variation. This may be easier for a user to perform if they do not have easy access to the touch-screen; for example if the user is carrying the MCD 100 with one hand and another object with the other hand or if it is difficult to find an appropriate finger to apply pressure to the screen due to the manner in which the MCD 100 is held.

As shown in FIG. 33A, as in FIG. 32A, a room may contain multiple remote media playback devices; in this variation, as with the first, a remote screen 3205 capable of playing media and a set of wireless speakers 3210 are illustrated. The method of the second variation is shown in FIG. 34. At step 3405 a media playback mode is detected. For example, this may be detected when widget 3220 is activated on the MCD 100. As can be seen in FIG. 33A, the MCD 100 may be optionally playing music 3305 using its own internal speakers 160.

At step 3410 a number of sensor signals are received in response to the user moving the MCD 100. This movement may comprise any combination of lateral, horizontal, vertical or angular motion over a set time period. The sensor signals may be received from any combination of one or more internal accelerometers, gyroscopes, magnetometers, inclinometers, strain gauges and the like. For example, the movement of the MCD 100 in two or three dimensions may generate a particular set of sensor signals, for example, a particular set of accelerometer and/or gyroscope signals. As illustrated in FIG. 33B, the physical gesture may be a left or right lateral movement 3310 and/or may include rotational components 3320. The sensor signals defining the movement are processed at step 3415 to determine if the movement comprises a predefined physical gesture. In a similar manner to a touch-screen gesture, as described previously, a physical gesture, as defined by a particular pattern of sensor signals, may be associated with a command. In this case, the command relates to instructing a remote media playback device to play media content.

As well as determining whether the physical gesture relates to a command, the sensor signals are also processed to determine a direction of motion at step 3420, such as through the use on an accelerometer or use of a camera function on the computing device. The direction of motion may be calculated from sensor data in an analogous manner to the calculation of a gesture vector in the first variation. When interpreting physical motion, it may be assumed that the user is facing the remote device he/she wishes to control. Once a direction of motion has been determined, this may be used as the gesture vector in the methods of the first variation, i.e. as described in the first variation the direction together with location co-ordinates for the three devices 3205, 3210 and 100 may be used to determine which of devices 3205 and 3210 the user means to indicate.

For example, in FIG. 33B, the motion is in direction 3310. This is determined to be in the direction of remote screen 3205. Hence, MCD 100 sends a request for media playback to remote screen 3205. Remote screen 3205 then commences media playback shown by notes 3330. Media playback may be commenced using timestamp information relating to the time at which the physical gesture was performed, i.e. the change in playback from MCD to remote device is seamless; if music track is playing and a physical gesture is performed at an elapsed time of 2:19, the remote screen 3205 may then commence playback of the same track at an elapsed time of 2:19.

A third variation of the tenth embodiment is shown in FIGS. 33C and 33D. In this variation a gesture is used to indicate that control of music playback should transfer from a remote device to the MCD 100. This is useful when a user wishes to leave a room where he/she has been playing media on a remote device; for example, the user may be watching a TV program in the lounge yet want to move to the master bedroom. The third variation is described using a physical gesture; however, a touch-screen gesture in the manner of FIG. 32A may alternatively be used. The third variation also uses the method of FIG. 34, although in the present case the direction of the physical gesture and media transfer is reversed.

In FIG. 33C, wireless speakers 3210 are playing music as indicated by notes 3230. To transfer playback to the MCD 100, the method of FIG. 34 is performed. At step 3405, the user optionally initiates a media playback application or widget 3220 on MCD 100; in alternate embodiments the performance of the physical gesture itself may initiate this mode. At step 3410, a set of sensor signals are received. This may be from the same or different sensor devices as the second variation. These sensor signals, for example, relate to a motion of the MCD 100, e.g. the motion illustrated in FIG. 33D. Again, the motion may involve movement and/or rotation in one or more dimensions. As in the second variation, the sensor signals are processed at step 3415, for example by CPU 215 or dedicated control hardware, firmware or software, in order to match the movement with a predefined physical gesture. The matched physical gesture may further be matched with a command; in this case a playback control transfer command. At step 3420, the direction of the physical gesture is again determined using the signal data. To calculate the direction, e.g. towards the user, certain assumptions about the orientation of the MCD 100 may be made, for example, it is generally held with the touch-screen facing upwards and the top of the touch-screen points in the direction of the remote device or devices. In other implementations a change in wireless signal strength data may additionally or alternatively by used to determine direction: if signal strength increases during the motion movement is towards the communicating device and vice versa for reduction in signal strength. Similar signal strength calculations may be made using other wireless channels such as IR or Bluetooth™. Accelerometers may also be aligned with the x and y dimensions of the touch screen to determine a direction. Intelligent algorithms may integrate data from more that one sensor source to determine a likely direction.

In any case, in FIG. 33C, the physical gesture is determined to be in a direction towards the user, i.e. in direction 3350. This indicates that media playback is to be transferred from the remote device located in the direction of the motion to the MCD 100, i.e. from wireless speakers 3210 to MCD 100. Hence, MCD 100 commences music playback, indicated by notes 3360, at step 3325 and wireless speakers stop playback, indicated by the lack of notes 3230. Again the transfer of media playback may be seamless.

In the above described variations, the playback transfer methods may be used to transfer playback in its entirety, i.e. stop playback at the transferring device, or to instruct parallel or dual streaming of the media on both the transferee and transferor.

1. A method of access control for a mobile computing device having a touch-screen, the method comprising:
receiving a signal indicating an input applied to the touch-screen;
matching the signal against a library of signal characteristics to identify a user of the mobile computing device from a group of users of the mobile computing device;
receiving an additional input to the mobile computing device;
using both the signal and the additional input to authenticate the user; and
if authenticated, allowing access to the mobile computing device in accordance with configuration data for the authenticated user.

2. The method of claim 1, wherein the matching step comprises:
calculating one or more metrics from the received signal, wherein the one or more metrics are representative of the size of a user's hand; and
comparing the one or more metrics from the received signal with one or more metrics stored in the library of signal characteristics to identify a user.

3. The method of claim 2, wherein the comparing step comprises:
calculating a probabilistic match value for each user within the group of users; and
identifying the user as the user with the highest match value.

4. The method of claim 2, wherein access to certain functions within the mobile computing device is restricted if the one or more metrics from the received signal indication that the size of a user's hand is below a predetermined threshold.

5. The method of claim 1, wherein the additional input comprises one or more of:
an identified touch-screen gesture or series of identified touch-screen gestures;
an audio signal generated by a microphone coupled to the mobile computing device;
a still or video image generated a camera coupled to the mobile computing device; and
an identified movement signal or series of identified movement signals.

6. A mobile computing device comprising:
a touch-screen adapted to generate a signal indicating an input applied to the touch-screen;
a sensor;
an authentication module configured to receive one or more signals from the touch-screen and the sensor and allow access to the mobile computing device in accordance with configuration data for an authenticated user,
wherein the authentication module is further configured to match a signal generated by the touch-screen against a library of signal characteristics to identify a user of the mobile computing device from a group of users of the mobile computing device, and
further authenticate the user using one or more signals from the sensor to conditionally allow access to the mobile computing device.
